(19) United States
(12) Patent Application Publication
(10) Pub. No.: US 2026/0167829 A1
(43) Pub. Date: Jun. 18, 2026

(54) USES OF DIAZIRINES

(71) Applicant: Nanyang Technological University, Singapore (SG)

(72) Inventors: Terry William Joseph STEELE, Singapore (SG); Ivan DJORDJEVIC, Singapore (SG); Muhammad Naziruddin BIN MOHD ALI, Singapore (SG)

(21) Appl. No.: 18/854,138

(22) PCT Filed: Apr. 10, 2023
(86) PCT No.: PCT/SG2023/050243

§ 371 Date: Oct. 4, 2024

(30) Foreign Application Priority Data
Apr. 8, 2022 (SG) 10202203625P
May 24, 2022 (SG) 10202205533P

(51) Int. Cl. C09D 4/00; C09D 135/02

(52) U.S. Cl. CPC C09D 4/00; C09D 135/02

(57) ABSTRACT

Disclosed herein are a light sensitive composition comprising a photocurable composition and a photoinitiator comprising an aryl-diazirine, wherein the diazirine bears an electron withdrawing group, and a cured composition obtained by curing the light sensitive composition. Also disclosed herein is a cured composition comprising a cured polymeric resin, and a reaction product formed between an aryl-diazoalkane and a dipolarophile, wherein the diazoalkane bears an electron withdrawing group. Also disclosed herein is a method of forming a cured polymeric resin, the method comprising the steps of (a) providing the light sensitive composition as aforementioned above, and (b) exposing it to a light source for a period of time to provide a cured polymeric resin.

### FIELD OF INVENTION

The present invention relates to uses of diazirines, and more particularly relates to use of aryl-diazirines as photoinitiators.

### BACKGROUND

The listing or discussion of a prior-published document in this specification should not necessarily be taken as an acknowledgement that the document is part of the state of the art or is common general knowledge.

Acrylates (also encompassing methacrylates) are versatile functional groups employed in click reactions, Michael additions, and chain growth polymerisation. Diacrylate based liquid resins, e.g. polyethylene glycol diacrylate (PEGDA or PEG-DA), have been used in a range of biomedical applications from tissue engineering to drug delivery. PEG-DA is generally used in the form of a photo-crosslinkable hydrogel. Acrylates are often used towards bioadhesives, 3D printing, dental resins, and packaging due to their rapid polymerisation but must rely on toxic photoinitiators that are known to leach from the cured resins.

Curing resins with light radiation requires a photoinitiator as one of the raw materials within the liquid monomer resin. Once exposed to the chosen wavelength of energy (ultraviolet (UV), visible, infrared or microwave), the photoinitiator will react and cause the initiation of the curing process. For the monomer resin, there are versions of cyanoacrylate, epoxy, silicone, anaerobic, and acrylic products available as radiation curing. However, a minor percentage of the photoinitiator composition does not react, forms dimers, endures as persistent radicals, or combination thereof. These undesired by-products are small molecules (<700 g/mol) that can leach or bloom onto the surfaces of cured resins causing undesired affects such as biological irritations, poor cosmetic appearance, surface contamination, unpredictable material properties, or combination thereof.

Polymerisation of acrylates produces highly crosslinked polymer networks that form the mainstay of many industries based on adhesives, fillers, coatings, and building materials. Curing of acrylate biomaterials and resins requires incorporation of leachable and potentially harmful small molecule initiators. One of the major impediments with acrylate resins is the degree of shrinkage of the crosslinked resin, which can be more than 14% by v/v (Schmidt, C. & Scherzer, T., J. Polym. Sci. B: Polym. Phys. 2015, 53, 729-739). This can lead to premature failure for use in adhesives. In medical implants, the shrinkage may cause gaps that lead to patient complications, premature failure, or both. In dental materials, photocured acrylate based resins are known to form gaps within fillings and between the edge of dental prostheses, which accelerates the failure of clinical filling. No photoinitiators are currently known that prevent or eliminate the degree of shrinkage. Thus, it would be advantageous if a relatively non-toxic photoinitiator compound could be found that prevents or eliminates volumetric shrinkage, for example by the formation of inert gases occurring simultaneously as part of the resin initiation. The latter could offset the volume reduction usually exhibited by acrylates during curing.

Examples of polymerisation reactions of methacrylates and acrylates with carbenes exist, but most reports describe N-heterocyclic carbenes (NHCs) which are generally relatively stable/persistent carbenes. NHCs have been reported to act as initiators and/or precatalysts for anionic polymerisations of methacrylates, resulting in high Mw low dispersity products (Naumann, S. et al., Polym. Chem. 2013, 4, 2731-2740). However, NHCs cannot be light activated, they do not have long-term shelf stability, and they do not prevent or eliminate resin shrinkage upon photocuring as they do not produce inert gases upon resin initiation. Triplet carbenes are not capable of carbene insertion, for example, carbene insertion into O—H bonds. Triplet carbenes may act as short lived diradicals, achieving a higher molecular radical density than tertiary carbon radicals. Triplet carbenes activated from aryldiazirine have been observed to react with oxygen and subsequent oxidation to ketones or proton abstraction, with open shell singlet carbenes behaving in a similar manner (Hassan, M. M. & Olaoye, O. O., Molecules 2020, 25, 2285).

Production of polyesters is primarily achieved through ring-opening polymerization (ROP) of precursors of small monomer cyclic esters. Polyesters are widely used as implants, thin films, and as controlled delivery of encapsulated small molecules. Current production methods require metal catalysts that remain within the resin. Metal-free initiators and propagation catalysts are sought to reduce or remove the current generation of metal catalysts. NHCs are known to catalyse ring opening polymerization of cyclic esters. However, there is no known carbene precursor that is capable of light activated initiation, propagation catalyst, or combination thereof.

Organic peroxides are readily cleaved to give two radicals. The oxyl radicals are unstable and believed to be transformed into relatively stable carbon-centered radicals. For example, di-tert-butyl peroxide (t-BuOOt-Bu) gives two t-butoxy radicals (t-BuO·) and the radicals become methyl radicals (CH₃·) with the loss of acetone. Benzoyl peroxide ((PhC)OO)₂) generates benzoyloxyl radicals (PhCOO·), each of which loses carbon dioxide to be converted into a phenyl radical (Ph·). Methyl ethyl ketone peroxide is also common, and acetone peroxide is on rare occasions used as a radical initiator, too. Several variants of organic peroxides have evolved into acetophenones (see 2,2-dimethoxy-2-phenylacetophenone (DMPA), FIG. 1) and camphorquinone which is a common photoinitiator for dental composites. However, polymerization with the latter is too slow by itself, so various amine catalysts are required to increase curing rates. However, they also have compromised aesthetic properties due to its intense yellow colour, and low polymerization rate and conversion efficiency. This has created demand for better photoinitiators, for example, monoacylphosphine oxides such as (diphenyl(2,4,6-trimethylbenzoyl) phosphine oxide, better known as TPO. TPO has better colour stability than resin mixtures containing a camphorquinone/amine photoinitiator system. Acrylates initiated by TPO showed higher reactivity, rate of polymerization and degree of conversion, but lower depth of cure due to higher molar absorptivity which reduces light penetration.

Some thermal initiators are known to have nitrogen evolution upon thermal activation, as shown in FIG. 2A. Azobisisobutyronitrile (AIBN) is safer to use than benzoyl peroxide initiators because the risk of explosion is far less. However, it is still considered an explosive compound, decomposing above 65° C. AIBN readily gives off free radicals temperatures above 40° C., therefore it does not have a long shelf-life and must be refrigerated. The exothermic decomposition results in two 2-cyano-2-propyl (carbon) radicals and a molecule of nitrogen gas. The release of nitrogen gas pushes this decomposition forward due to the increase in entropy, therefore the reaction can lead to explosions under some situations. Runaway reactions or burning of AIBN results in the formation of a highly toxic compound known as tetramethylsuccinonitrile. Due to the formation of toxic compounds, AIBN cannot be used for medical implants, such as dental implant resins.

Diazoalkanes are valuable reagents for organic chemists and are continuously sought by chemical biologists for protein labeling, a market that is experiencing unprecedented 14%/year growth rate and a projected value of 4.2B USD by 2021. Chemoselectivity is typically dominated by azido groups, but diazoalkanes have more advantages: (1) diazo (C═N₂) has a smaller footprint than azido (C—N₃); (2) has a wider range of crosslinking reactivity with nucleophiles; and (3) end-products are clean alkylations with only N₂ gas as a by-product (e.g. methylation of alcohols and carboxylic acids to ethers and esters). Drawbacks of diazomethane and other diazoalkanes include their high basicity, making them unstable in aqueous environments and are explosively reactive when dried and isolated. This prevents commercial availability of diazo compounds and prevents use as chemisorbents.

Therefore, there exists a need for non-toxic photocuring compositions to overcome at least one of the aforementioned problems for initiating chain growth polymerization, free radical polymerization, ring opening polymerization, or combinations thereof.

### SUMMARY OF INVENTION

Aspects and embodiments of the invention will now be discussed by reference to the following numbered clauses.
1. A light sensitive composition comprising:
   a photocurable composition; and
   a photoinitiator comprising an aryl-diazirine, wherein the diazirine bears an electron withdrawing group.
2. The light sensitive composition according to Clause 1, wherein the aryl-diazirine is selected from one or both of:
   a linear or branched macromolecule that is covalently attached to one or more aryl-diazirine groups; and
   a compound according to formula I:

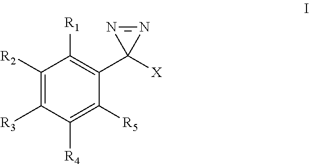

where:
X represents OR₆, halo, or, more particularly, a C₁ to C₆ alkyl group substituted by one or more fluoro atoms;
each of R₁ to R₅ independently represents H, —C(═O)OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₈, when present, independently represents H or C₁ to C₆ alkyl that is unsubstituted or substituted by one or more halogen atoms.
3. The light sensitive composition according to Clause 2, wherein the compound of formula I is selected from one or more of the group consisting of 3-phenyl-3-(trifluoromethyl)-3H-diazarine, 3-(4-(bromomethyl)phenyl)-3-(trifluoromethyl)-3H-diazarine, 4-[3-(trifluoromethyl)-3H-diazirin-3-yl]-benzoic acid, and 4-[3-(trifluoromethyl)-3H-diazirin-3-yl]-benzyl alcohol.
4. The light sensitive composition according to Clause 2, wherein the linear or branched macromolecule is a linear or branched polycaprolactone.
5. The light sensitive composition according to Clause 4, wherein the linear or branched polycaprolactone has the structure:

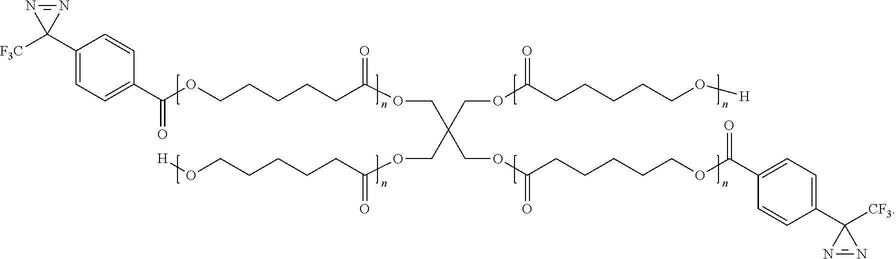

6. The light sensitive composition according to any one of the preceding clauses, wherein the photocurable composition comprises one or more monomers, oligomers or polymers bearing one or more groups capable of free radical polymerisation and/or ring opening polymerisation.
7. The light sensitive composition according to Clause 6, wherein the photocurable composition comprises poly(ethylene glycol) diacrylate (PEGDA), optionally wherein the number average molecular weight of the PEGDA is from 500 to 1,000 Daltons, such as about 575 Daltons.
8. The light sensitive composition according to any one of the preceding clauses, wherein the aryl-diazirine is present in an amount of from 0.001 to 50 wt % relative to the weight of the entire light sensitive composition.
9. The light sensitive composition according to any one of the preceding clauses, wherein the aryl-diazirine is present in an amount of from 0.01 to 20 mol % relative to the molar amount of the photocurable composition.
10. The light sensitive composition according to Clause 9, wherein the aryl-diazirine is present in an amount of from 0.1 to 10 mol %, such as from 0.5 to 5 mol %, such as from 0.01 to 1 mol %, such as from 5 to 20 mol %, such as from 10 to 15 mol % relative to the molar amount of the photocurable composition.
11. The light sensitive composition according to any one of the preceding clauses, wherein the light sensitive composition further comprises one or more of the group selected from an anti-oxidant, a plasticizer, an impact modifier, a colorant, a pigment, a conductive filler, an antimicrobial, a filler, a chemical blowing agent, a fragrance, and a rheology modifier.
12. The light sensitive composition according to any one of the preceding clauses, wherein the photoinitiator further comprises a photocatalyst, optionally wherein the photocatalyst is an iridium photocatalyst, such as [Ir(C₁₈H₂₄N₂) (C₁₂H₅F₅N)₂]PF₆.
13. The light sensitive composition according to any one of the preceding clauses, wherein the light sensitive composition further comprises a solvent.
14. The light sensitive composition according to any one of the preceding clauses, wherein the light sensitive composition is suitable for use as a resin for 3D-printing.
15. The light sensitive composition according to any one of the preceding clauses, wherein the light sensitive composition is suitable for use as a nail gel.
16. A cured composition obtained by curing a light sensitive composition wherein said light sensitive composition is that of any one of Clauses 1 to 15.
17. A cured composition comprising:
   a cured polymeric resin; and
   a reaction product between an aryl-diazoalkane and a dipolarophile, wherein the diazoalkane bears an electron withdrawing group.
18. The cured composition according to Clause 17, wherein the reaction product formed between an aryl-diazoalkane and a dipolarophile is a cycloaddition product of a reaction between an aryl-diazoalkane and one of the group consisting of a methacrylate group, a propargylic alcohol group, an aldehyde group or a ketone group.
19. The cured composition according to Clause 17 or Clause 18, wherein the aryl-diazoalkane is selected from one or both of:
   a linear or branched macromolecule that is covalently attached to one or more aryl-diazoalkane groups; and
   a compound according to formula II:

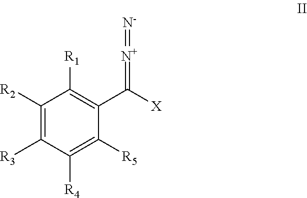

where:
X represents OR₆, halo, or, more particularly, a C₁ to C₆ alkyl group substituted by one or more fluoro atoms;
each of R₁ to R₅ independently represent H, —C(═O) OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₈, when present, independently represents H or C₁ to C₆ alkyl that is unsubstituted or substituted by one or more halogen atoms.
20. The cured composition according to Clause 19, wherein the compound of formula II is selected from one or more of the group consisting of (1-diazo-2,2,2-trifluoroethyl)benzene, 1-(bromomethyl)-4-(1-diazo-2,2,2-trifluoroethyl)benzene, 4-(1-diazo-2,2,2-trifluoroethyl)benzoic acid and [4-(1-diazo-2,2,2-trifluoroethyl)phenyl]methanol.
21. The cured composition according to Clause 19, wherein the linear or branched macromolecule is a linear or branched polycaprolactone.
22. The cured composition according to Clause 21, wherein the linear or branched polycaprolactone has the structure:

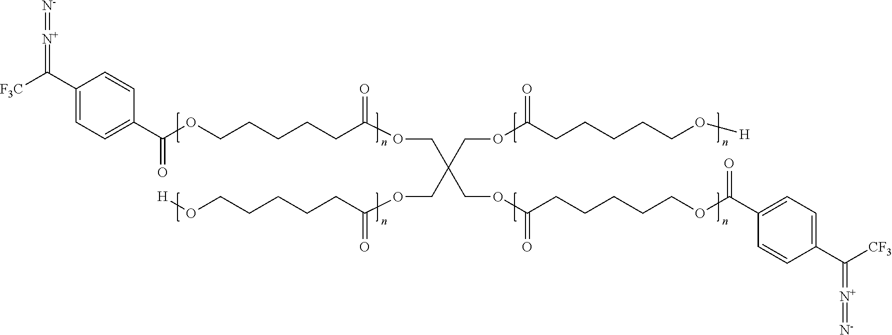

23. The cured composition according to any one of Clauses 17 to 22, wherein the cured polymeric resin is formed from one or more monomers, oligomers or polymers bearing one or more groups capable of free radical polymerisation and/or ring opening polymerisation.
24. The cured composition according to Clause 23, wherein the cured polymeric resin is formed from poly(ethylene glycol) diacrylate (PEGDA).
25. The cured composition according to any one of Clauses 17 to 24, wherein the cured composition has a minimum absorption of 0.5 ABS within the UV spectrum of from 200 to 300 nm.
26. A method of forming a cured polymeric resin, the method comprising the steps of:
(a) providing a light sensitive composition according to any one of Clauses 1 to 15; and
(b) exposing it to a light source for a period of time to provide a cured polymeric resin.
27. The method according to Clause 26, wherein when the light sensitive composition is one according to any one of Clauses 1 to 11 and Clauses 13 to 15, as dependent upon any one of Clauses 1 to 11, then the light source is UV light.
28. The method according to Clause 26, wherein when the light sensitive composition is one according to Clause 12, then the light source is visible light.

### DRAWINGS

FIG. 1 depicts DMPA, an organic free radical photoinitiator.

FIG. 2 depicts A) formation of free radicals from AIBN, a thermal initiator, and B) diazirine as carbene precursor.

FIG. 3 depicts the aryl-diazirine photoinitiators for chain-growth polymerization. ‘X’ at the 4-aryl position indicates a functional group that serves to shift chemical properties (e.g. wavelength absorption), or utility in grafting on macromolecules. A) Light activation of aryl-diazirine is known to produce both singlet and triplet carbenes. B) Representation of p-orbitals in the triplet and singlet carbine state. C) Triplet carbenes initiate chain growth polymerization. D) Propagation stage proceeds if no radical inhibitors are present and monomer concentration>>than radical concentration. E) Example of radical ring opening polymerization of 2-methylene-1,3-dioxepane, where the controlling of the m/n ratio can be used to tune the material properties. F) Example of ring opening polymerization of epoxy resins with free radical photoinitiators and known iodonium salt super acids. Aryl-diazirines photoinitiators induce the activation of iodonium salt super acids, which proceeds to initiator epoxy ring opening polymerization.

FIG. 4 depicts A) (left) UVA light activation of 0.1 mol % 3-phenyl-3-(trifluoromethyl)-3H-diazirine (CAS 73899-14-6) dissolved in PEGDA575 (CAS 26570-48-9) and (right) normal force measurements as an assessment of volumetric shrinkage. B) (left) UVA light activation of 1.0 mol % 3-phenyl-3-(trifluoromethyl)-3H-diazirine (CAS 73899-14-6) dissolved in PEGDA575 (CAS 26570-48-9) and (right) normal force measurements as an assessment of volumetric shrinkage. C) (left) Visible light (405 nm) activation of 1.0 mol % 3-phenyl-3-(trifluoromethyl)-3H-diazirine (CAS 73899-14-6) dissolved in PEGDA575 (CAS 26570-48-9) and (right) normal force measurements as an assessment of volumetric shrinkage. D) (left) Blue light (445 nm) activation with 0.1 mol % (Ir[dF(CF₃)ppy]₂(dtbpy)) PF₆ (IRPC) and 1.0 mol % 3-phenyl-3-(trifluoromethyl)-3H-diazirine (CAS 73899-14-6) dissolved in PEGDA575 (CAS 26570-48-9) and (right) normal force measurements as an assessment of volumetric shrinkage.

FIG. 5 depicts A) (left) UVA light activation of 0.1 mol % 3-(4-(bromomethyl)phenyl)-3-(trifluoromethyl)-3H-diazirine (CAS 92367-11-8) dissolved in PEGDA575 (CAS 26570-48-9) and (right) normal force measurements as an assessment of volumetric shrinkage. B) (left) UVA light activation of 1.0 mol % 3-(4-(bromomethyl)phenyl)-3-(trifluoromethyl)-3H-diazirine (CAS 92367-11-8) dissolved in PEGDA575 (CAS 26570-48-9) and (right) normal force measurements as an assessment of volumetric shrinkage. C) (left) Visible light (405 nm) activation of 1.0 mol % 3-(4-(bromomethyl)phenyl)-3-(trifluoromethyl)-3H-diazirine (CAS 92367-11-8) dissolved in PEGDA575 (CAS 26570-48-9) and (right) normal force measurements as an assessment of volumetric shrinkage. D) (left) Blue light (455 nm) activation with 0.1 mol % IRPC and 1.0 mol % 3-(4-(bromomethyl)phenyl)-3-(trifluoromethyl)-3H-diazirine (CAS 92367-11-8) dissolved in PEGDA575 (CAS 26570-48-9) and (right) Normal force measurements as an assessment of volumetric shrinkage.

FIG. 6 depicts A) (left) UVA light activation of 0.1 mol % 4-[3-(trifluoromethyl)-3H-diazirin-3-yl]benzoic acid (CAS 85559-46-2) dissolved in PEGDA575 (CAS 26570-48-9) and (right) normal force measurements as an assessment of volumetric shrinkage. B) (left) UVA light activation of 1.0 mol % 4-[3-(trifluoromethyl)-3H-diazirin-3-yl]benzoic acid (CAS 85559-46-2) dissolved in PEGDA575 (CAS 26570-48-9) and (right) normal force measurements as an assessment of volumetric shrinkage. C) (left) Visible light (405 nm) activation of 1.0 mol % 4-[3-(trifluoromethyl)-3H-diazirin-3-yl]benzoic acid (CAS 85559-46-2) dissolved in PEGDA575 (CAS 26570-48-9) and (right) Normal force measurements as an assessment of volumetric shrinkage. D) (left) Blue light (445 nm) activation with 0.1 mol % IRPC and 1.0 mol % 4-[3-(trifluoromethyl)-3H-diazirin-3-yl]benzoic acid (CAS 85559-46-2) dissolved in PEGDA575 (CAS 26570-48-9) and (right) normal force measurements as an assessment of volumetric shrinkage.

FIG. 7 depicts A) (left) UVA light activation of 0.1 mol % 4-[3-(trifluoromethyl)-3H-diazirin-3-yl]benzyl alcohol (CAS 87736-88-7) dissolved in PEGDA575 (CAS 26570-48-9) and (right) normal force measurements as an assessment of volumetric shrinkage. B) (left) UVA light activation of 1.0 mol % 4-[3-(trifluoromethyl)-3H-diazirin-3-yl]benzyl alcohol (CAS 87736-88-7) dissolved in PEGDA575 (CAS 26570-48-9) and (right) normal force measurements as an assessment of volumetric shrinkage. C) (left) Visible light (405 nm) activation of 1.0 mol % 4-[3-(trifluoromethyl)-3H-diazirin-3-yl]benzyl alcohol (CAS 87736-88-7) dissolved in PEGDA575 (CAS 26570-48-9) and (right) normal force measurements as an assessment of volumetric shrinkage. D) (left) Blue light (445 nm) activation with 0.1 mol % IRPC and 1.0 mol % 4-[3-(trifluoromethyl)-3H-diazirin-3-yl]benzyl alcohol (CAS 87736-88-7) dissolved in PEGDA575 (CAS 26570-48-9) and (right) normal force measurements as an assessment of volumetric shrinkage.

FIG. 8 depicts A) (left) visible light (405 nm) activation of 1.0 mol % 2-(4-(3-(trifluoromethyl)-3H-diazirin-3-yl)phenoxy)ethan-1-ol (CAS 271252-33-6) dissolved in PEGDA575 (CAS 26570-48-9) and (right) normal force measurements as an assessment of volumetric shrinkage. B) (left) Steady-state viscosity (Pa·s) before exposure to visible light (405 nm) and (right) amplitude sweep showing shear stress (kPa) from 1% to 1000% strain (%) after exposure to visible light (405 nm).

FIG. 9 depicts diazoalkanes as chemical absorbents. A) Aryl-diazoalkane is generated in situ through the photoisomerization of aryl-diazirine. B) Aryl-diazoalkane is a 1,3-dipole which undergoes cycloaddition with dipolarphiles. C) Common examples of dipolarophiles that are known skin irritants.

FIG. 10 depicts the generation of diazoalkane from diazirine grafted CaproGlu-1000 (CG). A) ¹⁹F NMR before (top) and after (bottom) 10 J of UVA at 50° C. on CaproGlu-1000. B) Diazirine, diazoalkane, and carbene concentration as function of UVA dose and temperature. C) UVA exposure of aryl-diazirine shows a visual confirmation of yellow colored aryl-diazoalkane. D) Schematic of aryl-diazirine conversion to aryl-diazoalkane.

FIG. 11 depicts aryl-diazoalkanes reacting spontaneously with excess diacrylates as measured by Fourier-transform infrared spectroscopy (FTIR). Aryl-diazoalkanes is first in situ generated by UVA exposure to aryl-diazirine present in CaproGlu 1000. A) Decay of aryl-diazoalkanes after photocuring a 1:1 ratio of PEGDA575:CaproGlu 1000. Photocuring simultaneously generates diazoalkane and initiates free radical polymerization of PEGDA575. Within 30 minutes, unreacted PEGDA575 molecules undergo cycloaddition reactions with diazoalkanes. Further decrease is seen at 16 hours. B) Increasing the ratio to 2:1 ratio of PEGDA575:CaproGlu 1000 completely removes aryl-diazoalkane to background levels after 16 hours.

FIG. 12 depicts formation of diazoalkane after UVA exposure of CaproGlu 1000. Diazoalkane is stable is still present after 16 hours post UVA.

FIG. 13 depicts A) (left) UVA light activation of 0.1 mol % CaproGlu 1000 dissolved in PEGDA575 (CAS 26570-48-9) and (right) normal force measurements as an assessment of volumetric shrinkage. B) (left) UVA light activation of 1.0 mol % CaproGlu 1000 dissolved in PEGDA575 (CAS 26570-48-9) and (right) normal force measurements as an assessment of volumetric shrinkage. C) (left) Visible light (405 nm) activation of 1.0 mol % CaproGlu 1000 dissolved in PEGDA575 (CAS 26570-48-9) and (right) normal force measurements as an assessment of volumetric shrinkage. D) (left) Blue light (445 nm) activation of 0.1 mol % IRPC and 1.0 mol % CaproGlu 1000 dissolved in PEGDA575 (CAS 26570-48-9) and (right) normal force measurements as an assessment of volumetric shrinkage.

FIG. 14 depicts aryl-diazoalkanes in the presence of excess nucleophiles as measured by FTIR. A) Excess thiol nucleophile has no decay effects on aryl-diazoalkane. B) Excess hydroxy nucleophile has no decay effects on aryl-diazoalkane.

FIG. 15 depicts aryl-diazoalkanes reacting via dipolar cycloaddition with excess gallic aldehyde. Measured by ¹⁹F NMR. A) Decay of aryl-diazoalkane after addition of gallic aldehyde. Diazoalkane in situ generated from acidic diazirine (DzCOOH). B) Diazoalkane in situ generated from CaproGlu-1000. C) A known reaction path named as Buchner-Curtius-Schlotterbeck reaction, where diazoalkanes react with aldehydes to from ketones.

FIG. 16 depicts A) (left) UVA light (365 nm) activation of 1.0 mol % diphenyl(2,4,6-trimethylbenzoyl)phosphine oxide (TPO) dissolved in PEGDA575 (CAS 26570-48-9) and (right) normal force measurements as an assessment of volumetric shrinkage. B) (left) Visible light (405 nm) activation of 1.0 mol % TPO dissolved in PEGDA575 (CAS 26570-48-9) and (right) normal force measurements as an assessment of volumetric shrinkage. C) (left) UVA light exposure of PEGDA575 (CAS 26570-48-9) with no photoinitiator and (right) normal force measurements as an assessment of volumetric shrinkage. D) (left) Visible light (405 nm) exposure of PEGDA575 (CAS 26570-48-9) with no photoinitiator and (right) normal force measurements as an assessment of volumetric shrinkage.

FIG. 17 depicts A) light activation of 1.0 mol % TPO dissolved in PEGDA575 (CAS 26570-48-9) and B) normal force measurements as an assessment of volumetric shrinkage.

FIG. 18 depicts A) (left) UVA light activation of 1.0% (w/w) 4-[3-(trifluoromethyl)-3H-diazirin-3-yl]benzyl alcohol (CAS 87736-88-7) dissolved in PEGDA575 (CAS 26570-48-9) diluted with 20 wt % toluene and (right) normal force measurements as an assessment of volumetric shrinkage. B) (left) UVA light activation of 1.0% (w/w) 4-[3-(trifluoromethyl)-3H-diazirin-3-yl]benzoic acid (CAS 85559-46-2) dissolved in PEGDA575 (CAS 26570-48-9) diluted in 80 wt % toluene and (right) normal force measurements as an assessment of volumetric shrinkage. C) (left) UVA light activation of 1.0% (w/w) TPO dissolved in PEGDA575 (CAS 26570-48-9) diluted in 80 wt % toluene and (right) normal force measurements as an assessment of volumetric shrinkage.

FIG. 19 depicts A) (left) UVA light activation of 1.0% (w/w) 4-[3-(trifluoromethyl)-3H-diazirin-3-yl]benzyl alcohol (CAS 87736-88-7) dissolved in PEGDA575 (CAS 26570-48-9) diluted with 80 wt % phosphate buffered saline (PBS) and (right) normal force measurements as an assessment of volumetric shrinkage. B) (left) UVA light activation of 1.0% (w/w) 4-[3-(trifluoromethyl)-3H-diazirin-3-yl]benzoic acid (CAS 85559-46-2) dissolved in PEGDA575 (CAS 26570-48-9) diluted with 80 wt % PBS and (right) normal force measurements as an assessment of volumetric shrinkage. C) (left) UVA light activation of 1.0% (w/w) TPO dissolved in PEGDA575 (CAS 26570-48-9) diluted with 80 wt % PBS and (right) normal force measurements as an assessment of volumetric shrinkage. D) (left) UVA light exposure of PEGDA575 (CAS 26570-48-9) diluted with 80 wt % PBS and (right) normal force measurements as an assessment of volumetric shrinkage.

FIG. 20 depicts A) UVA light activation of 1.0% (w/w) 4-[3-(trifluoromethyl)-3H-diazirin-3-yl]benzyl alcohol (CAS 87736-88-7) dissolved in a 1:1 mol ratio of 2-hydroxyethyl methacrylate (CAS 868-77-9) and PEGDA575 (CAS 26570-48-9). B) Normal force measurements as an assessment of volumetric shrinkage. C) UVA light activation of 1.0% (w/w) 4-[3-(trifluoromethyl)-3H-diazirin-3-yl]benzyl alcohol (CAS 87736-88-7) dissolved in a 1:1 mol ratio of 2-hydroxyethyl methacrylate (CAS 868-77-9) and PEGDA575 (CAS 26570-48-9). D) Normal force measurements as an assessment of volumetric shrinkage.

FIG. 21 depicts FTIR spectra of PEG-DA575 resins before and after curing at UVA (365 nm) and blue light (445 nm). A) 3-Phenyl-3-(trifluoromethyl)-3H-diazirine. B) 3-(4-(Bromomethyl)phenyl)-3-(trifluoromethyl)-3H-diazirine. C) 4-[3-(Trifluoromethyl)-3H-diazirin-3-yl]benzoic acid. D) 4-[3-(Trifluoromethyl)-3H-diazirin-3-yl]benzyl alcohol. E) CaproGlu 1000. F) Degree of conversion based on 1408 cm⁻¹ peak before and after photocuring as measured by FTIR spectroscopy under ambient conditions and exposure to ambient oxygen.

FIG. 22 depicts PEG575 diacrylate films (10 mm in diameter) produced after activation with A) UVA or B) blue LED. Note that the thin films (0.2 mm thick, 10 mm diameter) were transparent with no visual discoloration after photocuring. C) UV-visible (UV/VIS) spectral region recorded for PEGDA575 polymerized by UVA light (365 nm; 2 J dose) with CAS #85559-46-2 and TPO initiators; note the natural absorption and light blocking ability of photocured 1% mol CAS #85559-46-2/PEG-DA575 resin within UVB and UVC wavelengths to prevent photooxidation. (inset) PEGDA575 was completely photocured into a rigid solid with carbene initiator (Dz is short for CAS #85559-46-2). The rigid plastic throughout demonstrates light penetration depth greater than 1 cm thickness due to the relatively low molar extinction coefficient carbene precursor.

FIG. 23 depicts photosynthesis of aryl-diazoalkane. A) Experimental setup for the ¹⁹F NMR experiment: schematic side-view; B)¹⁹F NMR Peaks assigned. C) Aryl-diazoalkane generated from Dz as a function of temperature and UVA joules exposure.

FIG. 24 depicts ¹⁹F NMR Spectra from 0-50 J UVA dosage at 70° C. Diazirine has been converted to diazoalkane.

FIG. 25 depicts (top) structure of crosslinking trifluorophenyl diazirine (TPD) group present in CaproGlu and products (carbene and diazoalkane) formed upon UV activation. (Bottom) Abbreviated structure of components within liquid polymer formulations.

FIG. 26 depicts the A) scheme showing reactive functional groups of CaproGlu and polycaprolactone triol (PCLT) 300; B) photorheometry showing G′ and G″ of neat CaproGlu control and PCLT:CG 1:2 during photocuring (UV was turned on at 30 seconds and off at 130 seconds); C) variation in steady shear (shear rate 10/s) viscosity and G′ of CaproGlu with increasing dilution with PCLT300: D) variation in maximum Normal Force and Shear Strength of CaproGlu with increasing dilution with PCLT300; and E) FTIR of PCLT:CG 2:1 before and after curing (n=3 for B, C and D).

FIG. 27 depicts A) photorheometry of CaproGlu/PCLT mixtures and CaproGlu control, with mixtures of molar functional group ratios PCLT:CG 1:2, 1:1 and 2:1. B) Normal Force recorded during photocuring for CaproGlu/PCLT mixtures. C) Amplitude sweep of cured samples of PVLT/CaproGlu mixtures.

FIG. 28 depicts the FTIR of neat CaproGlu before and after curing (10 J/cm², 365 nm UV light). Diazoalkane peak at 2080 cm⁻¹ in cured sample. CH₂ peak at 2850 cm⁻¹ in both samples.

FIG. 29 depicts A) the scheme showing diazirine photoinitiators and PEGDA, a diacrylate monomer capable of free radical polymerization. B) Photo rheology displaying the photo-activation of diazirine initiators initiation the free radical polymerization of PEGDA only upon UVA exposures. C) G′ or Storage modulus at the end of 10J UVA exposure. D) Normal force of displaying no volumetric shrinkage of the crosslinked PEGDA resin. E) Scanning electron microscopy of porous CaproGlu (CG) after 10 J UVA irradiation. F) Scanning electron microscopy of non-porous PEGDA575:CG 1:1 after 10 J UVA irradiation.

FIG. 30 depicts the A) scheme showing reactive functional groups of CaproGlu and pentaerythritol tetrakis 3-mercaptopropionate (PTHT), B) photorheometry showing G′ and G″ of neat CaproGlu control and PTHT:CG 1:1 during photocuring (UV was turned on at 30 seconds and off at 130 seconds), C) variation in steady shear (shear rate 10/s) viscosity and G′ of CaproGlu with increasing dilution with PTHT, D) variation in maximum Normal Force and maximum Shear Stress of CaproGlu with increasing dilution with PTHT, and E) FTIR of PTHT:CG 1:1 molar ratio before and after curing, arrow indicates diazoalkane peak (n=3 for B, C and D).

FIG. 31 depicts A) photorheometry of CaproGlu/PTHT mixtures and CaproGlu control, with mixtures of molar functional group ratios PTHT:CG 1:2, 1:1 and 2:1. B) Normal Force recorded during photocuring for CaproGlu/PTHT mixtures. C) Amplitude sweep of cured samples of PTHT/CaproGlu mixtures.

FIG. 32 depicts the A) scheme showing reactive functional groups of CaproGlu and polyamidoamine (PAMAM), B) photorheometry showing G′ and G″ of neat CaproGlu control and PAMAM:CG 1:2 during photocuring (UV was turned on at 30 seconds and off at 130 seconds), C) variation in steady shear (shear rate 10/s) viscosity and G′ of CaproGlu with increasing dilution with PAMAM, D) variation in maximum Normal Force and Shear Strength of CaproGlu with increasing dilution with PAMAM, E) FTIR of PAMAM:CG 1:1 before and after curing; arrow indicates diazoalkane peak, F) (top) neat CaproGlu and PAMAM:CG samples 1:4, 1:2 and 1:1 in 4 mL vials prior to addition of D₂O; (middle) neat CaproGlu and PAMAM:CG 1:4, 1:2 and 1:1 in D₂O after 24 hours, and (bottom) neat CaproGlu and PAMAM:CG 1:4, 1:2 and 1:1 following removal from D₂O (samples are 10 cm in diameter), and G)¹H nuclear magnetic resonance (NMR) spectra of leachates in D₂O after 24 hours (n=3 for B, C and D).

FIG. 33 depicts ¹H NMR (60 MHz) in D₂O of neat PAMAM. δ 0.10 (s, 9H) 3-trimethylsilyl-1-propane sulfonic acid sodium salt (TMSP) standard, 4.89 solvent peak D₂O, 2.52-3.49 PAMAM peaks.

FIG. 34 depicts ¹H NMR (60 MHz) in D₂O of CaproGlu leachates after exposure of samples to 1 M NaOD in D₂O for 48 hours. δ 4.89 solvent peak D₂O, 7.23-7.95 unknown aromatic degradation products, 1.20-3.67 other unknown degradation products.

FIG. 35 depicts the A) scheme showing reactive functional groups of CaproGlu and PEG-DA575, B) photorheometry showing G′ and G″ of pure CaproGlu, pure PEG-DA575, PEG-DA575:CG 1:2, PEG-DA575:CG 2:1, and PEG-DA575:CG 46:1 during photocuring (UV was turned on at 30 seconds and off at 130 seconds), C) variation in steady shear (shear rate 10/s) viscosity and G′ at 10 J of CaproGlu with increasing dilution with PEG-DA575, D) variation in Shear Strength and Maximum Normal Force=of CaproGlu with increasing dilution with PEG-DA575, and E) FTIR spectra of PEG-DA575:CG 1:1 before and after UV exposure; dashed line indicates 810 cm⁻¹ (C═C out of plane stretch; n=3 for B, C and D).

FIG. 36 depicts A) photorheometry of CaproGlu/PEG-DA575 mixtures and CaproGlu control, with mixtures of molar functional group ratios PEGDA575:CG 1:1 and 2:1. B) Normal Force recorded during photocuring for CaproGlu/PEGDA575 mixtures. C) Amplitude sweep of cured samples of PEGDA575/CaproGlu mixtures.

FIG. 37 depicts A) photorheometry of CaproGlu/PEG-DA575 mixtures and CaproGlu control, with mixtures of molar functional group ratios PEGDA575:CG 46:1, 4:1 and 1:2. B) Normal Force recorded during photocuring for CaproGlu/PEGDA575 mixtures. C) Amplitude sweep of cured samples of PEGDA575/CaproGlu mixtures. D) Photocuring of PEG-DA575 control with TPO photoinitator (46:1 ratio). E) Normal force during photocuring for PEG-DA575/TPO. F) Apparent viscosity of CaproGlu/PEG-DA575 with mixtures of molar functional group ratios PEG-DA575:CG 1:0, 1:1 and 1:2.

FIG. 38 depicts A) comparison of photorheometry of CaproGlu with different additives, each with a 1:1 molar ratio of diazirine to the additive OH, SH, NH₂ or acrylate functional groups, and B-F) Scanning Electron Microscopy (SEM) images of 1:1 mixtures in the order: CaproGlu control; PEGDA575:CG 1:1; PCLT:CG 1:1; PTHT:CG 1:1; and PAMAM:CG 1:1 (magnification ×500 (×600 in D). Scale bar=10 μm).

FIG. 39 depicts A) photorheometry of CaproGlu/PAMAM mixtures and CaproGlu control, with mixtures of molar functional group ratios PAMAM:CG 1:4, 1:2 and 1:1. (B) Normal Force recorded during photocuring for CaproGlu/PAMAM mixtures. (C) Amplitude sweep of cured samples of PAMAM/CaproGlu mixtures.

FIG. 40 depicts G′ and G″ against Dose for A) 20% PEGDA575 in PBS, B) 20% PEGDA575 in PBS+1% TPO, C) 20% PEGDA575 in PBS+1% DzOH, and D) 20% PEGDA575 in PBS+1% DzCOOH. Tests were performed in triplicates.

FIG. 41 depicts G′ and G″ against Dose for A) 50% PEGDA575 in PBS, B) 50% PEGDA575 in PBS+1% TPO, C) 50% PEGDA575 in PBS+1% DzOH, and D) 50% PEGDA575 in PBS+1% DzCOOH. Tests were performed in triplicates.

FIG. 42 depicts G′ and G″ against Dose for A) 80% PEGDA575 in PBS, B) 80% PEGDA575 in PBS+1% DzOH, C) 80% PEGDA575 in PBS+1% DzOH, and D) 80% PEGDA575 in PBS+1% DzOH. Tests were performed in triplicates.

FIG. 43 depicts the 1-way ANOVA statistical analysis of PEGDA575 at different concentrations with TPO, DzOH or DzCOOH.

FIG. 44 depicts Normal Force against Dose for A) 20% PEGDA575 in PBS, B) 20% PEGDA575 in PBS+1% TPO, C) 20% PEGDA575 in PBS+1% DzOH, and D) 20% PEGDA575 in PBS+1% DzCOOH. Tests were performed in triplicates.

FIG. 45 depicts Normal Force against Dose for A) 50% PEGDA575 in PBS, B) 50% PEGDA575 in PBS+1% TPO, C) 20% PEGDA575 in PBS+1% DzOH, and D) 20% PEGDA575 in PBS+1% DzCOOH. Tests were performed in triplicates.

FIG. 46 depicts Normal Force against Dose for A) 80% PEGDA575 in PBS, B) 80% PEGDA575 in PBS+1% TPO, C) 80% PEGDA575 in PBS+1% DzOH, and D) 80% PEGDA575 in PBS+1% DzCOOH. Tests were performed in triplicates.

FIG. 47 depicts the films formed at 20% PEGDA575 in PBS with 1% photo-initiator.

FIG. 48 depicts mixtures of PEGDA575 and PBS at different concentrations, without photo-initiators.

FIG. 49 depicts G′ and G″ against Dose for 30% PEGDA575 in PBS+1% DzOH.

FIG. 50 depicts the experimental setup for photo-differential scanning calorimetry (DSC) experiments.

FIG. 51 depicts the DSC curves for A-B) PEGDA575 with TPO at 100% and 20% concentration, C-D) PEGDA575 with DzOH at 100% and 20% concentration, and E-F) PEGDA575 with DzCOOH at 100% and 20% concentration.

FIG. 52 depicts G′ and G″, and Normal Force against Dose graphs of PEGDA700+1% TPO at A, B) 365 nm and C, D) 405 nm. Graph for 365 nm is representative while graphs for 405 nm are obtained from the average of triplicates tests.

FIG. 53 depicts G′ and G″ against dose of PEGDA700+1% DzOH at A) 365 nm and B) 405 nm, and PEGDA700+1% DzCOOH at C) 365 nm and D) 405 nm. Tests were performed in triplicates.

FIG. 54 depicts Normal Force to rheometer probe against dose of PEGDA700+1% DzOH at A) 365 nm and B) 405 nm, and PEGDA700+1% DzCOOH at C) 365 nm and D) 405 nm. Tests were performed in triplicates.

FIG. 55 depicts 1 Way ANOVA Statistical Analysis for A) PEGDA700 between DzOH and DzCOOH at 365 nm, and for B) PEGDA700 for TPO, DzOH, DzCOOH at 405 nm.

FIG. 56 depicts the photorheometry results obtained for UVA-induced crosslinking (365 nm) of binary mixtures with PEGDA575 and PTHT. Liquid mixture of PEGDA575/PTHT=2/1 mol ratio with 1% mol. of diazirine initiators (DzOH and CaproGlu, CG)−Storage (G′) and Loss (G″) moduli evolution during UVA activation (total dose of 10 J) and Normal force on rheometer probe: A, B) G′/G″ of PEGDA575+PTHT with DzOH and Normal force, respectively; C, D) G′/G″ of PEGDA575+PTHT with CG and Normal force, respectively; E, F) G′/G″ of PEGDA575+PTHT with TPO and Normal force, respectively; and G, H) G′/G″ of PEGDA575+PTHT (no carbene initiator; control) and Normal force, respectively.

FIG. 57 depicts the visible light shelf stability of 30% PEGDA575+1% TPO, 70% PEGDA575+1% TPO, 70% PEGDA575+1% DzOH, and 30% PEGDA575+1% DzOH.

FIG. 58 depicts Cell viability of 0.01-1 mM of three photoinitiators. A) Structure of photoinitiators, B) 24 hours of incubation. 0.01 and 0.1 mM are not significantly different from control. C) 48 hours of incubation. All concentrations of DzOH are not significantly different from control.

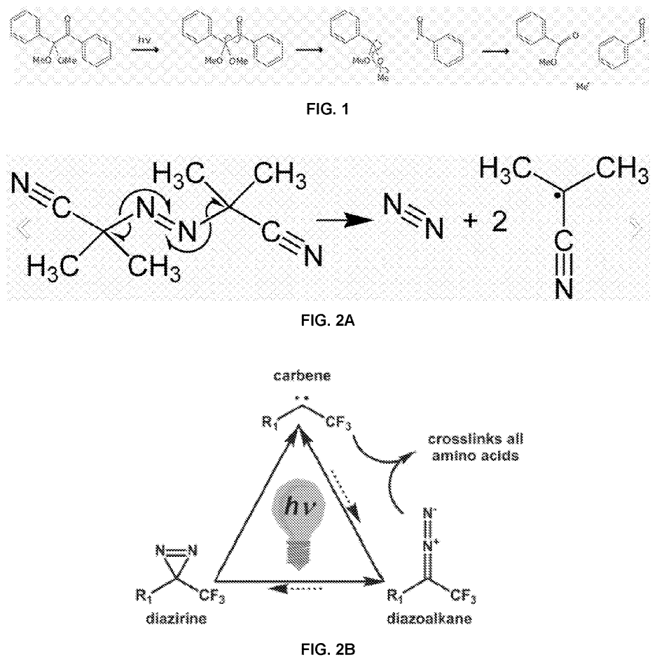

### DESCRIPTION

It has been surprisingly found that the combination of a photocurable composition and a photoinitiator comprising an aryl-diazirine allows for the photopolymerisation of acrylates. In particular, it is noted that the presence of aryl-diazirine provided synergistic enhancement of dynamic modulus.

In a first aspect of the invention, there is provided a light sensitive composition comprising:
a photocurable composition; and
a photoinitiator comprising an aryl-diazirine, wherein the diazirine bears an electron withdrawing group.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a compound” includes mixtures of two or more such compounds, reference to “a composition” includes mixtures of two or more such compositions, and the like.

Unless otherwise stated, the term “aryl” when used herein includes C₆₋₁₄ (such as C₆₋₁₀) aryl groups. Such groups may be monocyclic, bicyclic or tricyclic and have between 6 and 14 ring carbon atoms, in which at least one ring is aromatic. The point of attachment of aryl groups may be via any atom of the ring system. However, when aryl groups are bicyclic or tricyclic, they are linked to the rest of the molecule via an aromatic ring. C₆₋₁₄ aryl groups include phenyl, naphthyl and the like, such as 1,2,3,4-tetrahydronaphthyl, indanyl, indenyl and fluorenyl. Embodiments of the invention that may be mentioned include those in which aryl is phenyl.

The term “the diazirine bears an electron withdrawing group” is intended to mean that an electron withdrawing group is attached to the carbon atom of the diazirine group. Any suitable electron withdrawing group may be used herein. Examples of suitable electron withdrawing groups include, but are not limited to, CF₃, O-alkyl, and halo (e.g. F, Cl or Br).

In particular embodiments that may be mentioned herein, the aryl-diazirine may be a linear or branched macromolecule that is covalently attached to one or more aryl-diazirine groups. As will be appreciated, each of the diazirine groups will bear an electron withdrawing group.

In alternative embodiments that may be mentioned herein, the aryl-diazirine may be a compound according to formula I:

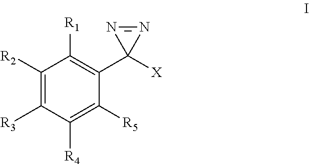

where:
X represents OR₆, halo, or, more particularly, a C₁ to C₆ alkyl group substituted by one or more fluoro atoms;
each of R₁ to R₅ independently represents H, —C(═O)OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₃, when present, independently represents H or C₁ to C₈ alkyl that is unsubstituted or substituted by one or more halogen atoms.

In yet a further alternative embodiment, the aryl-diazirine may be both of the above. That is, it may be a combination of:
a linear or branched macromolecule that is covalently attached to one or more aryl-diazirine groups; and
a compound according to formula I as described above.

“Alkyl” refers to monovalent alkyl groups which may be straight chained or branched and preferably have from 1 to 10 carbon atoms or more preferably 1 to 6 carbon atoms. Examples of such alkyl groups include methyl, ethyl, n-propyl, iso-propyl, n-butyl, iso-butyl, n-hexyl, and the like. As used herein, C₁-C₈alkyl refers to an alkyl group having 1 to 6 carbon atoms.

References herein (in any aspect or embodiment of the invention) to compounds of formula (I) includes references to such compounds per se, to tautomers of such compounds, as well as to physiologically acceptable salts or solvates, or pharmaceutically functional derivatives of such compounds.

In some embodiments that may be mentioned herein, the compound of formula I may be selected from one or more of the group consisting of 3-phenyl-3-(trifluoromethyl)-3H-diazarine, 3-(4-(bromomethyl)phenyl)-3-(trifluoromethyl)-3H-diazarine, 4-[3-(trifluoromethyl)-3H-diazirin-3-yl]-benzoic acid, and 4-[3-(trifluoromethyl)-3H-diazirin-3-yl]-benzyl alcohol.

In some embodiments that may be mentioned herein, the linear or branched macromolecule may be a linear or branched polycaprolactone. For example, the linear or branched polycaprolactone may have the structure:

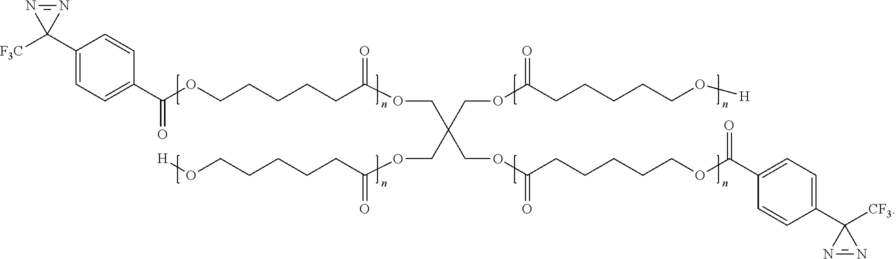

The light sensitive composition mentioned herein includes a photocurable composition. The photocurable composition may be any suitable material that can undergo photoinitiation by the aryl-diazirine, wherein the diazirine bears an electron withdrawing group. The photocurable composition may comprise one or more monomers, oligomers or polymers bearing one or more groups capable of free radical polymerisation and/or ring opening polymerisation. Examples of suitable materials that may be present in the photocurable composition include, but are not limited to:
alkenes;
functionally substituted alkenes;
butadiene;
vinyl pyrrolidone;
vinyl chloride;
vinylidene chloride;
tetrafluoroethylene;
acrylonitrile;
acrylamide;
vinyl monomers (e.g. styrene, methyl methacrylate, and vinyl esters, such as vinyl acetate);
monomers derived from natural products (e.g. itaconic acid, and sorbic acid);
radical ring opening polymerization (rROP) monomers (e.g. dioxepane monomers, cyclic ketene acetals, 2-methylene-1,3-dioxepane; 5,6-benzo-2-methylene-1,3-dioxepane; and methylenephenyl-1,3-dioxolane);
acrylates (e.g. methyl methacrylate, and acrylic acid); and
acrylates with cleavable crosslinkers (e.g. 2-(dimethylamino)ethyl methacrylate (DMAEMA) with bis(2-methacryloyloxyethyl) disulfide as a cleavable crosslinker).

Any suitable molecular weight for the monomers, oligomers and polymers mentioned above may be used herein.

In particular embodiments of the invention that may be mentioned herein, the photocurable composition may comprise poly(ethylene glycol) diacrylate (PEGDA). Any suitable molecular weight for the PEGDA may be used herein. For example, the number average molecular weight of the PEGDA may be from 500 to 1,000 Daltons, such as about 575 Daltons. As will be appreciated, PEGDA having a molecular weight of about 1,000 Daltons will melt at around 35° C., while a PEGDA having a molecular weight of about 1,500 Daltons will melt at around 50° C. As such, the molecular weights for the photocurable composition may be chosen for the photocurable composition to be liquid (or close thereto) at room temperature.

The aryl-diazirine may be present in an amount of from 0.001 to 50 wt % relative to the weight of the entire light sensitive composition.

Additionally or alternatively, the aryl-diazirine may be present in an amount of from 0.01 to 20 mol % relative to the molar amount of the photocurable composition. For example, the aryl-diazirine may be present in an amount of from 0.1 to 10 mol %, such as from 0.5 to 5 mol %, such as from 0.01 to 1 mol %, such as from 5 to 20 mol %, such as from 10 to 15 mol % relative to the molar amount of the photocurable composition. For the avoidance of doubt, the molar percentage of the aryl-diazirine is relative to the number of moles of the polymerisable materials in the photocurable composition. Generally, the lower the initiator ratio (i.e. the mol % of the aryl-diazirine), the longer the polymer chain, the better the polymer material properties, and the stronger the plastic. However, too low of an initiator concentration will result in other processes dominating, such as termination reactions and the monomer will then not be completely utilized.

The light sensitive composition disclosed herein may, in certain embodiments, further comprise one or more of the group selected from an anti-oxidant, a plasticizer, an impact modifier, a colorant, a pigment, a conductive filler, an antimicrobial, a filler, a chemical blowing agent, a fragrance, and a rheology modifier.

Suitable antioxidants include, but are not limited to one or more of the group consisting of aromatic amines, sterically hindered phenols, and metal deactivators.

Suitable plasticizers include but are not limited to one or more of the group consisting of dialkyl phthalate, aliphatic diester, trialkyl phosphate, and trialkyl trimellitate.

In further embodiments of the invention, the light sensitive composition may further comprise a photocatalyst. The photocatalyst may preferably be an iridium photocatalyst such as [Ir(C₁₈H₂₄N₂)(C₁₂H₅F₅N)₂]PF₆.

In further embodiments of the invention, the light sensitive composition may further comprise a solvent. Any suitable solvent may be used herein. For example, the solvent may include, but is not limited to, one or more of the group consisting of dimethyl sulfoxide, water, and halogenoalkanes (such as dichloromethane).

It will be appreciated that the light sensitive composition may be useful in a resin for 3D-printing. It will also be appreciated that the light sensitive composition may be suitable for use as a nail gel. Thus, in embodiments of the invention, the light sensitive composition is suitable for use as a resin for 3D-printing and/or the light sensitive composition is suitable for use as a nail gel.

As noted above, the light sensitive composition may be used in a number of applications, such as a resin for 3D-printing or as a nail gel. In such embodiments, it will be appreciated that the composition will be subjected to light curing to produce a cured composition. Thus, in a further aspect of the invention, there is provided a cured composition obtained by curing a light sensitive composition wherein said light sensitive composition is as disclosed above.

It will be appreciated that any suitable light source may be used to effect the curing of the light sensitive composition. For example, the light source may be a visible light source or a UV light source.

In another aspect of the invention, there is a cured composition comprising:
a cured polymeric resin; and
a reaction product between an aryl-diazoalkane and a dipolarophile, wherein the diazoalkane bears an electron withdrawing group.

As will be appreciated, the electron withdrawing group may be identical to the electron withdrawing group mentioned hereinbefore in relation to the diazarine. Hence, it will be appreciated that the electron withdrawing group is attached to the carbon atom of the diazoalkane.

The reaction product formed between the aryl-diazoalkane and the dipolarophile may be a cycloaddition product of a reaction between an aryl-diazoalkane and one or more of the group consisting of a methacrylate group, a propargylic alcohol group, an aldehyde group or a ketone group. Examples of suitable dipolarophiles that may be used in the above-mentioned materials include, but are not limited to poly(ethylene glycol) diacrylate, and 2-hydroxyethyl methacrylate (HEMA).

In particular embodiments that may be mentioned herein, the aryl-diazoalkane may be a linear or branched macromolecule that is covalently attached to one or more aryl-diazoalkane groups. As will be appreciated, each of the diazoalkane groups will bear an electron withdrawing group.

In alternative embodiments that may be mentioned herein, the aryl-diazoalkane may be a compound according to formula II:

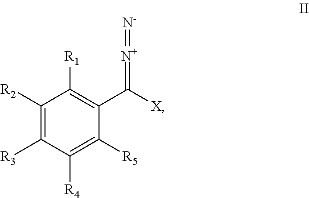

where:
X represents OR₆, halo, or, more particularly, a C₁ to C₆ alkyl group substituted by one or more fluoro atoms;
each of R₁ to R₅ independently represent H, —C(═O)OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₈, when present, independently represents H or C₁ to C₆ alkyl that is unsubstituted or substituted by one or more halogen atoms.

In embodiments of the invention that may be mentioned herein, the compound of formula II may be selected from one or more of the group consisting of (1-diazo-2,2,2-trifluoroethyl)benzene, 1-(bromomethyl)-4-(1-diazo-2,2,2-trifluoroethyl)benzene, 4-(1-diazo-2,2,2-trifluoroethyl)benzoic acid and [4-(1-diazo-2,2,2-trifluoroethyl)phenyl]methanol.

In yet a further alternative embodiment, the aryl-diazoalkane may be both of the above. That is, it may be a combination of:
a linear or branched macromolecule that is covalently attached to one or more aryl-diazoalkane groups; and
a compound according to formula II as described above.

In some embodiments that may be mentioned herein, the linear or branched macromolecule may be a linear or branched polycaprolactone. For example, the linear or branched polycaprolactone may have the structure:

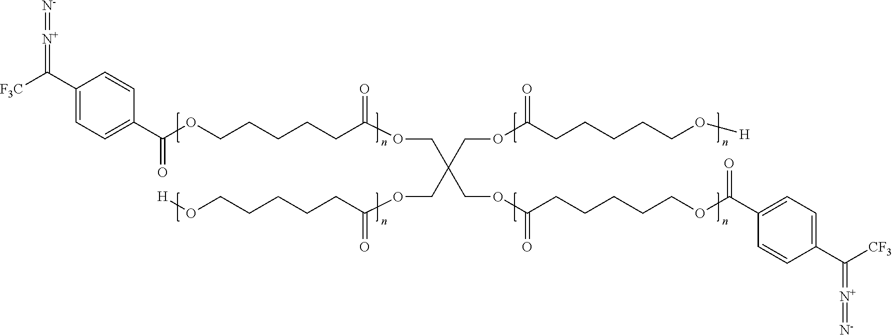

The cured composition mentioned may be formed from any suitable material. For example, it may be formed from one or more monomers, oligomers or polymers bearing one or more groups capable of free radical polymerisation and/or ring opening polymerisation. Said materials may be as described hereinbefore in relation to the monomers, oligomers or polymers with respect to the light sensitive composition and the list will be omitted here for brevity. In particular embodiments of the invention that may be mentioned herein, the cured polymeric resin may be formed from poly(ethylene glycol) diacrylate (PEGDA).

The cured composition disclosed herein may have any suitable minimum absorption value. For example, the cured composition may have a minimum absorption of 0.5 ABS within the UV spectrum of from 200 to 300 nm.

In yet another aspect of the invention, there is a method of forming a cured polymeric resin, the method comprising the steps of:
(a) providing a light sensitive composition as disclosed above; and
(b) exposing it to a light source for a period of time to provide a cured polymeric resin.

Any suitable light source may be used herein. Examples of suitable light sources may include, a visible light source or a UV light source.

When the light source is a visible light source, it may have a wavelength of from 400 to 700 nm, such as 405 nm or 445 nm. When the light source is an UV light source, it may have a wavelength of from 10 to 400 nm, such as 365 nm.

When the light sensitive composition as disclosed above comprises a photocatalyst, the light source is preferably a visible light source having a wavelength of from 400 nm to 700 nm, such as 445 nm.

In embodiments of the method where the light sensitive composition does not include a photocatalyst, then the light source may be a UV light source.

Any suitable period of time may be used herein. For example, the period of time may be from seconds to 100 seconds, such as 100 seconds.

The use of the aryl-diazirines disclosed herein may provide one or more of the following advantages:
1. reduced or elimination of resin shrinkage of meth/acrylate monomers, due to evolution of molecular nitrogen during light exposure;
2. rapid initiation of meth/acrylate chain growth polymerization in less than 5 seconds;
3. removal of dissolved oxygen, a known inhibitor of chain growth polymerization. Carbenes react with oxygen to form ketones, removing them from the resin during light irradiation;
4. long shelf stability of 1 year or more, stable at room temperature. No refrigeration required;
5. little to no mammalian cell toxicity of leachates before or after light initiation;
6. aryl-diazirines are under ambient conditions and undergo endothermic decomposition upon heating (therefore non-explosive) above 80° C.;
7. aryl-diazirine is capable of activating chain growth polymerization under a wide range of ratios, for example 0.1-50 mol %;
8. both UVA (365 nm) and visible light (violet @ 385 & 405 nmand blue @ 455 nm) wavelengths activate aryl-diazirines with subsequent initiation of chain growth polymers;
9. aryl-diazirine are small molecules (<200 g/mol) that are soluble in aqueous, organic solvents, oils, or liquid monomer resins capable of chain growth polymerization;
10. aryl-diazirine can be grafted on macromolecules with no loss of photoinitiator function;
11. aryl-diazirine can simultaneously initiate mixed resin systems for tailoring chain growth polymerization. Mixed resins include olefins, cyclic esters, or combination thereof;
12. aryl-diazirine can withstand 25-40 kGy gamma sterilization with no loss of function;
13. aryl-diazirines have a high degree of conversion (DC) of acrylate monomers, >60% under ambient conditions;
14. aryl-diazirines have a low molar absorption coefficient, which in turn allows a higher depth of cure compared to conventional photoinitiators. E.g. TPO=520 cm⁻¹M⁻¹ @ 381 nm, while Aryl-diazirines have molar absorption coefficient of UVA (185 cm⁻¹M⁻¹ @ 350 nm) and visible (<10 cm⁻¹M⁻¹ @ 400-700 nm);
15. aryl-diazirines can be activated with standard dental light-curing units such as Quartz-tungsten halogen units, polywave LED light-curing units, solar simulators, UVA LEDS, violet LEDS, blue LEDS, and xenon plasma arc lamps;
16. aryl-diazirines and their post-cure products have excellent aesthetic properties since it has high transmittance in the visible range of 400-700 nm;
17. carbene based bioadhesive crosslinking mechanism is based on the carbene precursor of aryl-diazirine reacting with primary alcohol function groups upon UVA exposure via step-growth polymerization. Carbene based bioadhesives can be diluted or mixed with acrylate resins to form hybrid polymerization biomaterials that undergo no shrinkage or exhibit volume expansion;
18. carbene precursors are available as neat liquids, and are miscible directly in acrylates and cyclic esters resins with no co-solvents required;
19. initiation of cyclic ester radical ring opening polymerization;
20. photocured resins using carbene precursors have a natural ability to block both UVB and UVC wavelengths, known to cause photooxidation and premature degradation of biological, natural, and synthetic materials and plastics; and
21. aryl-diazirine are capable of initiating free radical polymerization when neat resins are diluted in aqueous and organic solvents. This is relevant for light activated biologic materials where acrylates have be grafted on proteins and natural/synthetic macromolecules, including but not limited to silk, fibrinogen, tropocollagen, soy protein isolate, casein, and collagen.

As such, aryl-diazirines are highly suitable for use in neat or resin monomer mixtures to initiate free radical polymerization, chain-growth polymerization, ring opening polymerization or combination thereof upon light irradiation.

Further aspects and embodiments of the invention will now be described by reference to the following non-limiting examples.

### EXAMPLES

### Materials

CaproGlu (CG; 52% diazirine grafted, Mw˜1500 Da), a carbene-based bioadhesive, was prepared as described previously (Djordjevic, I. et al., Biomaterials 2020, 260, 120215). In brief, 4-[3-(trifluoromethyl)-3H-diazirin-3-yl]benzoic acid (230.14 g·mol⁻¹; Dz-COOH) was synthesized by oxidation of DzOH (purchased from TCI) with KMnO₄. CaproGlu synthesis method was the esterification reaction between DzCOOH and PCLT with 1,1′-carbonyldiimidazole (CDI) coupling agent.

PTHT (>90%, Mw=488.66 Da) was purchased from TCI. Polyamidoamine Generation 0 (PAMAM GO) 43.81 w/w % in MeOH, Mw=516.68 Da, was purchased from Dendritech and methanol was removed under vacuum. PCLT (Mw˜300 Da, CAPA 3031) was purchased from Perstorp, Sweden. PEGDA (Mw˜575 gmol⁻¹, PEGDA575), TMSP (97%), TPO (97%), phosphate buffered saline (PBS) tablet, sodium deuteroxide (40 wt % in deuterium oxide), and all other chemicals and materials were purchased from Sigma Aldrich, Singapore (unless stated otherwise). Deuterium oxide (99.9% D) was purchased from Cambridge Isotopes. All reagents were used as received.

### Analytical Techniques

### UV/VIS Spectroscopy

UV/VIS spectroscopy is performed on a SHIMADZU UV-2700 UV-VIS Spectrometer (Shimadzu, Singapore). 1 mmol of each aryl-diazirine compound is dissolved in 1 mL of chloroform. The solution is then added to UV/VIS quartz tube with a path length of 1 cm. The background is normalized to chloroform. The samples are tested in the wavelength range of 200 to 800 nm at a medium scan rate of 2 nm, and a slit width of 0.5 nm. Data are collected in absorbance values (A) against wavelength (nm).

### NMR Spectroscopy

NMR analysis was carried out on a Nanalysis NMReady-60PRO benchtop 60 MHz NMR spectrometer.

### General Procedure for FTIR Spectroscopy Analysis

FTIR was carried out on a PERKIN Elmer Frontier FTIR in attenuated total reflectance (ATR) mode. Spectra were recorded in absorbance mode over a wavenumber range of 4000-600 cm⁻¹, with a resolution of 4 cm⁻¹, and 16 scans were taken. Samples measured prior to curing were placed directly onto the ATR crystal. Samples measured after curing were spread to a thickness of less than 0.5 mm on a glass slide, cured with a 365 nm UV torch (UVA LED Thorlabs SOLIS 365C) until 10 J·cm⁻² UV activation was reached (100 seconds at 100 mW·cm⁻²) and placed adhesive side down on the ATR crystal.

### Example 1. Photoinitiation Studies

Samples were prepared by magnetic stirring of additives directly or through co-solvent dissolution with aryl-diazirines in Table 1 for 15 minutes. Binary CaproGlu (CG) based polymer mixtures (published at E. Ellis et al. ACS Applied Polymer Materials 2023 5, 1440-1452) have been mixed with the aid of solvent dichloromethane (DCM), namely CG with pentaerythritol tetrakis (3-mercaptopropionat; M_{w}=488.66 Da; PTHT), polyethylene glycol diacrylate (PEGDA; M_{w}˜575 Da) and polyamidoamine generation 0 (PAMAM GO; 44 w/w % in MeOH; M_{w}=516.68 Da). Samples are prepared by magnetic stirring of additives (PTHT and PEGDA) in DCM dissolution with CG for 15 minutes in predetermined ratios as shown in Table 1. DCM is then removed under vacuum. A multiple step solvent removal is monitored with NMR spectroscopy up to the point where the traces of solvent are below detection limit of the instrument.

Table 2 lists the acrylate resin and TPO molecular properties.

TABLE 1
Names and descriptions of aryl-diazirines.

| | | | State^{#} |
|---|---|---|---|
| Name | CAS | | & |
| (Abbreviation) | No. | Structure | g/mol |
| 3-Phenyl-3 (trifluoromethyl)- 3H-diazirine (Dz) | 73899- 14-6 | 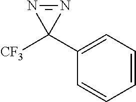 [SMILES: FC(F)(F)C1(c2ccccc2)N=N1] | Liquid 186.14 g · mol⁻¹ |
| 3-(4- (bromomethyl)phenyl)- 3-(trifluoromethyl)- 3H-diazirine (DzBr) | 92367- 11-8 | 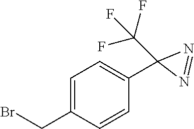 [SMILES: FC(F)(F)C1(c2ccc(CBr)cc2)N=N1] | Liquid 279.06 g · mol⁻¹ |
| 4-[3- (Trifluoromethyl)- 3H-diazirin-3- yl]benzoic acid (DzCOOH) | 85559- 46-2 | 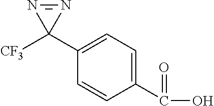 [SMILES: O=C(O)c1ccc(C2(C(F)(F)F)N=N2)cc1] | Solid 230.15 g · mol⁻¹ |
| 4-[3- (Trifluoromethyl)- 3H-diazirin-3- yl]benzyl alcohol (DzOH) | 87736- 88-7 | 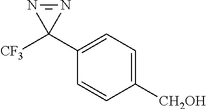 [SMILES: OCc1ccc(C2(C(F)(F)F)N=N2)cc1] | Liquid 216.16 g · mol⁻¹ |
| 2-(4-(3- (trifluoromethyl)- 3H-diazirin-3- yl)phenoxy)ethan- 1-ol^{##} (EGDz) | 271252- 33-6 | | Liquid 246.06 g · mol⁻¹ |
| CaproGlu 1000 (CG or CG1000) | NA | 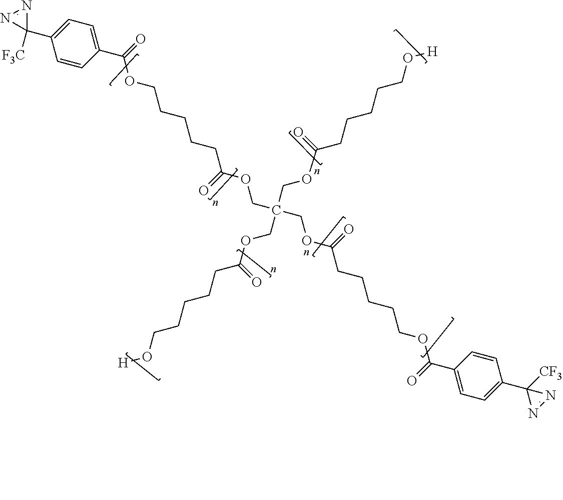 | Liquid 1500 g · mol⁻¹ |
| Tetrathiol (pentaerythritol tetrakis 3- mercaptopropionate) (PTHT) | 7575- 23-7 | 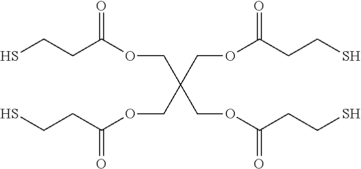 [SMILES: O=C(CCS)OCC(COC(=O)CCS)(COC(=O)CCS)COC(=O)CCS] | Liquid 488.66 g · mol⁻¹ |

^{#}State under ambient conditions; 25 deg. C. and 1 ATM.
^{##}Received from University of Victoria.

TABLE 2
Acrylate chemical, photocatalyst, and common photoinitiator example.

| Name (abbreviation) | Mw (g · mol⁻¹) | CAS No. | SKU No. | Source |
|---|---|---|---|---|
| Poly(ethylene glycol) | 575 | 26570-48-9 | 473441- | Sigma- |
| diacrylate (PEG-DA575) | | | 100 ML | Aldrich |
| 2-hydroxyethyl methacrylate | 130.14 | 868-77-9 | 128635- | Sigma- |
| (HEMA) | | | 500 G | Aldrich |
| (Ir[dF(CF₃)ppy]₂(dtbpy))PF₆ | 1121.91 | 870987-63-6 | 747793-1 G | Sigma- |
| (IRPC) | | | | Aldrich |
| Diphenyl(2,4,6- | 348.37 | 75980-60-8 | 415952-10 G | Sigma- |
| trimethylbenzoyl)phosphine | | | | Aldrich |
| oxide (TPO) | | | | |
| Tetrathiol (pentaerythritol | 488.66 | 7575-23-7 | 381462- | Sigma- |
| tetrakis 3- | | | 500 ML | Aldrich |
| mercaptopropionate) | | | | |
| (PTHT) | | | | |

Rheometry was carried out on an Anton Paar MCR 102 rheometer (Anton Paar, Singapore) equipped with a 50 N normal force plate. Normal force measurements assess volumetric shrinkages, which ranges from −5 N to −0.05 N for acrylate/photoinitiator resins (Schmidt, C. & Scherzer, T., J. Polym. Sci. B: Polym. Phys. 2015, 53, 729-739). Values between −0.05 to 2 N indicate reduction of volumetric shrinkage (negative values) or resin expansion (positive values). A PP10 parallel plate stainless steel probe was used, with a 0.2 mm measuring gap. Steady State Viscosity was measured first (shear rate 10 sec⁻¹), followed by a dynamic oscillatory strain measurement during photocuring (light ON at 30 seconds, off at 2 minutes 10 seconds, 1% shear, frequency 10 Hz, amplitude 1). The UV/visible lamp used was a Thor Labs 365/405/445 nm SOLIS High-Power LED connected to a 002200 LED Driver set to constant current mode. The light intensity at the rheometer sample area was adjusted to 100 mW·cm⁻² using a radiometer for a total dose of 10 J·cm⁻².

### Example 2. Photoinitiation of PEGDA575 with 3-phenyl-3 (trifluoromethyl)-3H-diazirine

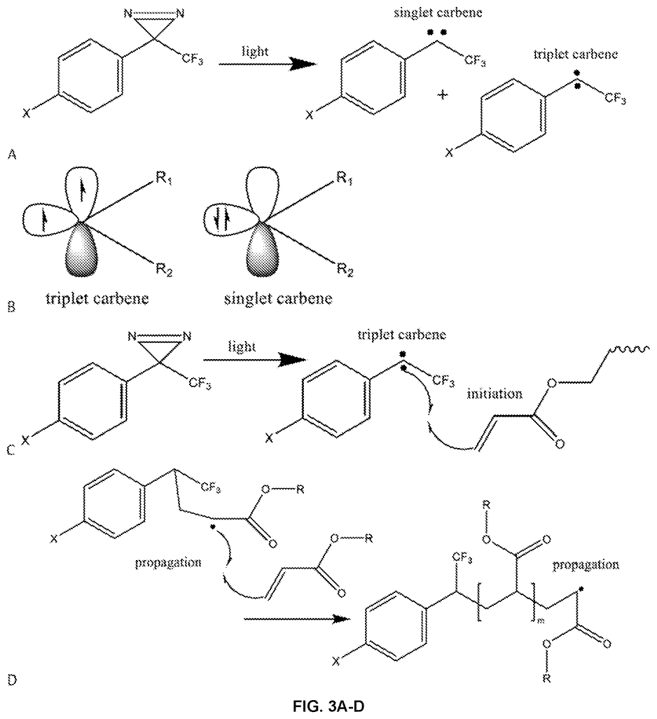

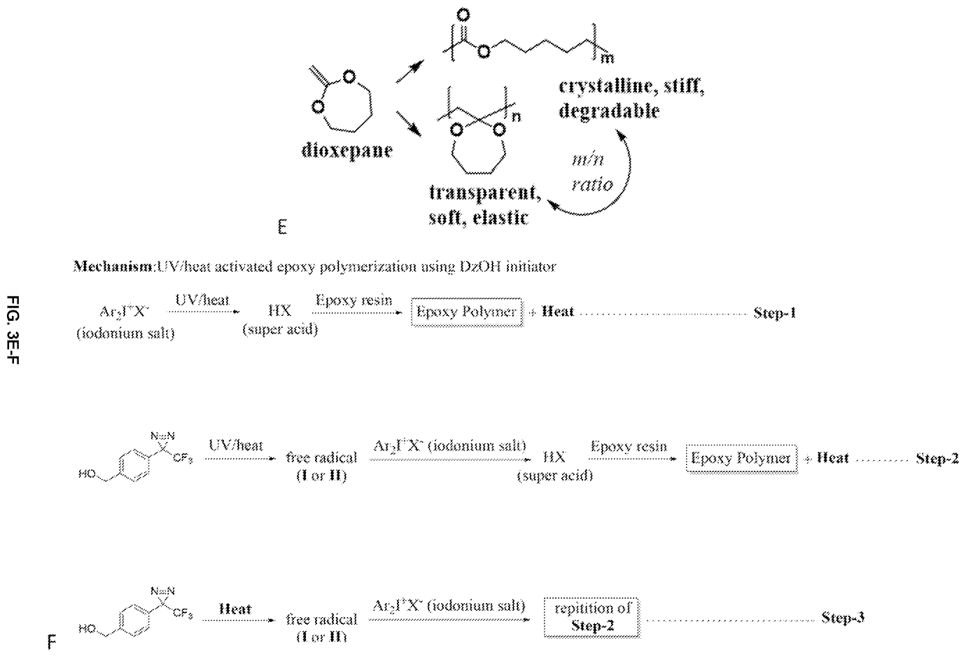

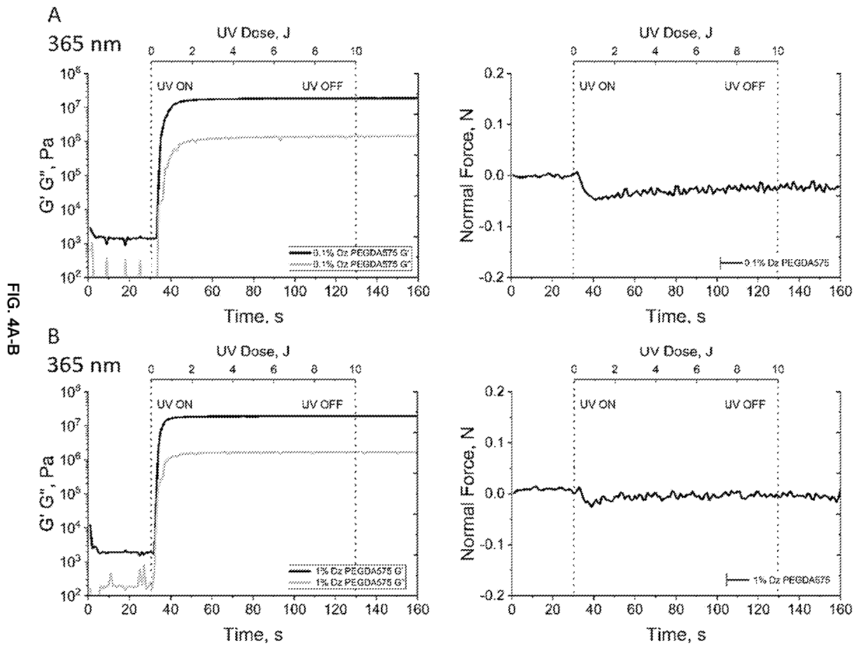

Aryl-diazirines, as shown in FIG. 3 and Table 1, are carbene precursors which differ significantly to NHCs in that they are less likely to act as nucleophiles due to electron withdrawing groups adjacent to the diazirine. FIG. 3 depicts the mechanism for UV/heat activated epoxy polymerization using DzOH initiator. The concentration of super acid produced in Step-1 is low, resulting in low concentration of epoxy polymer. In the presence of a free radical generator (DzOH), Step-2 and Step-3 take place. The heat produced in Step-1 and Step-2 of the polymerization reaction, if not dissipated to the surrounding, can further decompose the diazirine into more free radicals which in turn will result in further polymerization of the epoxy resin (Step-3). In this way, the polymerization cycle will be repeated without requiring further supply of energy.

The photoinitiation of PEGDA575 with 3-phenyl-3-(trifluoromethyl)-3H-diazirine was carried out by following the protocol in Example 1.

### Results and Discussion

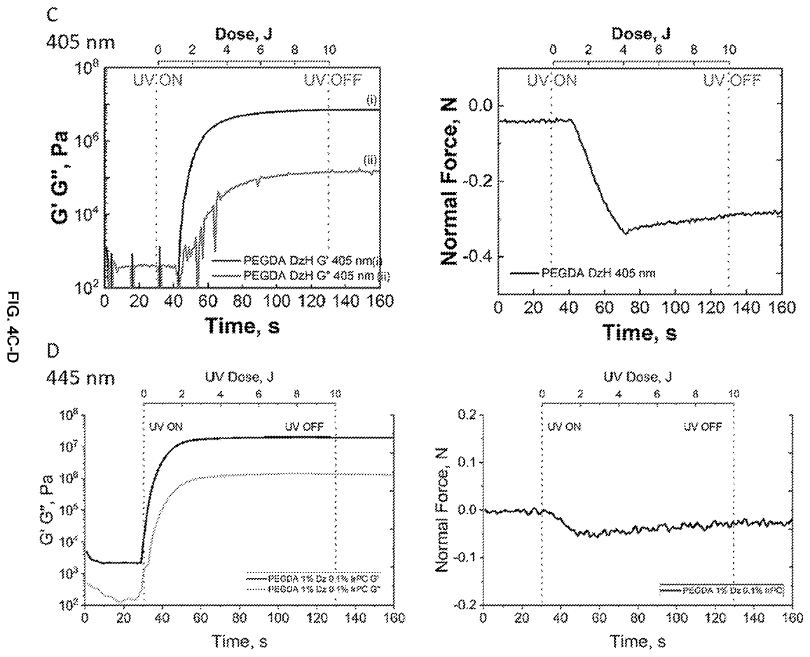

FIG. 4 displays an example of 3-phenyl-3-(trifluoromethyl)-3H-diazirine initiating PEGDA575 resin with UVA light under two concentrations of 0.1 and 1.0 mol %. Aryl-diazirine can also be activated with visible light (405 nm) or 445 nm with the aid of an iridium photocatalyst. Normal force measurements assess volumetric shrinkages, which ranges from −5 N to −0.1 N for acrylate/photoinitiator resins. Values between −0.1 to 2 N indicate reduction of volumetric shrinkage (negative values) or resin expansion (positive values).

### Example 3. Photoinitiation of PEGDA575 with 3-(4-(bromomethyl)phenyl)-3-(trifluoromethyl)-3H-diazirine

The photoinitiation of PEGDA575 with 3-(4-(bromomethyl)phenyl)-3-(trifluoromethyl)-3H-diazirine was carried out by following the protocol in Example 1.

### Results and Discussion

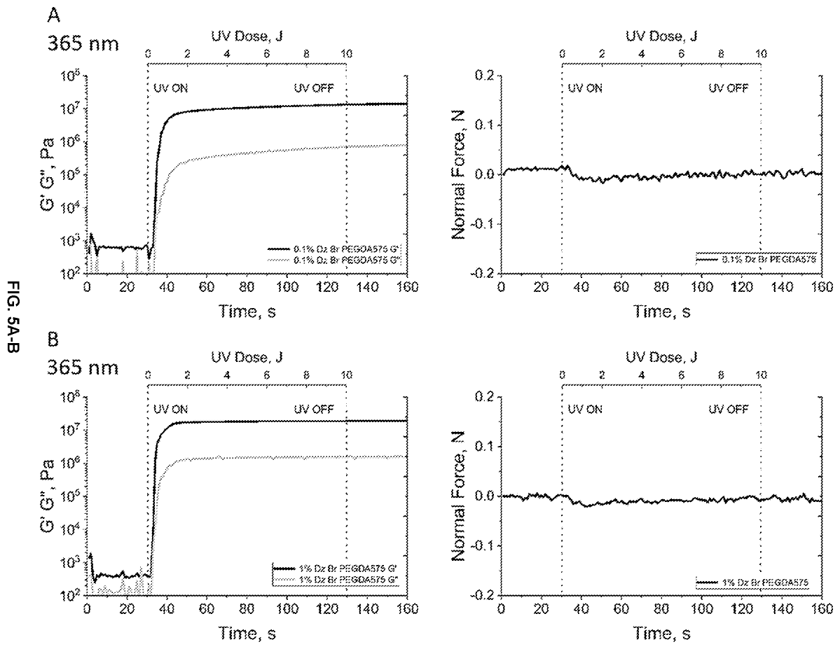

FIG. 5 displays an example of 3-(4-(bromomethyl)phenyl)-3-(trifluoromethyl)-3H-diazirine initiating PEGDA575 resin with UVA light under two concentrations of 0.1 and 1.0 mol %. Aryl-diazirine can also be activated with visible light (405 nm) or 445 nm with the aid of an iridium photocatalyst. UVA light also activates bromine radicals, but the presence of bromine radicals does not affect chain growth polymerization. Diazirine photoinitiator is unaffected by presence of bromine radicals.

### Example 4. Photoinitiation of PEGDA575 with 4-[3-(trifluoromethyl)-3H-diazirin-3-yl]benzoic acid

The photoinitiation of PEGDA575 with 4-[3-(trifluoromethyl)-3H-diazirin-3-yl]benzoic acid was carried out by following the protocol in Example 1.

### Results and Discussion

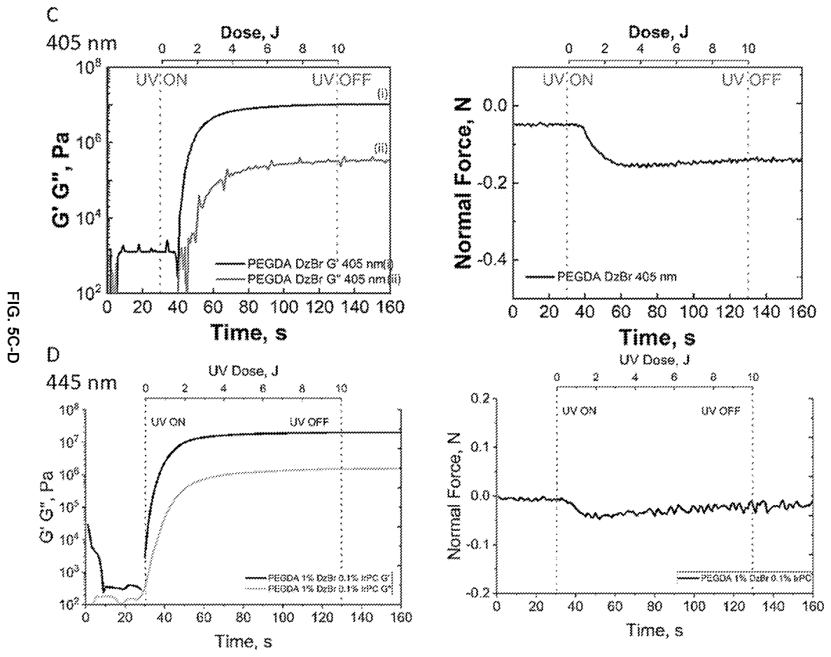

FIG. 6 displays an example of 4-[3-(trifluoromethyl)-3H-diazirin-3-yl]benzoic acid initiating PEGDA575 resin with UVA light under two concentrations of 0.1 and 1.0 mol %. Aryl-diazirine can also be activated with visible light (405 nm) or 445 nm with the aid of an iridium photocatalyst. Presence of the carboxylic acid functional group does not affect chain growth polymerization. Diazirine photoinitiator is unaffected by presence of acidic functional groups.

### Example 5. Photoinitiation of PEGDA575 with 4-[3-(trifluoromethyl)-3H-diazirin-3-yl]benzyl alcohol

The photoinitiation of PEGDA575 with 4-[3-(trifluoromethyl)-3H-diazirin-3-yl]benzyl alcohol was carried out by following the protocol in Example 1.

### Results and Discussion

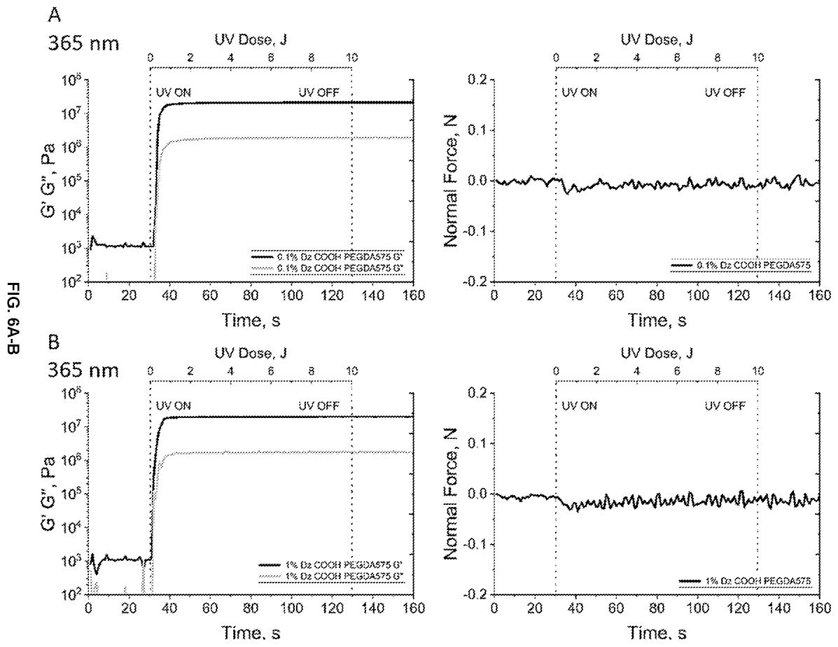

FIG. 7 displays an example of 4-[3-(trifluoromethyl)-3H-diazirin-3-yl]benzyl alcohol initiating PEGDA575 resin with UVA light under two concentrations of 0.1 and 1.0 mol %. Aryl-diazirine can also be activated with visible light (405 nm) or 445 nm with the aid of an iridium photocatalyst. Presence of the primary alcohol functional group does not affect chain growth polymerization. Diazirine photoinitiator is unaffected by presence of a primary alcohol proton donor.

### Example 6. Photoinitiation of PEGDA575 with 2-(4-(3-(trifluoromethyl)-3H-diazirin-3-yl)phenoxy)ethan-1-ol

The photoinitiation of PEGDA575 with 2-(4-(3-(trifluoromethyl)-3H-diazirin-3-yl)phenoxy)ethan-1-ol was carried out by following the protocol in Example 1.

### Results and Discussion

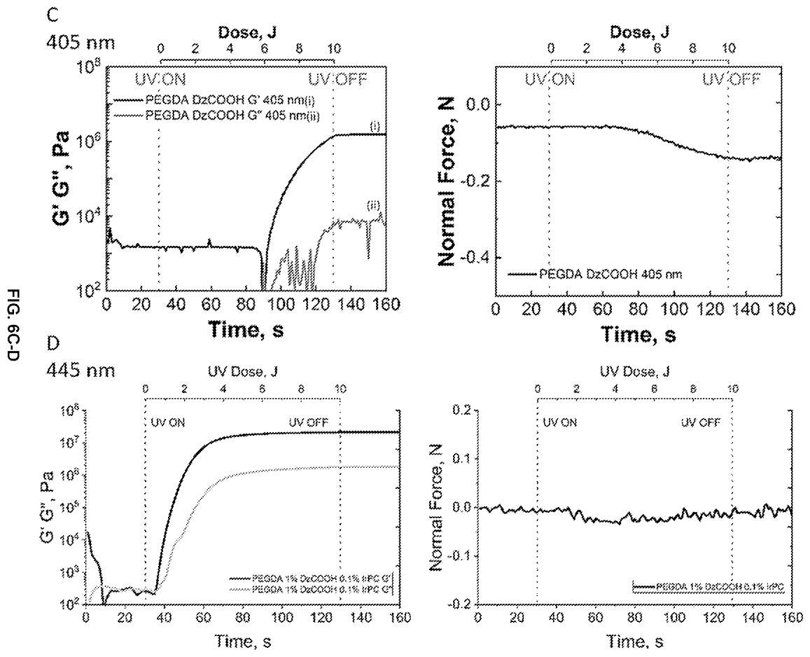

FIG. 8 displays an example of 2-(4-(3-(trifluoromethyl)-3H-diazirin-3-yl)phenoxy)ethan-1-ol initiating PEGDA575 resin with visible light (405 nm). Presence of the ether or primary alcohol functional group does not affect chain growth polymerization.

### Example 7. In Situ Generation of Aryl-Diazoalkane from Grafted Aryl-Diazirine Macromolecules

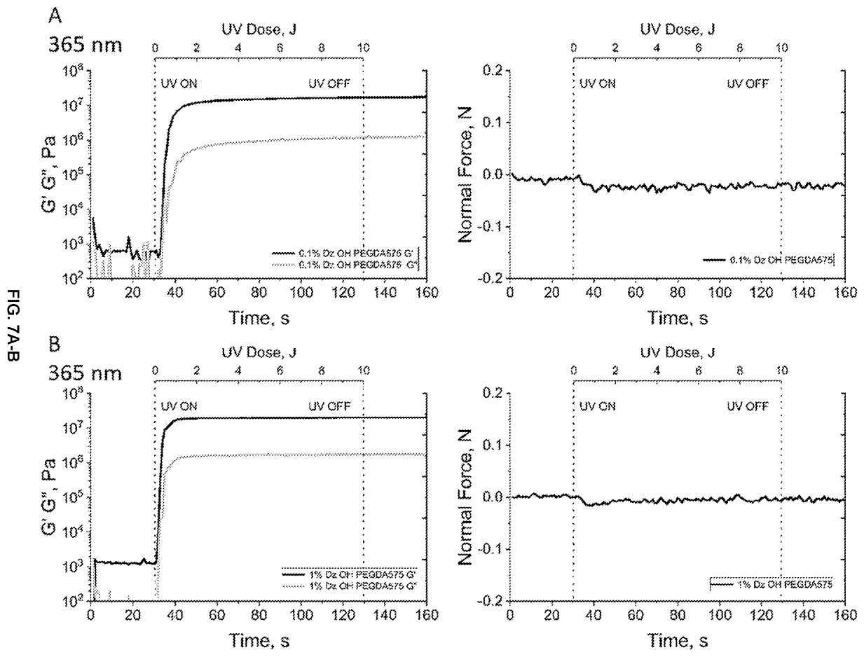

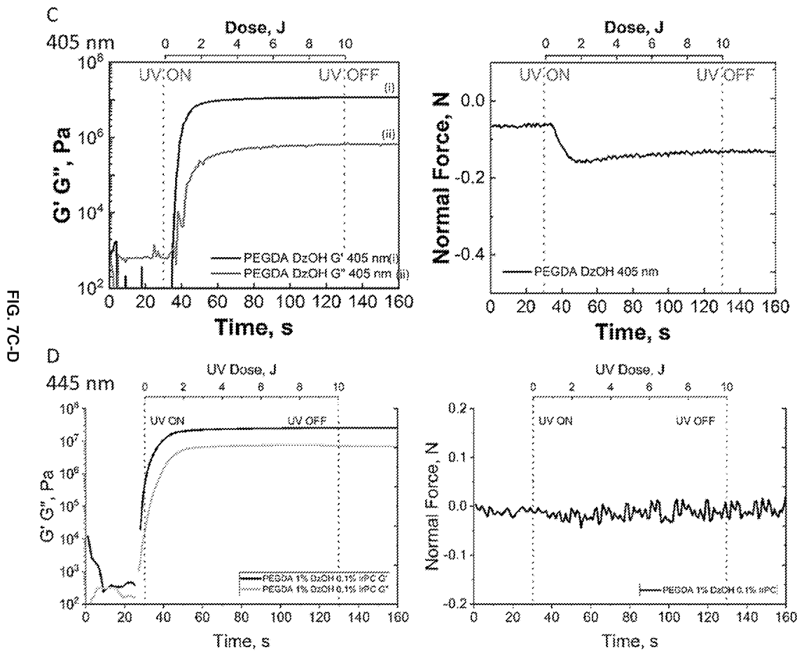

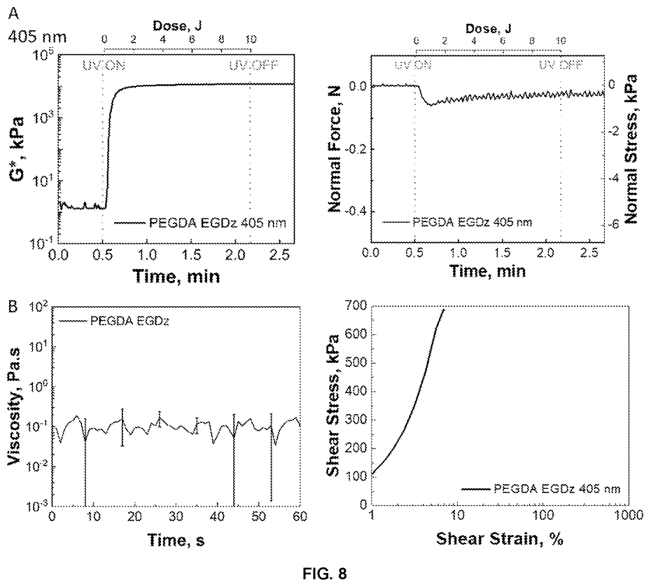

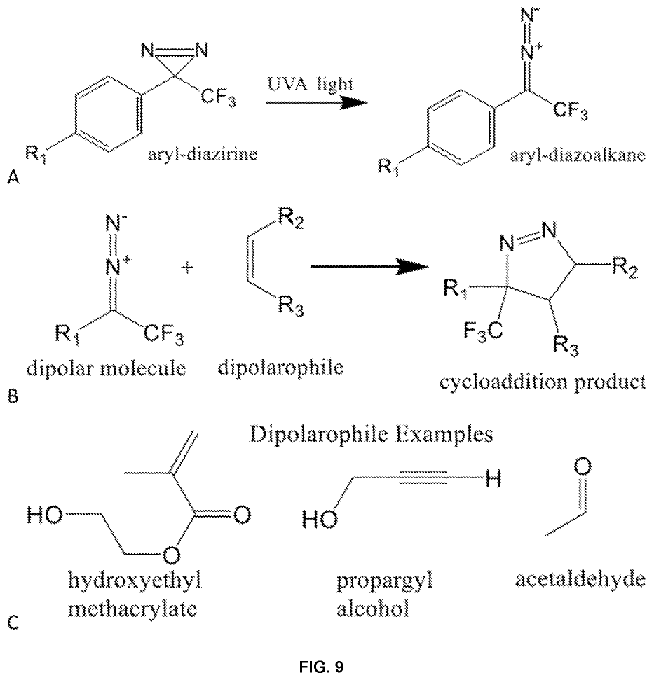

FIG. 9 depicts diazoalkanes as chemical absorbents. The photoinitiation of CaproGlu 1000 was carried out by following the protocol in Example 1.

### Results and Discussion

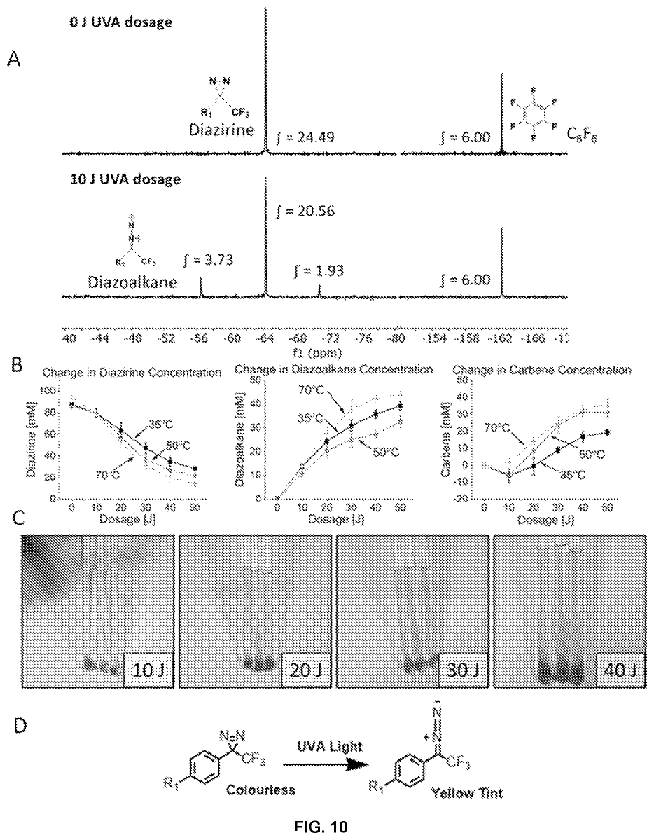

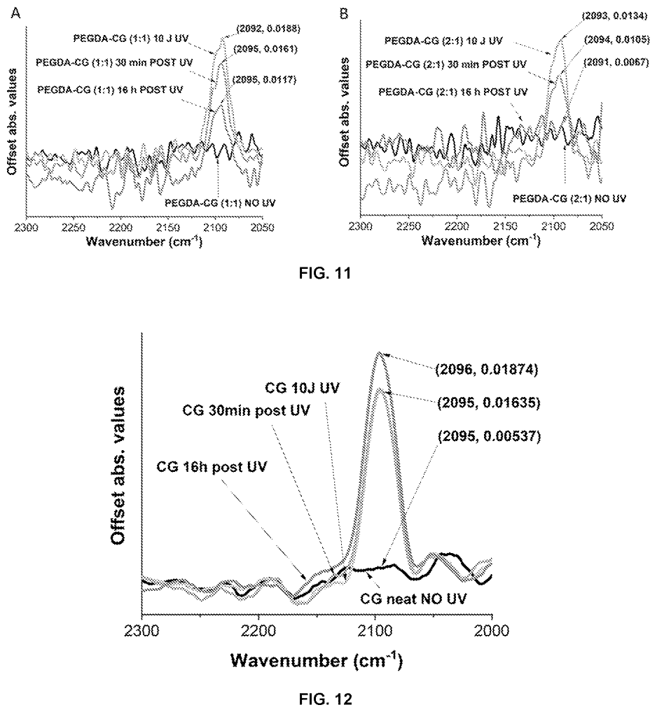

Upon UVA exposure of CaproGlu 1000, aryl-diazoalkane peaks can be quantified by ¹⁹F NMR (FIG. 10A), FTIR (FIGS. 11 and 12), or visually seen in FIG. 10C. FIG. 10B displays how controlling joules dose and temperature generates aryl-diazoalkane at specific concentrations. Empirical yields of 1% to 65% are possible.

### Example 8. Photoinitiation of PEGDA575 with CaproGlu 1000, a Carbene-Based Bioadhesive

The photoinitiation of PEGDA575 with CaproGlu 1000 was carried out by following the protocol in Example 1.

### Results and Discussion

CaproGlu 1000 initiates free radical polymerization of PEGDA575 resin with UVA light. FIG. 13 displays an example of CaproGlu 1000 initiating PEGDA575 resin with UVA light under two concentrations of 0.1 and 1.0 mol %. Aryl-diazirine can also be activated with visible light (405 nm) or 445 nm with the aid of an iridium photocatalyst. Grafting aryl-diazirines onto macromolecules does not affect chain growth polymerization.

The UVA exposure simultaneously generates aryl-diazoalkane, as seen in the FTIR peak of 2092 cm⁻¹, but only after light exposure. Photoinitiation reactions generally have at least >10% unreacted monomer when using photoinitiators at 1 mol %. Within 30 minutes post-UVA exposure, aryl-diazoalkane started to decay via dipolar cycloaddition with acrylate dipolarophile, as shown in the 1:1 ratio of PEGDA575:CaproGlu-1000 (FIG. 11A). Further peak reduction was seen after 16 hours. Increasing the PEGDA575:CaproGlu-1000 to 2:1 in FIG. 11B shows a complete loss of aryl-diazoalkane peak after 16 hours. Control experiments with CaproGlu 1000 mixed with thiol or hydroxyl additives displayed no decay of aryl-diazoalkane after 16 hours (FIG. 14). Aryl-diazoalkane is removed by unreacted acrylate functional groups after free radical photopolymerization. Diazirine photoinitiator is unaffected by grafting onto macromolecules.

### Example 9. In Situ Generated Aryl-Diazoalkane Decays after Addition of Aldehyde Functional Group

In situ generated aryl-diazoalkane decays after addition of aldehyde functional group Aryl-diazoalkane was generated in situ by 10 J UVA exposure to 4-[3-(trifluoromethyl)-3H-diazirin-3-yl]benzoic acid or CaproGlu 1000 (both at 30 mg in 0.6 mL CDCl₃). ¹⁹F NMR was recorded with C₆F₆ as ppm standard. Subsequently, 10 mg of gallic aldehyde was added and ¹⁹F NMR was recorded at 5 minutes and 18 hours.

### Results and Discussion

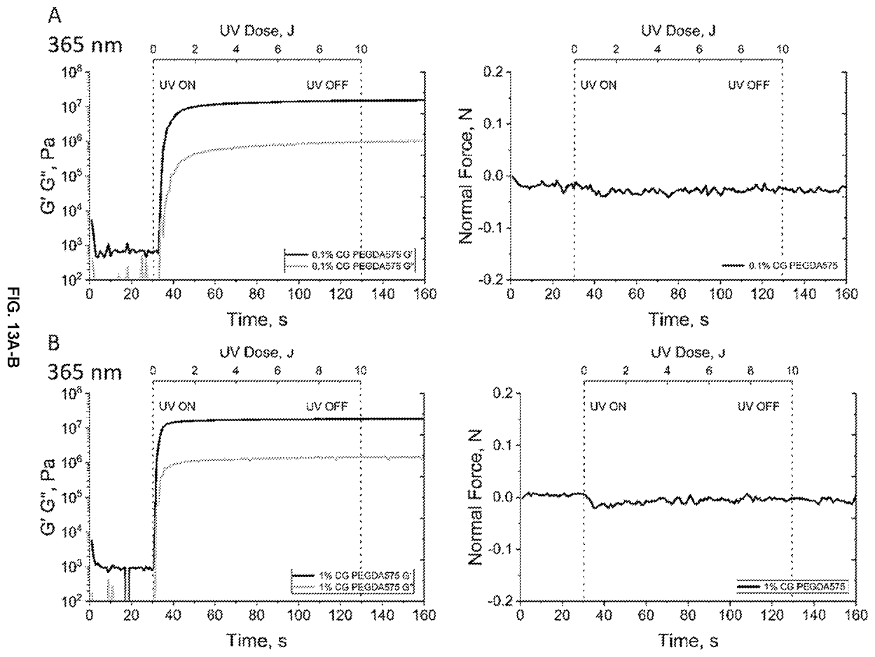

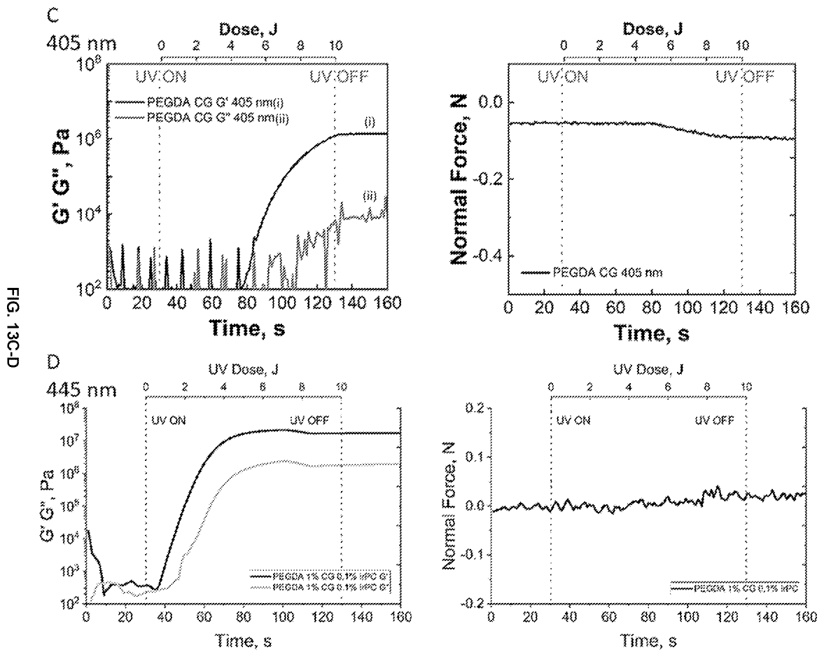

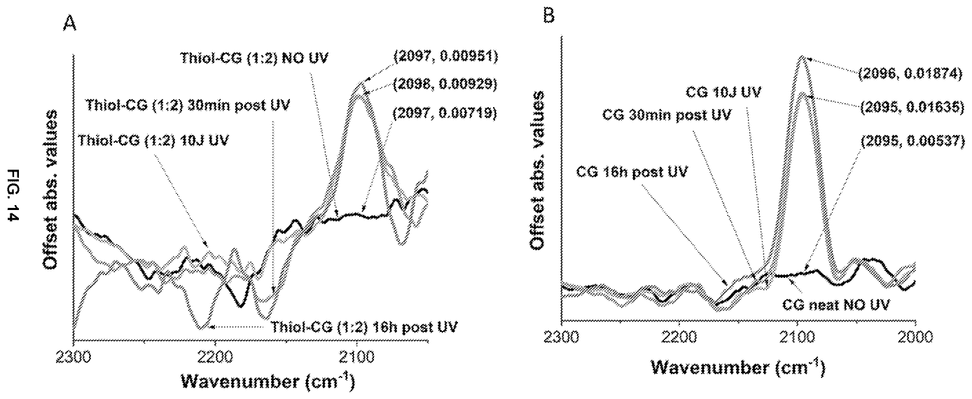

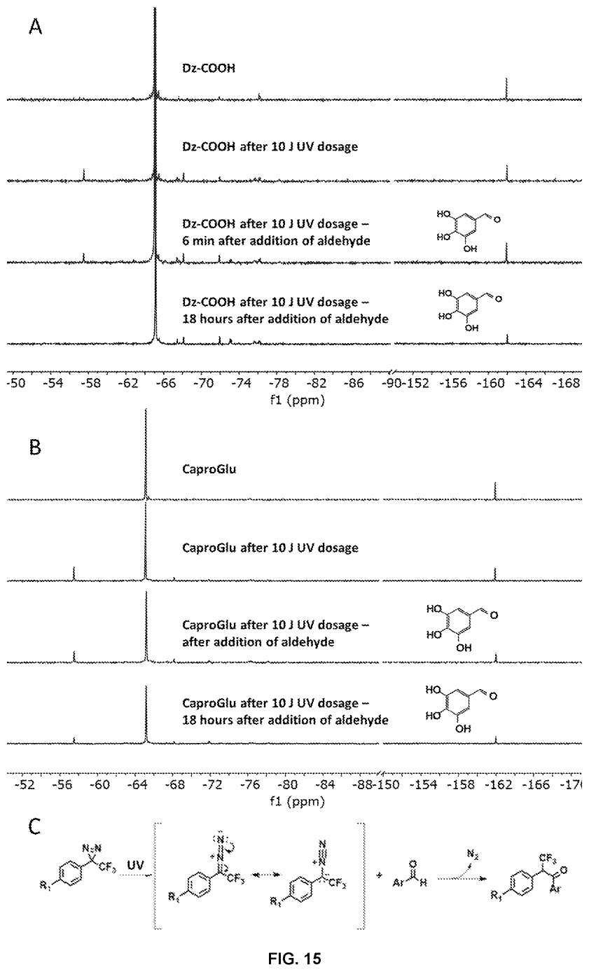

Complete reduction of aryl-diazoalkane peak (−56 ppm) was noted for the small molecule diazoalkane (FIG. 15A) while the macromolecule grafted diazoalkane was 50% consumed (FIG. 15B). A number of Buchner-Curtius-Schlotterbeck reaction products are possible, with one ketone derivative shown in FIG. 15C.

### Example 10. Photoinitiation of PEGDA575 with TPO and with UVA Light Only

All experiments are performed on an Anton Paar MCR 102 modular compact rheometer (Anton Paar, Singapore) with a photocuring setup in a parallel plate configuration. A UV light source is illuminated beneath the transparent sample base. A PP10 (10 mm diameter) parallel plate stainless steel probe is used at a 0.2 mm probe-base gap. Steady-state viscosity is first measured against a shear rate of 10 s⁻¹. This is followed by dynamic oscillatory strain measurement with 1% shear, 10 Hz frequency, and 1% amplitude. During this measurement, the formulation is irradiated by 365 nm (UVA) light for 100 seconds (LIGHT ON at 30 seconds, OFF at 130 seconds) for a total dose of 10 J·cm⁻² (100 mW·cm⁻²). Concurrently, the normal force acting on the probe is measured during the photopolymerization. This is followed by an amplitude sweep (1% to 1000% shear, angular frequency of 10 rad·sec⁻¹). The UV diode is a THORLABS 365 nm SOLIS High-Power LED connected to a DC2200 LED Driver (THORLABS, USA) set to constant current mode. The light intensity is calibrated with Newport Power Meter Model 843-R with a 919P thermopile sensor (Newport, USA). All measurements are performed in triplicates. A smoothening function is applied to the steady state viscosity (rq), storage and loss moduli (G′, G″), and normal force measurements (N).

### Results and Discussion

FIG. 16 displays an example of TPO (1.0% mol) initiating PEGDA575 resin with visible 405 nm and UVA 365 nm light at 1.0 mol %. Both displayed higher negative normal forces, indicating volumetric. Visible or UVA irradiation of PEGDA575 with no photoinitiator displayed no crosslinking or change in normal force, demonstrating initiator is required for free radical polymerization.

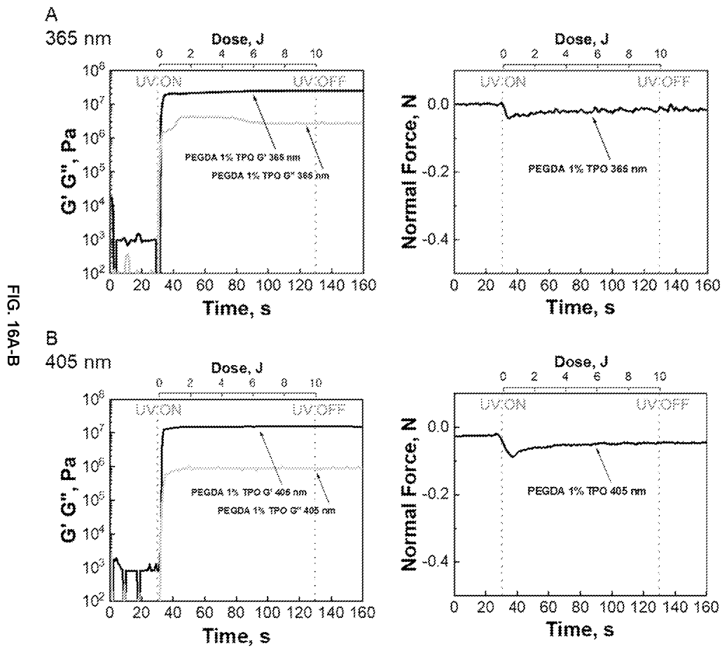

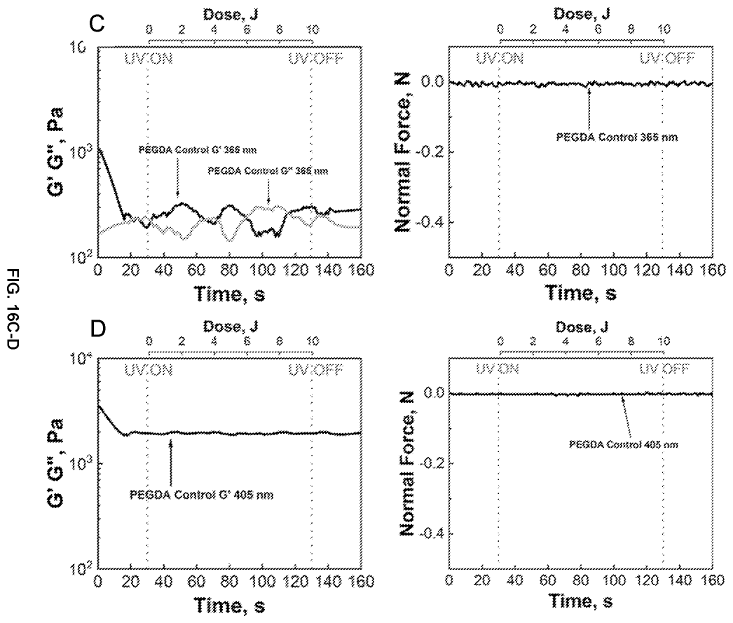

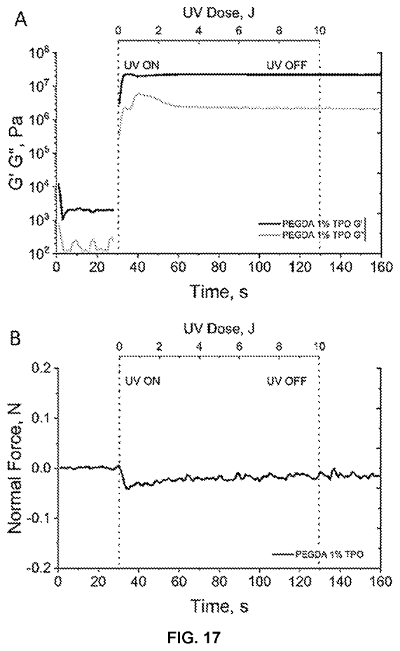

FIG. 17 also displays an example of TPO initiating PEGDA575 resin with UVA light under two concentrations of 0.1 and 1.0 mol %. TPO displays more volumetric shrinkage than aryl-diazirine.

### Example 11. Photoinitiation of PEGDA575 with Aryl-Diazirines Diluted with Toluene Solvent

All experiments are performed on an Anton Paar MCR 102 modular compact rheometer (Anton Paar, Singapore) with a photocuring setup in a parallel plate configuration. A UV light source is illuminated beneath the transparent sample base. A PP10 (10 mm diameter) parallel plate stainless steel probe is used at a 0.2 mm probe-base gap. Steady-state viscosity is first measured against a shear rate of 10 s⁻¹. This is followed by dynamic oscillatory strain measurement with 1% shear, 10 Hz frequency, and 1% amplitude. During this measurement, the formulation is irradiated by 365 nm (UVA) light for 100 seconds (LIGHT ON at 30 seconds, OFF at 130 seconds) for a total dose of 10 J·cm⁻² (100 mW·cm⁻²). Concurrently, the normal force acting on the probe is measured during the photopolymerization. This is followed by an amplitude sweep (1% to 1000% shear, angular frequency of 10 rad·sec⁻¹). The UV diode is a THORLABS 365 nm SOLIS High-Power LED connected to a DC2200 LED Driver (THORLABS, USA) set to constant current mode. The light intensity is calibrated with Newport Power Meter Model 843-R with a 919P thermopile sensor (Newport, USA). All measurements are performed in triplicates. A smoothening function is applied to the steady state viscosity (rq), storage and loss moduli (G′, G″), and normal force measurements (N).

### Results and Discussion

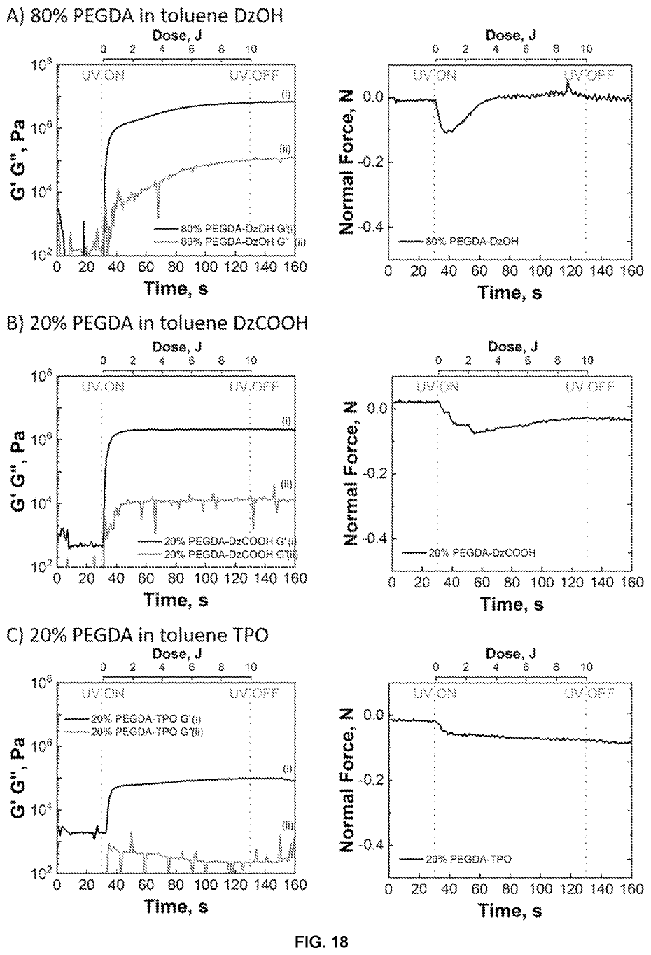

FIG. 18 displays an example of two aryl-diazirine initiating PEGDA575 resin even in the presence of diluting organic solvent under standard conditions with UVA light and 1.0 mol % initiator. Presence of the toluene solvent does not affect chain growth polymerization.

### Example 12. Photoinitiation of PEGDA575 with Aryl-Diazirines Diluted with Aqueous Solvent

All experiments are performed on an Anton Paar MCR 102 modular compact rheometer (Anton Paar, Singapore) with a photocuring setup in a parallel plate configuration. A UV light source is illuminated beneath the transparent sample base. A PP10 (10 mm diameter) parallel plate stainless steel probe is used at a 0.2 mm probe-base gap. Steady-state viscosity is first measured against a shear rate of 10 s⁻¹. This is followed by dynamic oscillatory strain measurement with 1% shear, 10 Hz frequency, and 1% amplitude. During this measurement, the formulation is irradiated by 365 nm (UVA) light for 100 seconds (LIGHT ON at 30 seconds, OFF at 130 seconds) for a total dose of 10 J·cm⁻² (100 mW·cm⁻²). Concurrently, the normal force acting on the probe is measured during the photopolymerization. This is followed by an amplitude sweep (1% to 1000% shear, angular frequency of 10 rad·sec⁻¹). The UV diode is a THORLABS 365 nm SOLIS High-Power LED connected to a DC2200 LED Driver (THORLABS, USA) set to constant current mode. The light intensity is calibrated with Newport Power Meter Model 843-R with a 919P thermopile sensor (Newport, USA). All measurements are performed in triplicates. A smoothening function is applied to the steady state viscosity (rq), storage and loss moduli (G′, G″), and normal force measurements (N).

### Results and Discussion

FIG. 19 displays an example of two aryl-diazirine initiating PEGDA575 resin even in the presence of diluting aqueous solvent of PBS under standard conditions with UVA light and 1.0 mol % initiator. Presence of the water or phosphate salts does not affect chain growth polymerization. TPO displays more volumetric shrinkage than aryl-diazirine. UVA irradiation of PEGDA575 dissolved in water with no photoinitiator displayed no crosslinking or change in normal force, demonstrating initiator is required for free radical polymerization.

### Example 13. Photoinitiation of Thiolene Resins with an Ungrafted 4-[3-(Trifluoromethyl)-3H-Diazirin-3-Yl]Benzyl Alcohol or a Diazirine-Grafted Macromolecule Based on CaproGlu

Photoinitiation of Thiol/Ene Resins with an Ungrafted 4-[3-(Trifluoromethyl)-3H-Diazirin-3-Yl]Benzyl Alcohol or a Diazirine-Grafted Macromolecule Based on CaproGlu

Polyethylene glycol diacrylate (M_{w}˜575 Da), referred to as “PEGDA” further in text is used in all the experiments. PEGDA/PTHT samples are prepared by magnetic stirring of PEGDA and PTHT polymer blend (2:1 molar ratio) with diazirine photoinitiators (1 mol % DzOH or 1 mol % CG relative to the total number of mols of PEGDA in each sample). Samples with standard TPO photoinitiator (1 mol %) are used as controls. The mixing of compounds (PEGDA+PTHT) in binary mixture with photoinitiators (DzOH, CG and TPO) is completed without any solvent. Binary mixtures with diazirine were stable under indoor lighting, unlike TPO mixtures which are activated under indoor light.

### Results and Discussion

FIG. 20 depicts the experimental results. Formulations with TPO initiator were unstable and prematurely crosslinked under fluorescent lights and white LED emitters. Hence, they display no liquid material properties before light exposure. Formulations with TPO initiator display larger negative volumetric shrinkage than diazirine initiators. UVA irradiation of PEGDA575/PTHT with no photoinitiator displayed no crosslinking or change in normal force, demonstrating initiator is required for free radical polymerization of thiol/ene resins.

### Example 14. Photoinitiation of PEGDA575 with Aryl-Diazirines Exhibits Degree of Conversion Greater than 60% in the Presence of Ambient Oxygen Conditions

FTIR analysis is performed on a PerkinElmer Frontier FTIR (PerkinElmer, Singapore) in attenuated total reflectance (ATR) mode. The parameters are set to a wavelength of 600 cm⁻¹ to 4000 cm⁻¹, 32 scans, and a resolution of 4 cm⁻¹. Neat formulation samples are measured by pipetting directly onto the ZnSe crystal. Photopolymerized samples are produced by irradiating droplets of the formulation on a glass slide and placing a droplet onto the ATR crystal. Samples are irradiated with 365 nm (UVA) wavelength for the total dose of 10 J·cm⁻² (UV diode strength: 100 mW·cm⁻²). Pressure is applied using the anvil arm to maximize contact between the sample and crystal. The UV lamp used was a THORLABS 365 nm SOLIS High-Power LED connected to a DC2200 LED Driver (THORLABS, USA) set to constant current mode. The light intensity is calibrated with Newport Power Meter Model 843-R with a 919P thermopile sensor (Newport, USA). All measurements are performed in triplicates. A baseline correction is then performed with a smoothening function on the Spectrum software (PerkinElmer, USA). Degree of conversion (DC) is calculated using Equation 1:

$$D C ( \% ) = ( 1 - \frac{{A}^{polymerized}}{{A}^{n e a t}} ) \times 100 \qquad Eq . 1$$

$$Where , {A}^{polymerized} = \frac{{R}^{evaluated}}{{R}^{reference}} , {A}^{n e a t} = \frac{{R}^{evaluated}}{{R}^{reference}} \qquad Eq . 2 , Eq . 3$$

Data readings (R) are used to calculate absorbances (A) normalized to carbonyl peaks (R^{reference}) detected at 1720 cm⁻¹.

### Results and Discussion

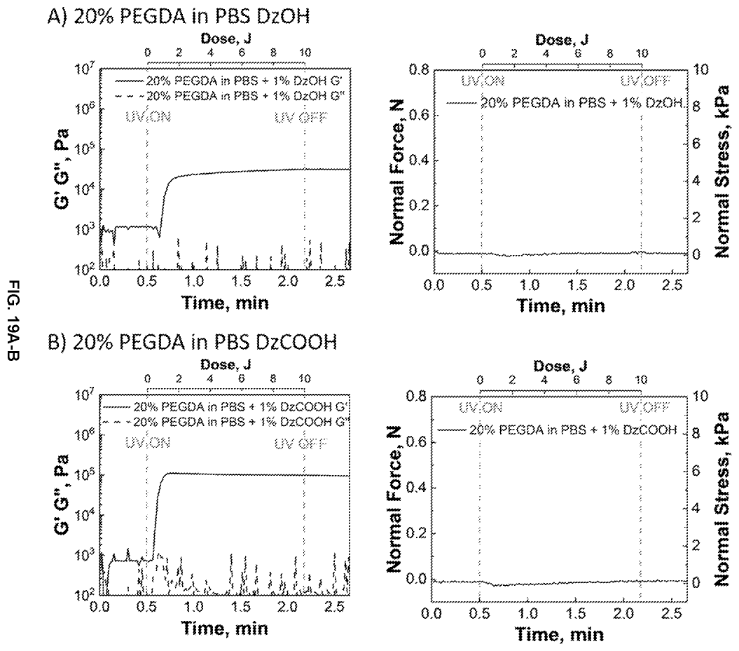

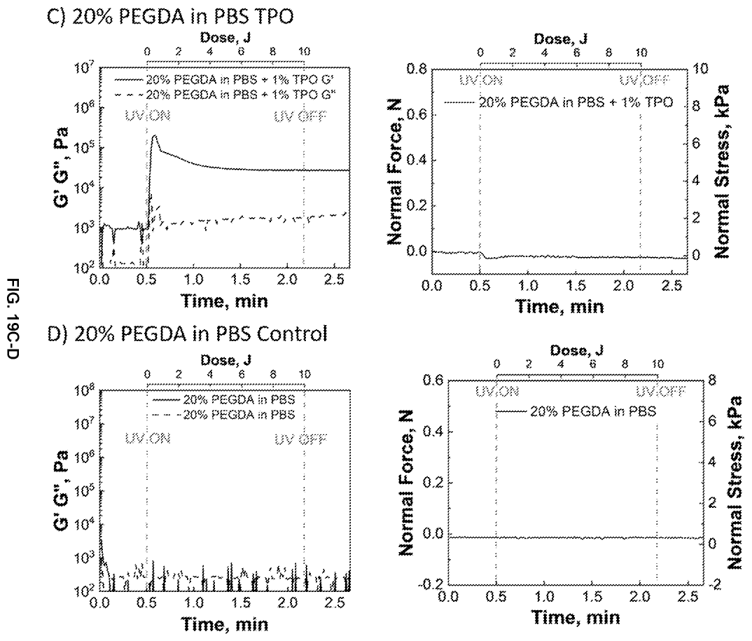

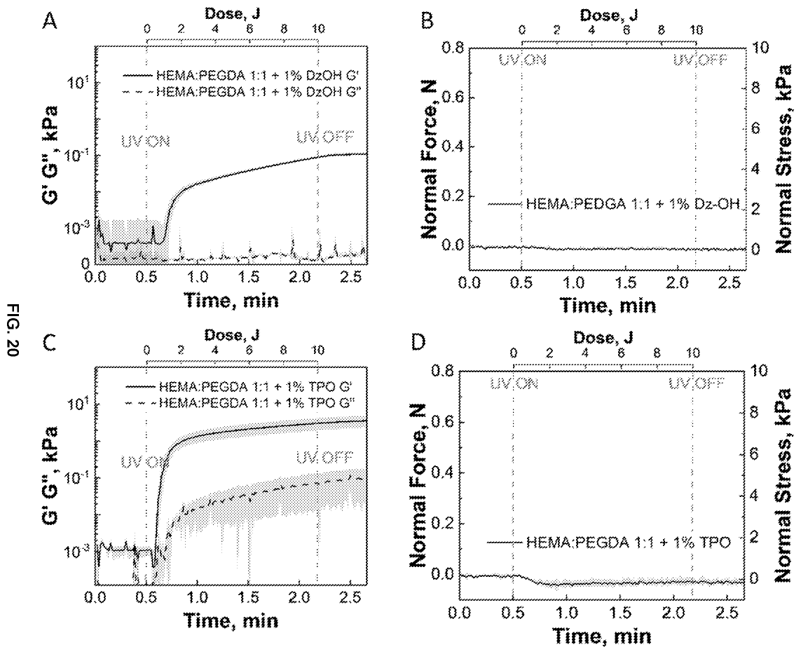

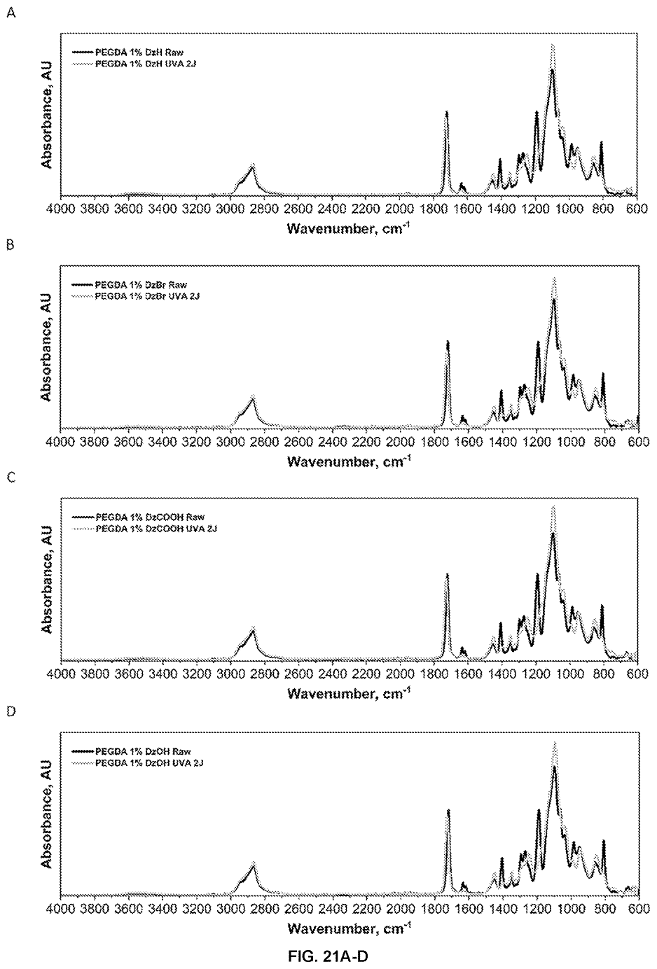

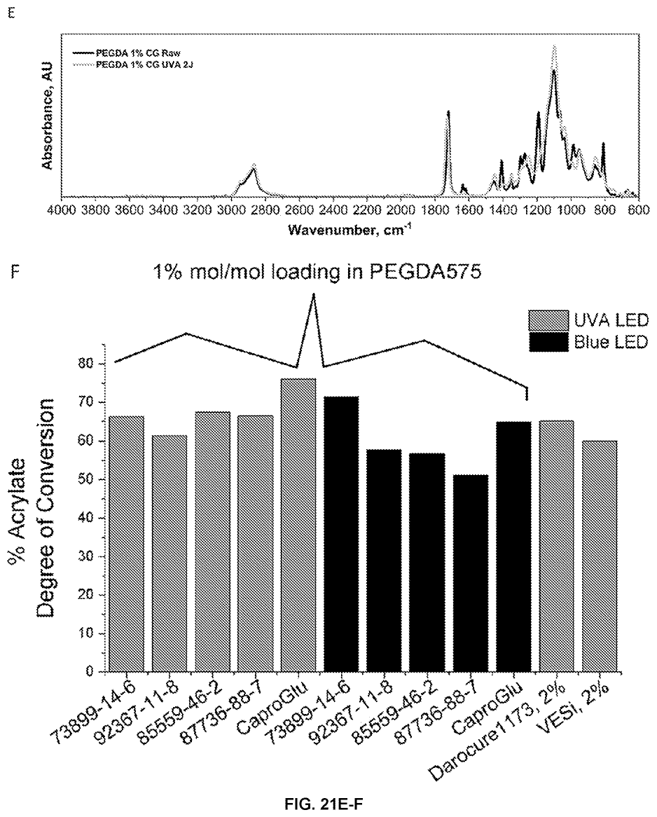

FIG. 21 depicts the degree of conversion of PEGDA575 monomers into crosslinked resins assessed via FTIR spectroscopy. Degree of conversion ranges from 50-78%, which is similar to TPO and camphorquinone photoinitiators that have 50-80% degree of conversion under ambient oxygen conditions.

### Example 15. Photographs of PEGDA575 Cured with Aryl-Diazirine Exhibits Transparent, Flexible Films

Samples are cured with a 365 nm UV torch (UVA LED Thorlabs SOLIS 365C) until 10 J·cm⁻² UV activation was reached (100 seconds at 100 mW·cm⁻²).

### Results and Discussion

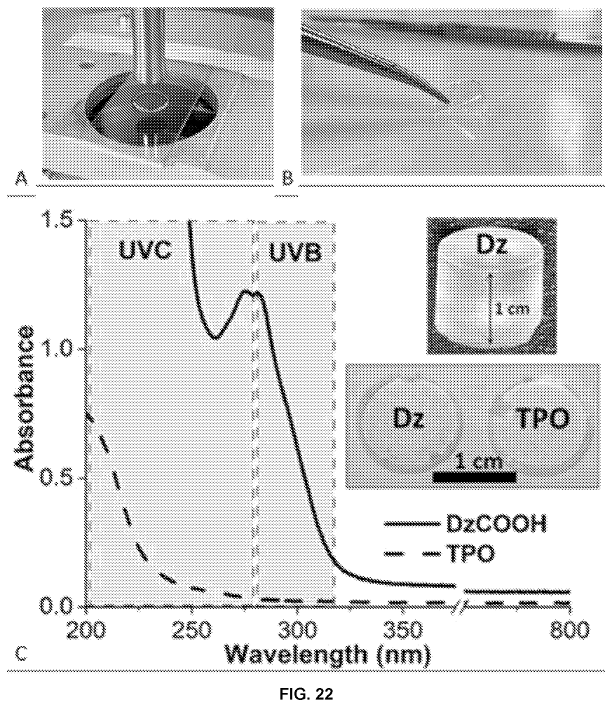

FIG. 22 depicts the photographs of cured films under UVA. These photographs show that the cured films have excellent cosmetic appearance with no yellow discoloration noted. Films are transparent and relatively flexible. The latter trait is a known feature of PEGDA575-based resins. Coatings with thickness of 1 cm or greater are possible due to the relatively low molar absorption coefficient of carbene precursor CAS #85559-46-2. Unlike TPO, carbene precursor results in a photocured polymer that absorbs harmful UVB and UVC wavelengths, which is especially useful for food packaging, sunlight resistant coatings, and sunblock lotions.

### Example 16. Photosynthesis Process and Production of Aryl-Diazoalkane Through Optimized Exposure and Temperature Conditions

### Photosynthesis Procedures and Sample Preparation

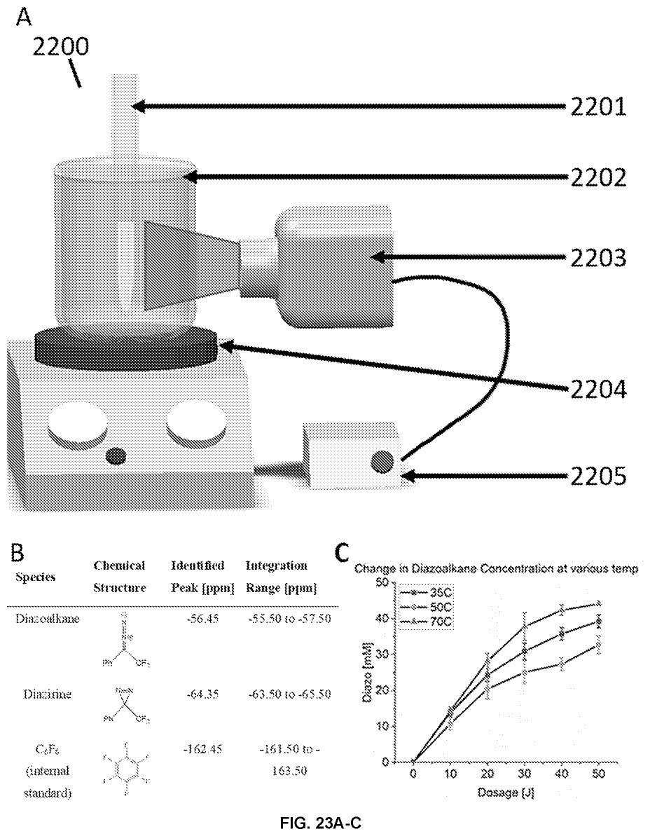

A stock solution of 2297.6 mg CaproGlu-1000 was mixed with 0.3% vol C₆F₆ (¹⁹F internal standard) and diluted with dimethyl sulfoxide (DMSO) in a 25 mL volumetric flask. After dissolving CaproGlu, 0.6 mL of the stock solution was placed into a NMR tube and the mass was recorded. The tube was sealed by glass melting. ¹⁹F NMR scan (0 J UVA Dosage) evaluates blank. The tube was immersed in a matching light refractive index liquid, such as light mineral oil for borosilicated glass at a preset temperature of 35-70° C. Sample was heated for 1 minute, and then the UVA Lamp was turned on for 100 seconds (light intensity=100 mW·cm⁻²) for a UV dosage of 10 J. ¹⁹F NMR scan (10 J UVA Dosage) evaluates process. Exposure was repeated for subsequent readings at 20 J, 30 J, 40 J and 50 J UVA dosage. FIG. 23A depicts the experimental setup 2200 for the ¹⁹F NMR experiment. The experimental setup 2200 includes a NMR tube with sample 2201, a beaker filled with light mineral oil 2202, a UV LED of wavelength 365 nm, at intensity of 100 mW·cm⁻² 2203, a heating plate 2204, and a UV LED driver (ON/OFF) 2205.

### Results and Discussion

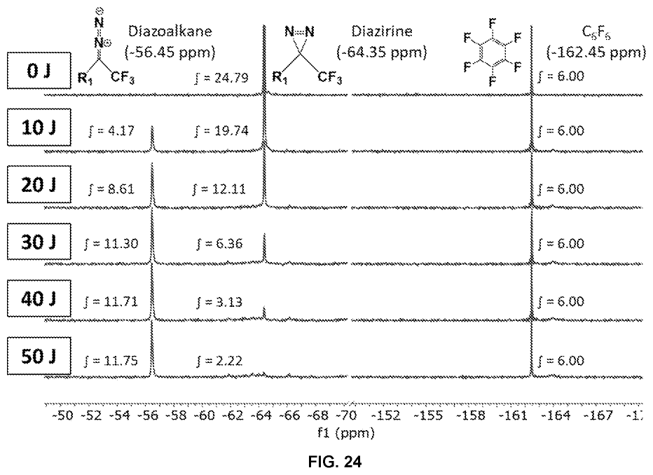

FIGS. 23 and 24 depict aryl-diazoalkane generated from Dz as a function of temperature and UVA joules exposure. Diazoalkane generation was observed from 0-50 J UVA dosage at 25-70° C. Diazirine has been converted to diazoalkane with empirical yields of 40% and no trace of aryl-diazirine.

### Example 17. Photoinitiation of Epoxy Resins with Aryl-Diazirines and Iodonium Super Acids

Photoinitiation of Epoxy Resins with Aryl-Diazirines and Iodonium Super Acids

DzOH (0.0198 mmol) was dissolved in a mixture of 3,4-epoxycyclohexylmethyl 3,4-epoxycyclohexanecarboxylate (CE, 1.98 mmol) and [4-[(2-hydroxytetradecyl)oxy]phenyl]phenyliodonium hexafluoroantimonate (iodonium salt, 0.0198 mmol). The formulation was placed in a sample vial and irradiated with UV light (365 nm for 100 s @ 100 mW/cm²).

### Results and Discussion

When CAS #87736-88-7 is present in an epoxy/iodonium salt super acid, the free radical produced from diazirine, reacts with onium salt to produce super acid, resulting in an overall increase super acid concentration that leads to initiation and polymerization of epoxy resin.

### Example 18. Sample Preparation of CaproGlu Binary Polymer Composites

Samples were prepared by magnetic stirring of additives directly (or through co-solvent dichloromethane) dissolution with CaproGlu for 15 minutes in concentrations described in Table 3. PCLT does not require solvent. PTHT and PEGDA575 samples (except 46:1, where no dichloromethane (DCM) was used due to low viscosity) were mixed in 2 mL DCM (5 mL for 1200 mg CaproGlu samples), which was then removed under vacuum. Samples were stored in the fridge until use. PAMAM GO containing samples were used immediately due to the ester lability in the presence of amines.

TABLE 3
Structure of additives and composition of formulations used in binary polymer composites.

| | | Target | | | |
|---|---|---|---|---|---|
| | | func- | | | |
| | | tio | | | % |
| | | nal- | | Addi- | Dilution |
| | Sample | group | CaproGlu | tive | of |
| Structure of Additive | Name | ratio* | (mg) | (mg) | CaproGlu |
| 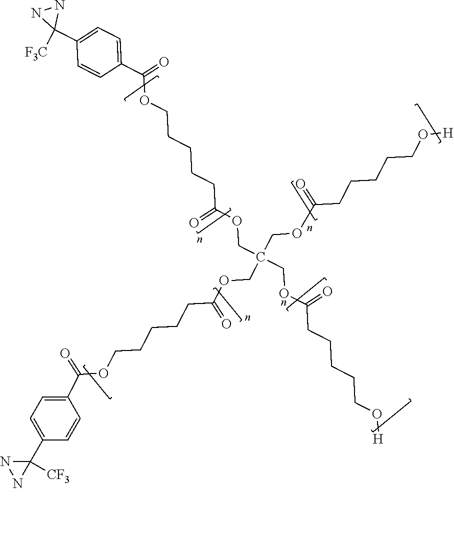 CaproGlu, Mw = 1500 g · mol⁻¹, viscosity = 6417 ± 24 mPa · s | CG Ctrl | 0:1 | 300 | 0 | 0 |
| 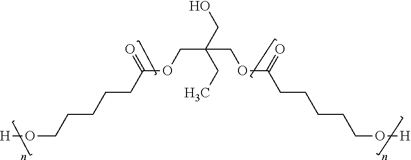 PCLT 300, Mw = 300 g · mol⁻¹, viscosity = 3295 ± 46 mPa · s | PCLT:CG 1:2 PCLT:CG 1:1 PCLT:CG 2:1 | 1:2 1:1 2:1 | 300 303 303 | 21 40 78 | 7 13.2 25.7 |
| 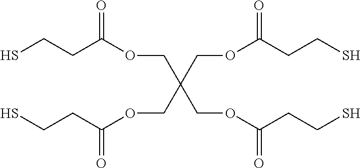 [SMILES: O=C(CCS)OCC(COC(=O)CCS)(COC(=O)CCS)COC(=O)CCS] PTHT, Mw = 488.66 g · mol⁻¹, viscosity = 667 ± 49 mPa · s | PTHT:CG 1:2 PTHT:CG 1:1 PTHT:CG 2:1 | 1:2 1:1 2:1 | 301 304 304 | 24 46 104 | 7.9 15.1 34.2 |
| 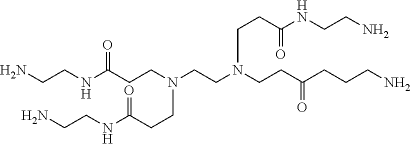 [SMILES: NCCCC(=O)CCN(CCC(=O)NCCN)CCN(CCC(=O)NCCN)CCC(=O)NCCN] PAMAM GO, Mw = 516.68 g · mol⁻¹, viscosity = 1090 + 48 mPa · s | PAMAM: CG 1:4 PAMAM: CG 1:2 PAMAM:C G1:1 | 1:4 1:2 1:1 | 300 300 300 | 11 20 40 | 3.6 6.7 13.3 |
| 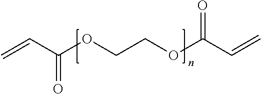 PEG-DA575, Mw = 575 g.mol-1, viscosity = 91 + 44 mPa · s | PEG- DA575:CG 1:1 PEG- DA575:CG 2:1 PEG- DA575:C | 1:1 2:1 1:2 | 1200 1200 300 | 460 920 61 | 38.3 76.7 20.3 |
| | G1:2 | | | | |
| | PEG- | 4:1 | 300 | 470 | 156 |
| | DA575:C | | | | |
| | G 4:1 | | | | |
| | PEG- | 46:1 | 25 | 448 | 1792 |
| | DA575:C | | | | |
| | G 46:1 | | | | |
| | PEG- | 46:1 | 0 | 200 | NA |
| | DA575:T | | | | |
| | PO | | | | |

*Ratio of terminal functional group on additive with respect to amount of diazirine on CaproGlu in formulation (For PCLT samples, the OH on CaproGlu is not included in ratio).

### Example 19. Photorheometry of CaproGlu Binary Formulations

Rheometry was carried out on an Anton Paar MCR 102 rheometer (Anton Paar, Singapore) with a custom photocuring setup as described previously (Djordjevic, I. et al., Biomaterials 2020, 260, 120215). A PP10 parallel plate stainless steel probe was used, with a 0.2 mm measuring gap. Steady State Viscosity was measured first (shear rate 10 sec⁻¹), followed by a dynamic oscillatory strain measurement during photocuring (UV ON at 30 seconds, off at 2 minutes 10 seconds, 1% shear, frequency 10 Hz, amplitude 1%), then an Amplitude Sweep (shear 1-1000-%, angular frequency 10 rad-sec⁻¹). In reporting of G′ and G″, a smoothing function was applied. The UV lamp used was a Thor Labs 365 nm SOLIS High-Power LED connected to a DC2200 LED Driver set to constant current mode. The UV intensity at the rheometer sample area was adjusted to 100 mW-cm⁻² using a radiometer or a total dose of 10 J·cm⁻². The terminal functional groups ratios were correlated to the dynamic material properties before, during, and after absorbed dose of 10 J upon UVA exposure.

### Example 20. Material Properties Investigation of UV-Active Binary Polymer Composites

To investigate the hypothesis that diazirines in a CaproGlu liquid polymer system will react preferentially with X—H functional groups, four multi-arm nucleophilic additives were mixed with CaproGlu, a bioadhesive that relies on carbene insertion as the main covalent crosslinking mechanism, as described in Example 18. The specific additives chosen were poly-triol (PCLT), tetrathiol (PTHT), polyamine dendrimer (PAMAM) and diacrylate monomer (PEGDA575). Photorheometry was carried out by following the protocol in Example 19.

### SEM of Cured Binary Composites

SEM was performed on a FESEM JEOL JSM-6340F. Samples (0.2 mm thick) were cured at 10 J·cm⁻² UV, cooled in liquid nitrogen, then cohesively fractured to produce thin cross sections. These were affixed to a SEM stub with carbon tape and sputter coated with gold on a JFC-1600 Auto Fine Coater at 20 mA, distance=3 cm for 30 seconds.

### Results and Discussion

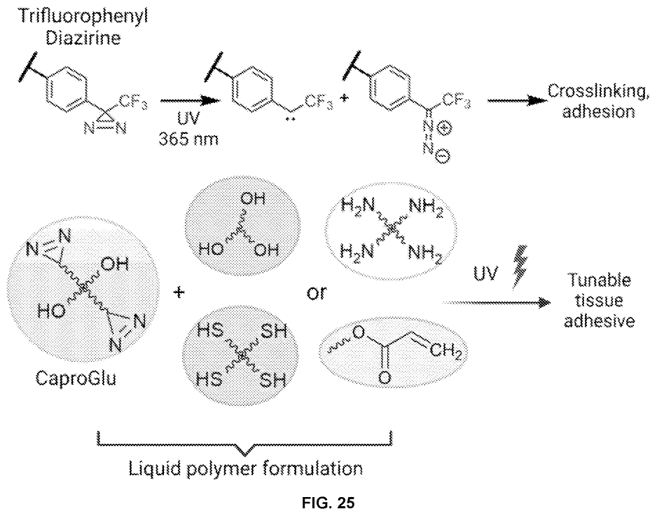

All components are liquid and miscible with CaproGlu (FIG. 25). All additives are more fluid (<6.5 Pa·s) with a lower molecular weight (<1500 g·mol⁻¹). Three or more CaproGlu/additive ratios serve to identify structure property relationships (Table 3). Molar ratios are centred around 1:1 (Table 3).

### Example 21. Dilution with PCLT Maintains Dynamic Mechanical Modulus

To investigate the interaction of diazirine with terminal hydroxyl groups, the first additive selected was PCLT (Mw=300 g·mol¹). PCLT is a liquid oligomer terminated with three hydroxyl groups and miscible with CaproGlu. Hydroxyl groups are expected to react preferentially with carbene compared to C—H bonds (Brunner, J., Senn, H. & Richards, F. M., J. Biol. Chem. 1980, 255, 3313-3318; and West, A. V. et al., J. Am. Chem. Soc. 2021, 143, 6691-6700). PCLT has a higher ratio of —OH groups per molecule than CaproGlu (PCLT: 3 —OH groups per 300 Da, CaproGlu: 2 —OH groups per 1500 Da). The samples were prepared by following the protocol in Example 18 and photorheometry was carried out by following the protocol in Example 19.

### Results and Discussion

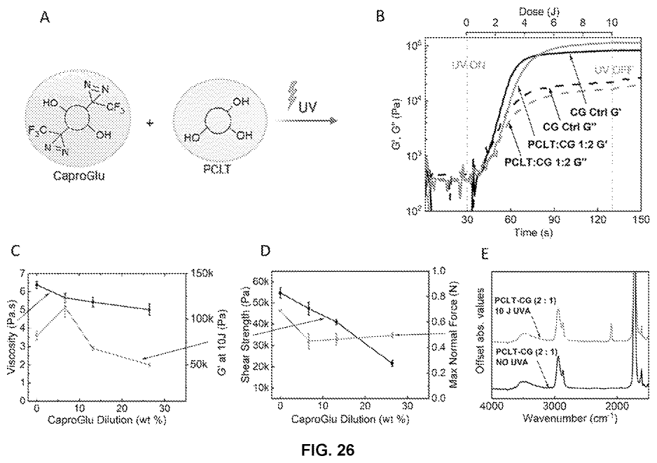

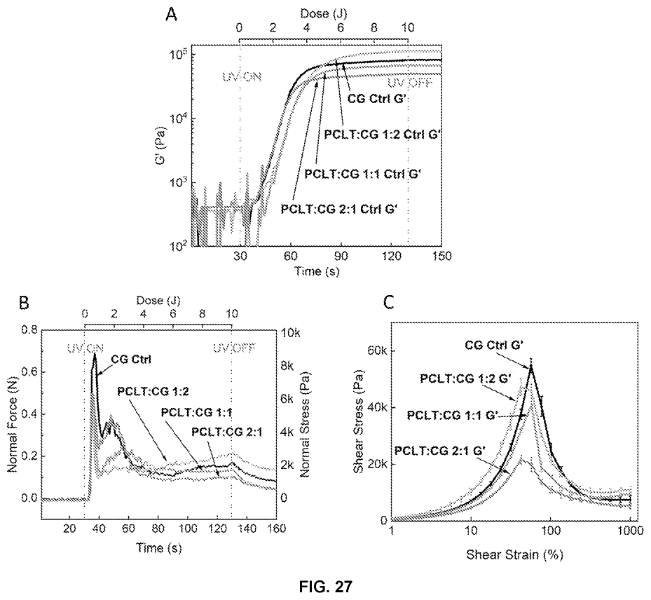

Three samples evaluate 2:1, 1:1 and 2:1 molar ratios of —OH:diazirine, as seen in FIG. 26A and Table 3. Photorheometry data for all formulations are shown in FIG. 27. FIG. 26B shows the storage (G′) and loss moduli (G″) for the sample PCLT/CaproGlu (1:2) before, during and after photocuring compared to undiluted CaproGlu. G′ for PCLT 1:2 increases above that of pure CaproGlu after UV activation (113 kPa at 10 J·cm²) for PCLT vs 82 kPa for CaproGlu (FIGS. 26C and 27). A possible reason for the G′ increase after addition of PCLT could be the result of carbene-insertion preference of O—H>C—H, less flexible oligomer chains, increased transparency, or combination thereof.

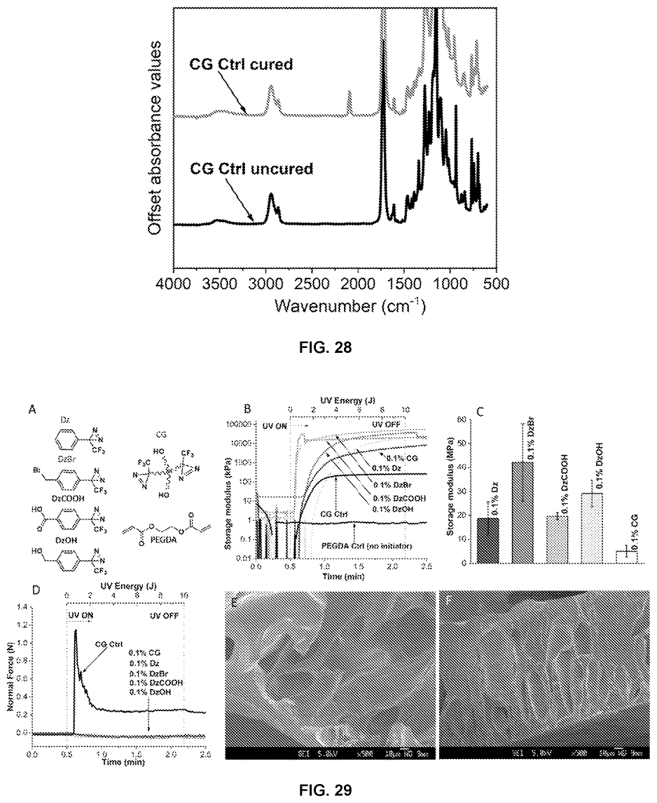

After further dilution of CaproGlu, a decrease in cured G′ was observed; 68 kPa and 50 kPa for 1:1 sample and 2:1, respectively, as seen in FIGS. 26C and 27. Addition of PCLT serves as a plasticizer, decreasing the steady shear (apparent) viscosity compared to neat CaproGlu. This result, together with the concentration reduction of diazirine groups, explains the reduction in G′ for more dilute formulations. The shear strength (determined from an amplitude sweep after curing, FIG. 26D) inversely correlates to dilution ratio, suggesting reduced intermolecular crosslinking. FIG. 26D also shows the maximum normal force observed during photocuring on the rheometer probe. Normal force is generated by bubble nucleation of molecular nitrogen upon diazirine-to-carbene transition, as observed previously (Djordjevic, I. et al., Biomaterials 2020, 260, 120215). Normal force is 0.69 N for pure CaproGlu and decreases upon diazirine dilution. FTIR of PCLT/CaproGlu (2:1, FIG. 26E) displays the appearance of a 2090 cm⁻¹ peak after UV activation. This is indicative of trifluorophenyl diazoalkanes, a known isomer of UVA activated diazirine (Djordjevic, I. et al., Biomaterials 2020, 260, 120215). The CaproGlu control sample, with no PCLT, exhibits a similar diazo peak (FIG. 28).

FIG. 29 depicts the storage modulus of 0.1% Dz, 0.1% Dz-Br, 0.1% Dz-COOH, 0.1% DzOH, 0.1% CG and pure CG.

### Example 22. Tetra-Thiol Additive Yields the Best Synergy of Viscoelastic Material Properties

Thiol-containing amino acids have preferential photolabeling in aqueous medium (West, A. V. et al., J. Am. Chem. Soc. 2021, 143, 6691-6700). PTHT (a tetra-thiol) is a liquid molecule at room temperature (FIG. 25 and Table 3). Tetra-thiol compounds serve as an alternative to traditional plasticisers due to their reduced tendency for migration (Saraswathy, M., Stansbury, J. W. & Nair, D. P., J. Mech. Behav. Biomed. Mater. 2017, 74, 296-303). Thus, it is hypothesised that PTHT will display a synergy with respect to (lower) viscosity and higher crosslinking after UVA exposure compared to hydroxyl end groups. The samples were prepared by following the protocol in Example 18 and photorheometry was carried out by following the protocol in Example 19.

### Results and Discussion

Sample mixing with a co-solvent preparation yielded more transparent formulations, otherwise direct mixtures are opaque.

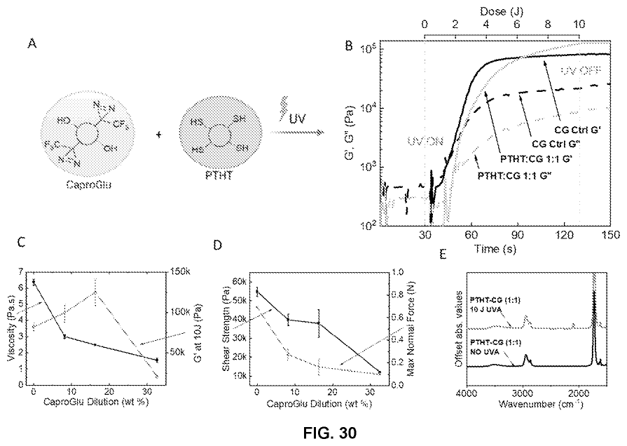

Upon UV activation, the storage modulus of PTHT/CaproGlu mixture exceeds that of CaproGlu (G′=82 kPa vs CG:PTHT 1:1 G′=125 kPa at 10 J·cm⁻²) for the first two PTHT containing formulations, as shown in FIGS. 30 and 31. This increase in G′ values supports the hypothesis of preferential crosslinking of carbenes with thiol groups (West, A. V. et al., J. Am. Chem. Soc. 2021, 143, 6691-6700). For the third formulation (34.2% PTHT/CaproGlu 2:1 molar ratio), a decrease in storage modulus was observed (21 kPa at 10 J·cm⁻², FIG. 30C). This formulation contains a twofold excess of thiols compared to diazirines; the excess of PTHT molecules is therefore likely to cause plasticizing effect to the polymer composite. However, gelation is maintained in all ratios. It was found that even 7% PTHT/CaproGlu 1:2 reduced the steady shear viscosity significantly (FIG. 30C). Amplitude sweeps determine the maximum shear strength (yield stress) with PTHT formulations reduced to 40 kPa in PTHT 1:2 (FIG. 30D) where unreacted PTHT acts as a plasticizer. FTIR (FIG. 30E) spectra show a decrease in the observed diazo peak in comparison to PCLT/CaproGlu binary composite (Table 4). This result suggests that thiols may be more reactive with diazoalkane than hydroxyl, preventing diazoalkane formation during UV exposure, or combination thereof.

TABLE 4
FTIR analysis of diazoalkane peaks compared to CH₂ peaks.

| | Diazo peak ratio/molar ratio in |
|---|---|
| Sample | comparison to Caproglu (%)* |
| CG | 100 |
| PTHT 2:1 | 99 |
| PCLT 2:1 | 115 |
| PAMAM 1:1 | 119 |
| PEG-DA575 1:1 | 143 |

${}^{*} ( \frac{\frac{Diazo Peak Sample}{{CH}_{2} Peak Sample}}{\frac{Diazo Peak C G}{{CH}_{2} Peak C G}} / \frac{\frac{Moles Diazo Sample}{Moles {CH}_{2} Sample}}{\frac{Moles Diazo C G}{Moles {CH}_{2} C G}} ) * 100$

### Example 23. Addition of Polyamidoamine to CaproGlu-Based Binary Composite Decreases Dynamic Modulus and Enhances Ester Hydrolysis

Amino acids with amine side groups (K, H, R, P) are among the least reactive for carbene insertion in aqueous environments (West, A. V. et al., J. Am. Chem. Soc. 2021, 143, 6691-6700). Therefore, it is hypothesised that incorporation of amine additives will have negligible improvements in storage modulus, but will accelerate the matrix depolymerization via two mechanisms—polyester hydrolysis and aminolysis. Therefore, amine additives could be exploited for accelerating matric resorption (Popoola, V. A., J. Appl. Polym. Sci. 1988, 36, 1677-1683; Toledo, A. L. M. M. et al., Int. J. Polym. Mater. Polym. Biomater. 2021, 70, 1258-1270)

The samples were prepared by following the protocol in Example 18 and photorheometry was carried out by following the protocol in Example 19.

### CaproGlu/PAMAM Composites Ester Degradation Analysis

PAMAM/CaproGlu samples (30 mg) were prepared on the same day and were added to the bottom of 4 mL glass vials, spreaded evenly over the base of the vial, and cured with a 365 nm UV torch for 2 minutes (10 J exposure). D₂O (1 mL) containing 0.1% TMSP was added to each vial for 24 hours at room temperature. 0.6 mL of supernatant was removed for ¹H NMR and returned to the vial after measurement. After 1 week, solid samples were weighed before and after freeze drying. Thickness was measured with a micrometer (1 μm resolution). D₂O pH was measured with a pH indicator paper (pH 0-14 MColorpHast) at 0, 1, and 7 days. ¹H NMR was also measured after one week, both on the raw supernatant and the supernatant following addition of NaOD (8 μL).

### Results and Discussion

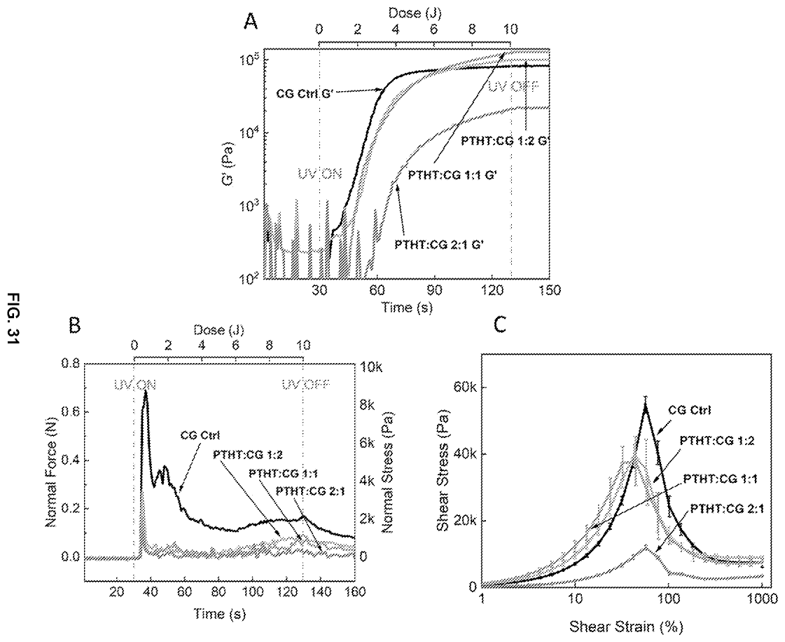

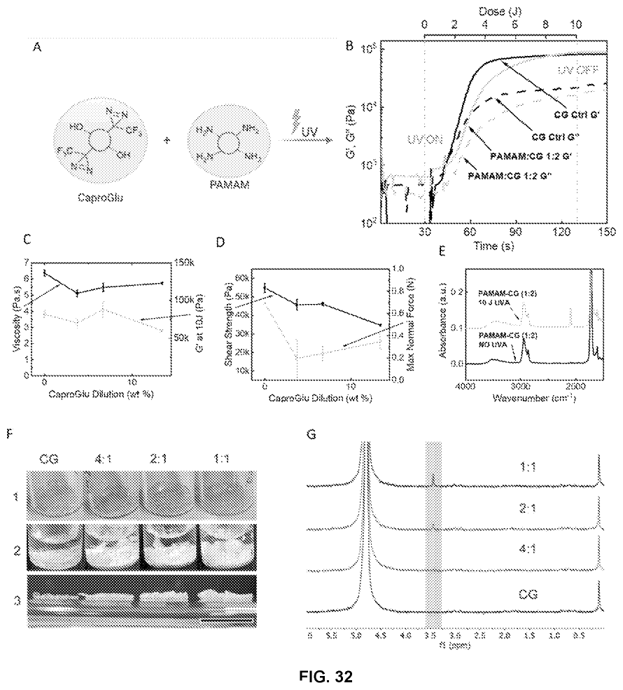

PAMAM serves as a miscible amine additive that is readily incorporated into CaproGlu (FIG. 32A). The three ratios were determined by the amount of primary amine relative to diazirine (Table 3). The final G′ value is not significantly different for dilutions up to 13% (FIG. 32B) while dynamic viscosity is reduced to 5.1 Pa·s for 1:4 PAMAM/CaproGlu ratio (FIG. 32C). Normal Force is also reduced to 0.37 N in PAMAM/CaproGlu (1:4, FIG. 32D), compared to pure CaproGlu (control). The maximum shear stress (FIG. 32D) is reduced to 35 kPa in the PAMAM/CaproGlu 1:1 binary composite. These results infer that addition of PAMAM did not improve crosslinking or that N—H insertion is less efficient than O—H/S—H. FTIR (FIG. 32E) spectra show the formation of diazoalkane that is consistent with PCLT additive formulation (FIG. 26E).

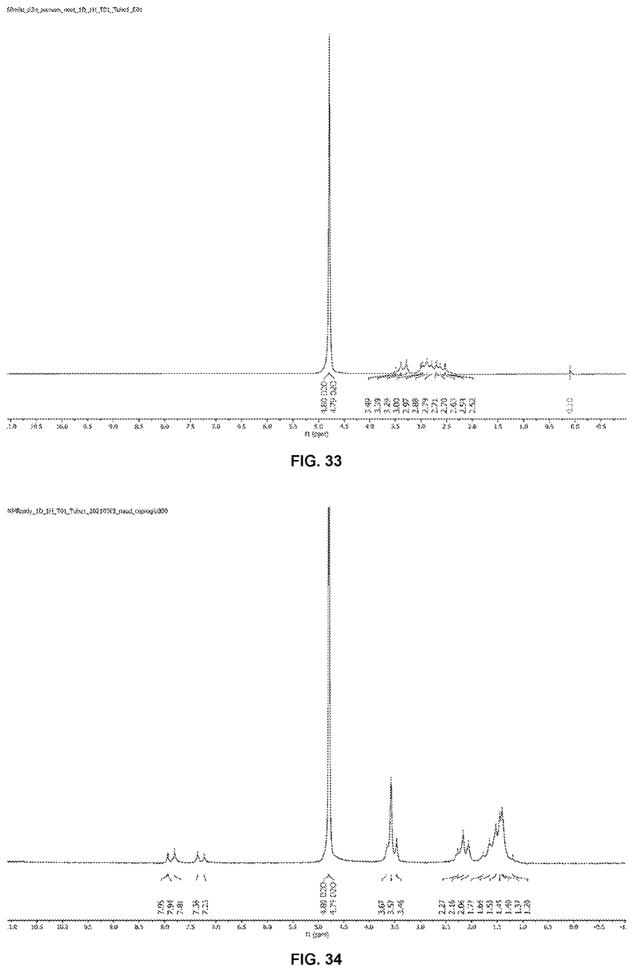

Degradation of PAMAM/CaproGlu binary composite samples in aqueous environment within 24 hours was qualitatively evaluated with ¹H NMR (FIGS. 32F-G, Table 5). Each formulation was cured (FIG. 32F, top) and incubated in unbuffered D₂O (FIG. 32F, middle) prior to leachate analysis. After 24 hours, differences are visible between the pure CaproGlu control and the PAMAM samples. The D₂O in the CaproGlu control sample appeared clear, whereas for all PAMAM samples, there was a soapy residue present in solution and on the sides of the glass (FIG. 32F, middle). A colour change was also apparent. The CaproGlu sample retained its yellow colour, whereas the PAMAM/CaproGlu binary composite samples became white where they are in contact with D₂O. The solution was removed from each sample and analysed by NMR (FIG. 32G). For the PAMAM/CaproGlu samples, a peak is observed at 3.44 ppm, which increased in concentration in accordance with the increasing concentration of PAMAM. NMR of pure PAMAM did not exhibit a similar peak (FIG. 33). CaproGlu degraded in 1 M NaOH exhibits a similar peak at 3.6 ppm along with various other degradation peaks (FIG. 34). The peak at 3.4 ppm is therefore attributed to an unknown water-soluble degradation product of CaproGlu and PAMAM. The increase in this peak indicates that CaproGlu degraded more quickly when PAMAM is incorporated (Table 5). After 1 week, the samples were removed from the solution, weighed, and their thickness was measured (FIG. 32F, bottom). The PAMAM samples retained much more water than pure CaproGlu due to their swelling as a result of the hydrophilic nature of PAMAM dendrimer and greater mass change following freeze drying (0.3% for CaproGlu vs. 47% for PAMAM/CaproGlu 1:1 in Table 5). A residue was observed on the glass side walls (FIG. 32F) and the appearance of degradation peaks was observed in SH NMR (FIG. 32G). PAMAM containing samples appear more hydrophilic, as indicated by the water retention after freeze drying. Residue is speculated to be electrostatic precipitates (—COO⁻/NH₃⁺) typical of ionic surfactants. Therefore, our results indicate the incorporation of PAMAM into CaproGlu can speed up degradation and increase hydrophilicity.

TABLE 5
pH, width, NMR integrals, and mass change
of PAMAM/CG degradation samples.

| | pH at | Width | NMR Integral | Mass change |
|---|---|---|---|---|
| Sample | 1 week* | (mm)^{‡} | value^{§} | (%)^{¶} |
| Ctrl CG | 5 | 0.3 | 0.2 | 0.3 |
| PAMAM:CG | 7 | 0.63 | 0.24 | 3 |
| 1:4 | | | | |
| PAMAM:CG | 7 | 0.93 | 0.27 | 25 |
| 1:2 | | | | |
| PAMAM:CG | 7 | 0.95 | 0.43 | 47 |
| 1:1 | | | | |

*pH of D₂O solution measured with pH indicator paper.
^{‡}Width of sample following removal from D₂O.
^{§}Integral of peak at 3.44 ppm.
^{¶}Change in mass following freeze drying of removed sample.

### Example 24. Photoactivated Diazirine Radicals Initiate Acrylates and Prevents Shrinking

PEGDA has been used in a range of biomedical applications from tissue engineering to drug delivery. PEGDA is generally used in the form of a photo-crosslinkable hydrogel. Acrylates are often used in tissue adhesives due to their rapid polymerisation but usually require addition of toxic photoinitiators. The initial viscosity, gelation time, and shear strength evaluate for synergistic properties with respect to additive-free CaproGlu. The samples were prepared by following the protocol in Example 18 and photorheometry was carried out by following the protocol in Example 19.

### Results and Discussion

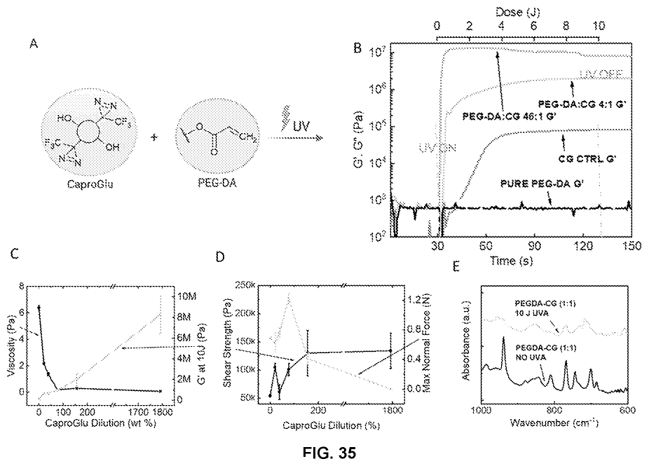

For the first time diacrylate polymerization is demonstrated by photoactivated diazirine, the carbene precursor. Two formulations were initially prepared with PEGDA575/CaproGlu mass ratios of 1:1 and 2:1 and their UV curing properties were studied using photorheometry (FIGS. 35A and 36). It was found that the formulations containing PEGDA575 reach a 10× higher storage modulus value at 10 J·cm² (655 kPa and 977 kPa for PEGDA575/CaproGlu 1:1 and 2:1, respectively) than neat CaproGlu (82 kPa) and cured more rapidly (60 kPa reached after 43 seconds for CaproGlu, 24 seconds for 1:1 PEGDA575/CaproGlu and 13 seconds for 2:1, FIG. 35B). Therefore, the diacrylate additive displays synergistic enhancement of dynamic modulus within the binary composite, reaching 977 kPa compared to 82 kPa of neat carbene based bioadhesive. For further investigation of this unexpected increase in crosslinking (compared to other reported binary adhesive composites, Table 3, FIGS. 26, 30 and 32), more formulations were prepared with ratios of PEGDA575/CaproGlu 1:2, 4:1 and 46:1. Pure PEGDA575 (FIG. 35B) showed no curing upon exposure to the UV light, thus supporting CaproGlu as the photoinitiator. The polymerisation of acrylates initiated by diazirine photolysis opens new possibilities for acrylate initiation and hybrid composite biomaterials.

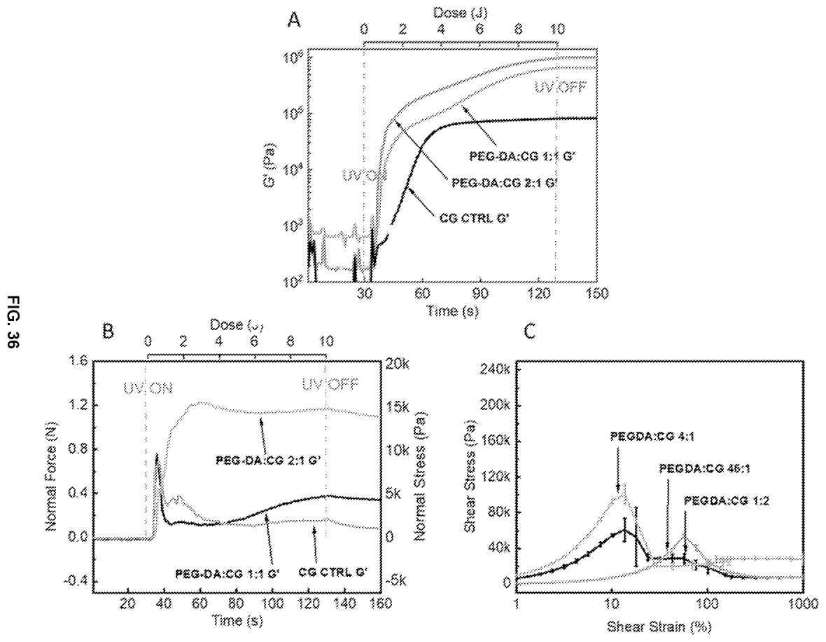

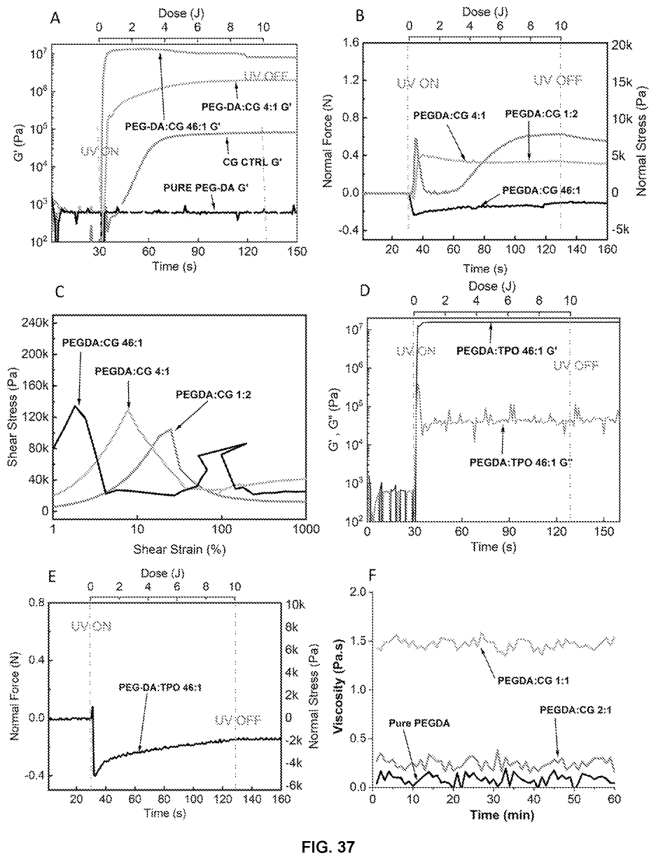

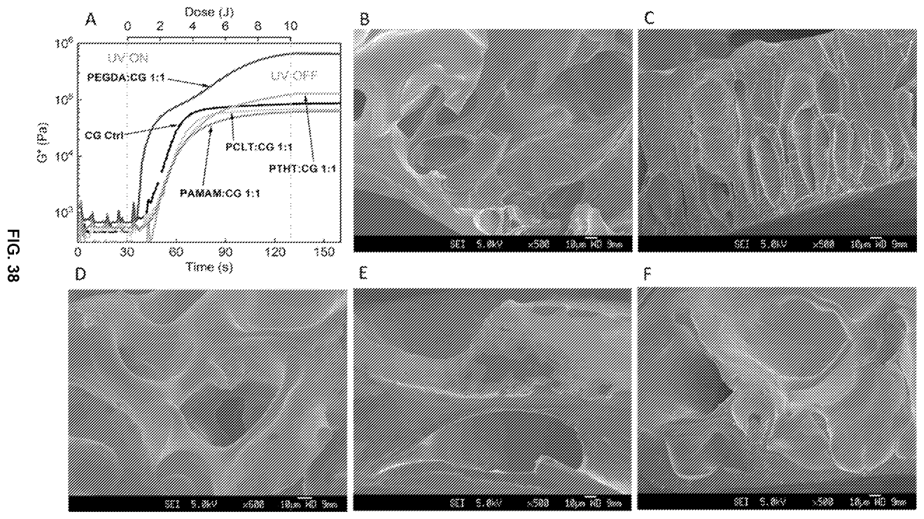

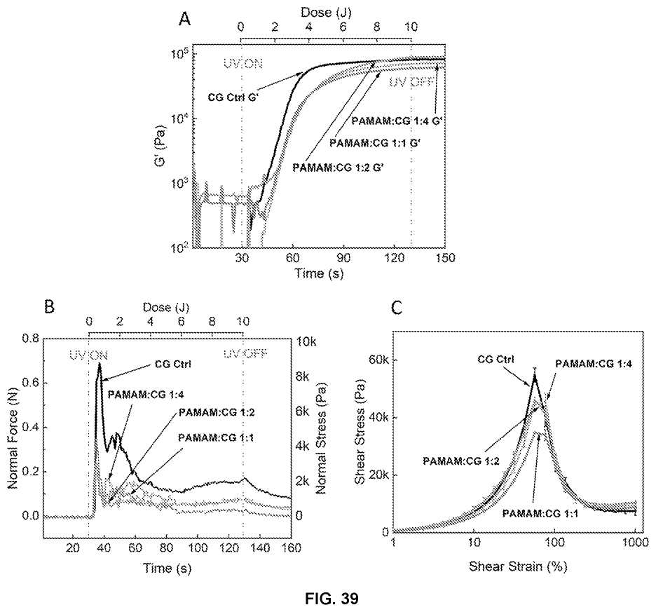

All PEGDA575 binary composites resulted in a significant increase in G′ after UV activation, with the 46:1 PEGDA575/CaproGlu sample reaching 8 MPa which is an order of magnitude higher than G′ of crosslinked pure CaproGlu (FIGS. 35A, C). Unlike the other binary composite formulations in this study, increasing the amount of additive beyond a 1:1 functional group ratio results in synergistic rise of G′. Maximum Normal Force was found to increase to a value of 2.1 N for PEGDA575/CaproGlu 2:1 ratio (76% dilution), followed by decrease for higher concentrations of PEGDA575 (FIG. 35D). The Normal Force was found to attain negative values for the 46:1 PEGDA575/CaproGlu sample (FIG. 37B). This is consistent with shrinkage during polymerisation of acrylates (Schmidt, C. & Scherzer, T., J. Polym. Sci. B: Polym. Phys. 2015, 53, 729-739). A further control compares TPO initiator as a similar ratio of 46:1 (FIG. 37D). The G′ values are similar to CaproGlu initiator, but shrinkage (assessed by normal stress) almost doubles. FTIR (FIG. 35E) confirms the acrylate peak reduction at 810 cm⁻¹ (characteristic of C═C out of plane stretch, Rydholm, A. E., Bowman, C. N. & Anseth, K. S., Biomaterials 2005, 26, 4495-4506). Photorheometry and FTIR indicate chain growth acrylate initiation by light activated CaproGlu. Diazirinyl radical, triplet carbene, or other diazirine to carbene intermediates are the speculated radical initiators.

FIGS. 35-37A-E display an example of CaproGlu initiating PEGDA575 resin with UVA light under multiple ratios (see Table 3) to tune steady state viscosity, shear storage modulus, shear strength, and volumetric shrinkage. FTIR spectra of PEG-DA575:CG 1:1 before and after UV exposure indicates depletion of acrylate groups; dashed line indicates 810 cm⁻¹, known for C═C out of plane stretch.

The triol hydroxy additive maintains the storage modulus despite dilution of the diazirine crosslinker. The thiol additive reduces apparent viscosity whilst maintaining material properties. Polyamine accelerates ester hydrolysis and increases hydrophilicity.

### Example 25. Direct Comparison Indicates Higher Dynamic Moduli and Altered Microstructure Measured for PEGDA575/CaproGlu Binary Composite

The samples were prepared by following the protocol in Example 18 and SEM was carried out by following the protocol in Example 20.

### Covalent Crosslinking

Covalent crosslinking was monitored via complex shear modulus (G*), which was measured on a custom photorheometer fitted with a narrow-band 365 nm UV diode and normal-force load cell. This allows real-time measurements in both shear and normal modes. Dynamic viscosity, G′ (storage modulus), G″ (loss modulus), and normal force (caused by expansion/contraction of polymer matrix) were continually monitored and subsequently analysed for yield stress/strain with an amplitude sweep. Functional groups were qualitatively assessed before and after curing via ATR-FTIR spectroscopy to observe consumption. SEM morphology analysis was employed to observe the porous microstructure caused by nitrogen; a by-product of UV activated diazirine. Ester hydrolysis was carried out in the case of amine additives, as described in Example 23.

### Results and Discussion

FIG. 38 shows a comparison of dynamic moduli values and microstructures of for all additives tested herein at a 1:1 CaproGlu/additive molar ratio. FIG. 38A shows the complex modulus (G*), which is the overall resistance to shear deformation, with higher values indicating a more solid-like sample (G*=G′+iG″). The results demonstrate that for a 1:1 ratio, PEGDA575 produces a higher cured G* (660 kPa) than the other additives (<130 kPa). PTHT incorporation also results in a G* higher than that of pure CaproGlu (127 kPa vs 84 kPa), whereas PCLT and PAMAM additives result in a lower G*. It is noted that each additive has a different morphology (degree of branching, molecular weight), so direct conclusions cannot be drawn about degree of crosslinking. However, in the case of PEGDA575, the difference in G′ is more pronounced. SEM cross-section micrographs of all investigated binary composites (FIGS. 38B-F) reveal pronounced morphological differences between the PEGDA575/CaproGlu sample (FIG. 38C), which has little to no pores observed. Brittle fracture surfaces were noted, which may be attributed to the stiffer polyacrylate matrix. Overall, this suggests that the free radical polymerization outruns carbene covalent insertion.

If carbenes formed by diazirines are indeed somehow initiating or catalysing polymerization of the PEGDA575, then diazirines could be a new type of photoinitiator for polymerization of acrylates. This would be advantageous due to their relatively non-toxic nature and the formation of nitrogen gas during initiation, which could offset the volume reduction usually exhibited by acrylates during curing (Schmidt, C. & Scherzer, T., J. Polym. Sci. B: Polym. Phys. 2015, 53, 729-739; Jian, Y. et al., J. Coat. Technol. Res. 2013, 10, 231-237; and Marx, P. & Wiesbrock, F., Polymers 2021, 13, 806). Future work may focus on variants of TPDs to expand these findings.

Studies have shown that TPDs insert into all standard amino acids, but display a higher insertion percentage in thiol containing amino acids (West, A. V. et al., J. Am. Chem. Soc. 2021, 143, 6691-6700). This is in agreement with observations herein, with PTHT additives displaying the highest storage modulus in comparison to polyol and polyamine additives. For the set of samples containing PAMAM (amine functional groups), the material properties did not follow the same trends as for PCLT and PTHT samples (alcohol and thiol functional groups). No increase in cured G′ was observed when the samples are incorporated.

Taken together, diazirine-grafted polycaprolactone tissue adhesive was combined with a range of transparent, liquid polymer additives to investigate synergistic bioadhesive material properties. These additives are branched polyalcohol, polythiol, polyamine and linear PEGDA575. Overall, the results indicate that the carbene crosslinking chemistry used in CaproGlu adhesives is robust in the presence of common functional groups, such as primary alcohol, thiol, and primary amine. Dilution of photoactive diazirines with hydroxyl groups of polyalcohol additive allows the binary composite formulation to maintain the original dynamic mechanical modulus (measured for pure diazirine-grafted polycaprolactone) for dilutions up to 7%, whereas dilution with polythiol increases the dynamic modulus for dilutions up to 15%. For each of the additives featuring the other functional groups, the storage modulus after curing was maintained up to a 1:1 functional group ratio. This corresponds to a dilution of CaproGlu of 13-15%. An increase in storage modulus for the thiol-containing PTHT samples and acrylate-containing PEGDA575 samples, indicates a higher degree of crosslinking.

Photorheometry and FTIR spectroscopy results indicate photoinduced diazirine-to-carbene insertion into both hydroxyl and thiol end-groups. The binary composite, produced by mixing diazirine-grafted polyester with polyamine, results in increased hydrophilicity and accelerated ester hydrolysis. The polyacrylate additive bestows increased dynamic modulus, which is attributed to diazirine-initiated acrylate oligomerisation/polymerisation. Taken together, the reported results demonstrate the robustness of diazirine-grafted macromolecules and biomaterials that can photochemically activated in a variety of reactive functional groups without impediments on carbene covalent insertion. For the first time, we report the initiation of free-radical polymerization of diacrylate molecule by CaproGlu, which is speculated to be dependent on diazirine photolysis. Future work may focus on the mechanism (e.g. free-radical vs. anionic) and which diazirine designs are the most efficient for chain-growth polymerization.

### Example 26. Photorheometry Studies of PEGDA575 with PBS (at 20%, 50%, 80% Wt/Wt) and DzOH, DzCOOH and TPO

It was previously found that diazirines enable the curing of PEGDA even in the presence of PBS. This was unexpected as the free radical molecules formed were expected to be quenched by the water molecules. Hence, to obtain more data, photorheology experiments were conducted for PEGDA575 in PBS at concentrations of 20%, 50% and 80% (wt/wt) with 1% (mol/mol) DzOH, DzCOOH and TPO.

TABLE 6
Names and descriptions of diazirine types and monomers used.

| | | |
|---|---|---|
| | Molecular Weight | |
| Name | (g/mol) | Structure |

Diazirines

| | | |
|---|---|---|
| DzOH | 216.16 | 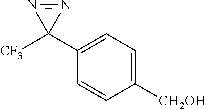 [SMILES: OCc1ccc(C2(C(F)(F)F)N=N2)cc1] |
| DzCOOH | 230.15 | 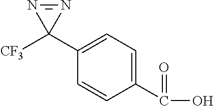 [SMILES: O=C(O)c1ccc(C2(C(F)(F)F)N=N2)cc1] |

Monomers

| | | |
|---|---|---|
| Poly(ethylene glycol) diacrylate [PEGDA575] | 575 | 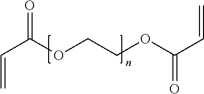 |
| Poly(ethyleneglycol) diacrylate [PEGDA700] | 700 | 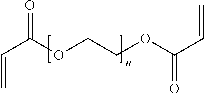 |

Commercial Photo-initiators

| | | |
|---|---|---|
| Diphenyl(2,4,6- trimethylbenzoyl)phosphine oxide [TPO] | 348.37 | 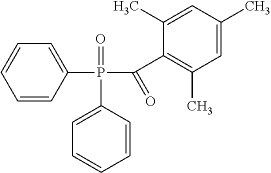 [SMILES: Cc1cc(C)c(C(=O)P(=O)(c2ccccc2)c2ccccc2)c(C)c1] |

### Preparation of Stock Solutions

Stock ‘PEGDA575+1% photo-initiator’ solutions were first prepared by adding 1% (mol/mol) of the photo-initiator to 5 g of PEGDA575. This was done for diazirines (DzOH, DzCOOH and commercial photo-initiator TPO). The amount of photo-initiators added are as depicted in Table 7.

TABLE 7
Amounts of diazirines and TPO needed to prepare
‘stock’ solution for 5 g of PEGDA575.

| | | | Amount of | Amount of | Amount of |
|---|---|---|---|---|---|
| Amount of | No. of mol | No. of mol of | DzOH | TPO | DzCOOH |
| PEGDA575 | of | photoinitiator | needed | needed | needed |
| (g) | PEGDA575 | (1%) | (mg) | (mg) | (mg) |
| 5 | 0.0087 | 0.000087 | 18.80 | 30.29 | 20.01 |

PBS was prepared previously by dissolving 1 PBS tablet in 200 mL of deionised (DI) water. The three ‘PEGDA575 with 1% photo-initiator’+PBS solutions were each prepared at 3 different concentrations: 20% PEGDA575 in PBS; 50% PEGDA575 in PBS; and 80% PEGDA575 in PBS.

### Photorheology Experiments

Photorheology experiments were conducted using the Anton Parr MCR 102 modular rheometer with the following parameters and 18 μl of the solution was used for each run. A PP10 parallel plate stainless steel probe was used and measured at a 0.2 mm gap. The Steady-State Viscosity was first measured against a shear rate of 10 s⁻¹. This was followed by Dynamic Oscillatory Strain measurement with 1% shear, 10 Hz frequency, and 1% amplitude. During the measurement, the formulation was cured by a 365 nm UVA light for 100 seconds (LIGHT ON at 30 seconds, OFF at 130 seconds) for a total dose of 10 J (100 mW/cm²). The UV lamp used was a Thor Labs 365 nm SOLIS High-Power LED connected to a DC2200 LED Driver set to constant current mode. The LED current was set to 1490 mA with a limit of 4500 mA.

### Results and Discussion

Prior to using 20% PEGDA575 in PBS, 10% PEGDA575 was tested with TPO and DzOH, however, as there was no curing activity observed on the rheometer for 10% PEGDA575 in PBS+DzOH, the concentration used to obtain data was changed to 20% PEGDA575, 50% PEGDA575 and 80% PEGDA575.

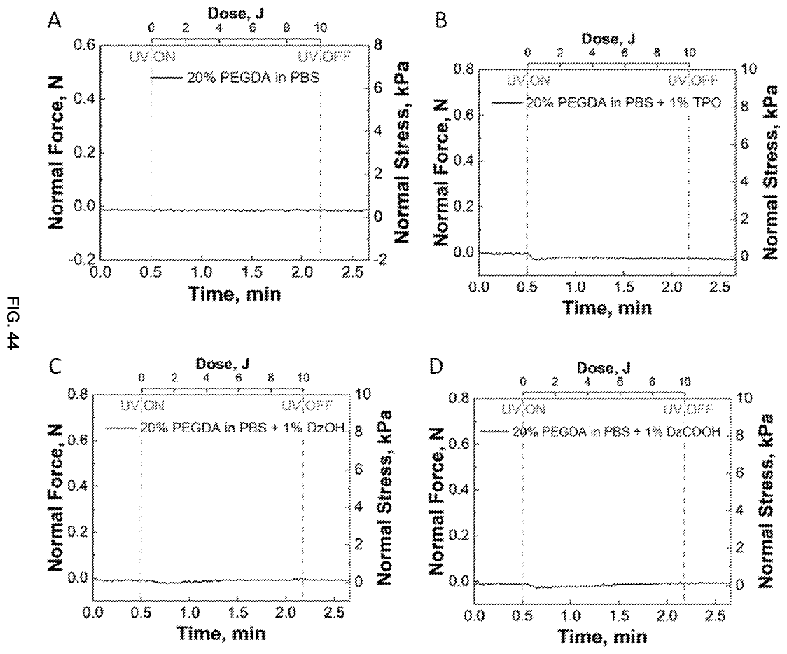

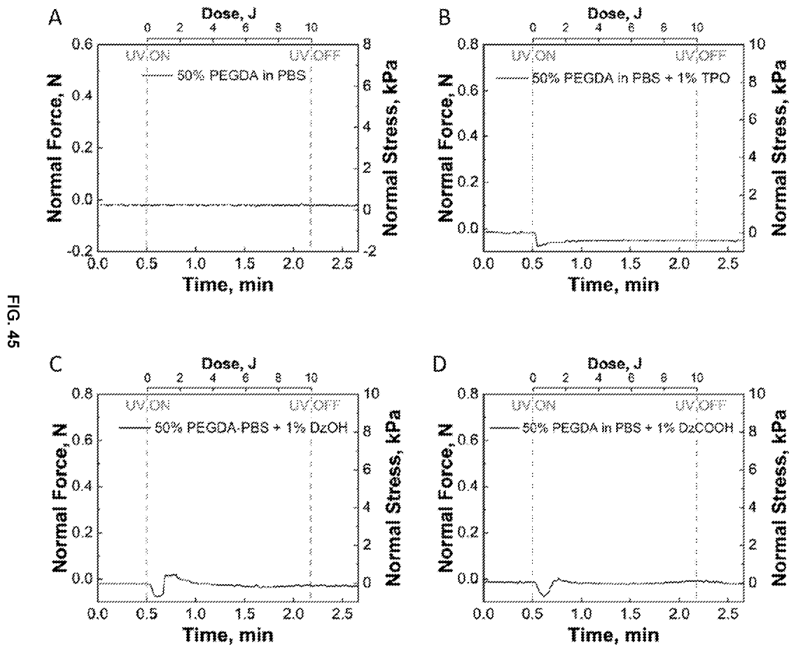

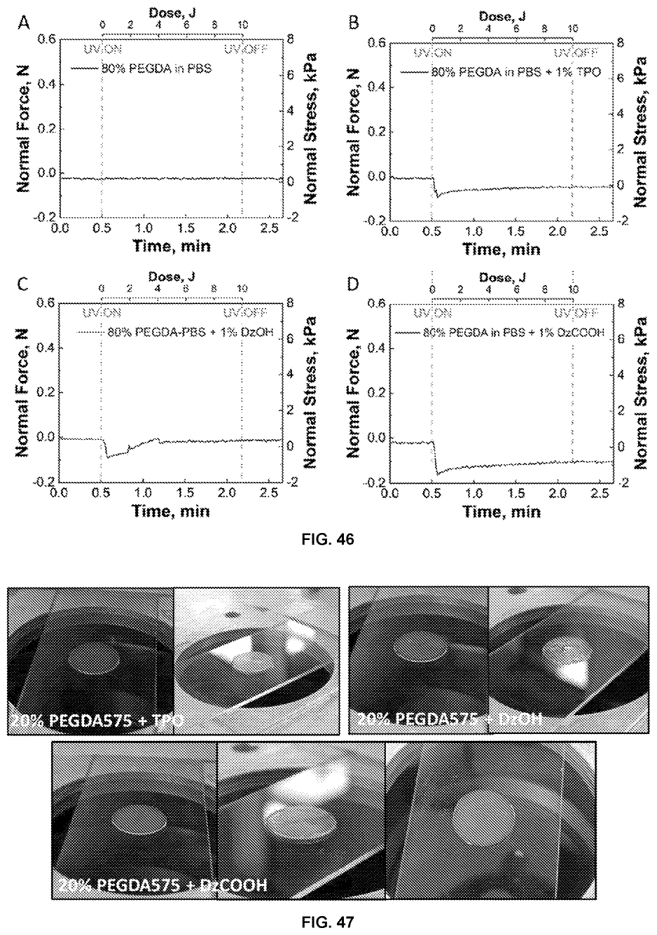

As seen in FIGS. 40-46 and the storage modulus graphs, all the formulations could form a solid thin film at the three concentrations of PEGDA575 in PBS, including at 20%. Overall, the storage modulus was highest at 80%, followed by 50% and 20% at 10⁷ Pa, 10⁵-10⁶ Pa and 10⁴-10⁵ Pa, respectively, which was expected. Generally, the lower the concentration of PEGDA575, the wetter the surface of the film after photopolymerisation. This corresponds to the lower G′ values which in turn generally indicate the less-solid property of the polymer.

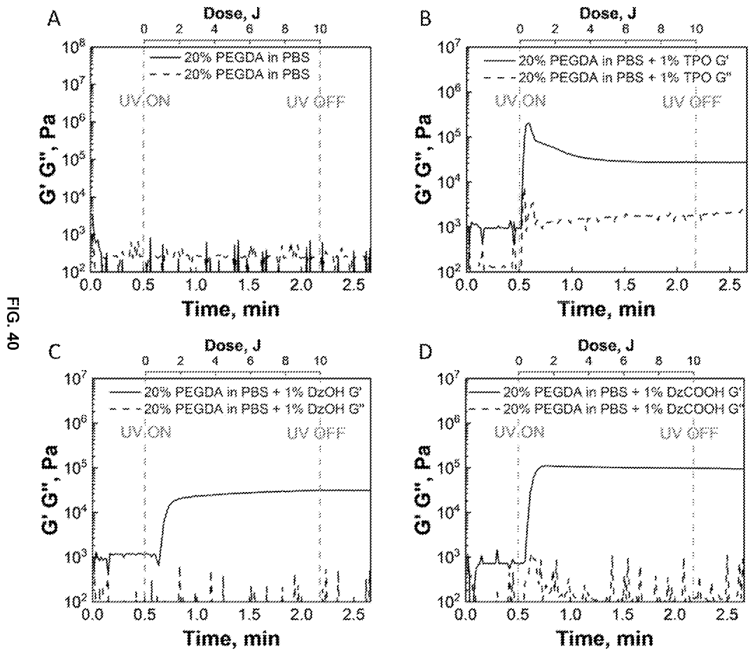

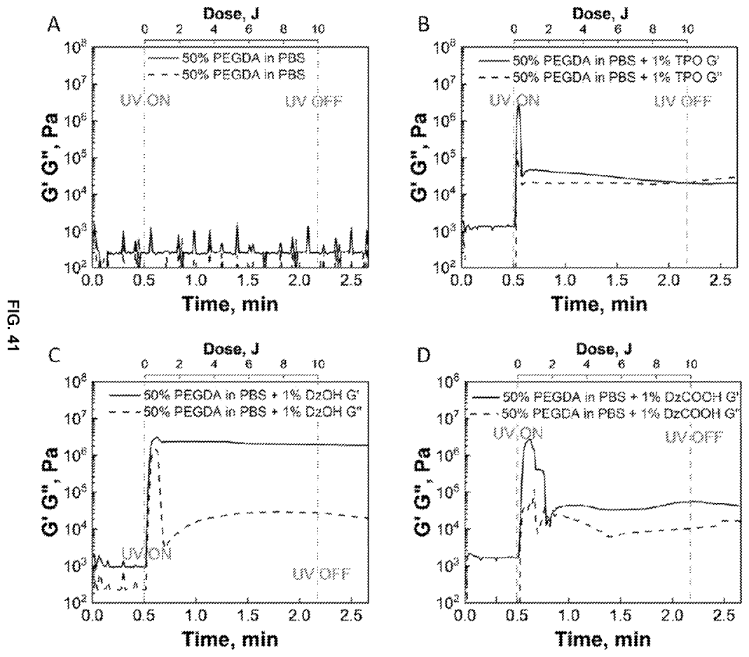

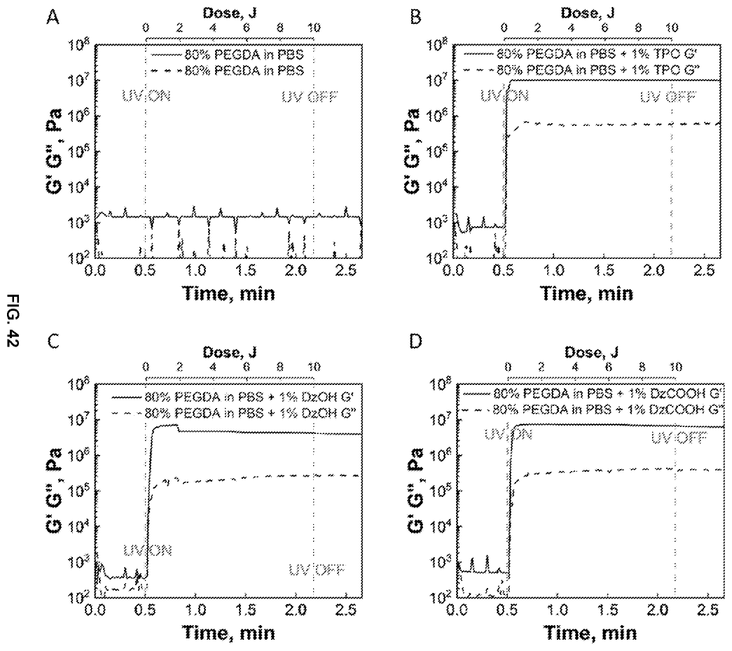

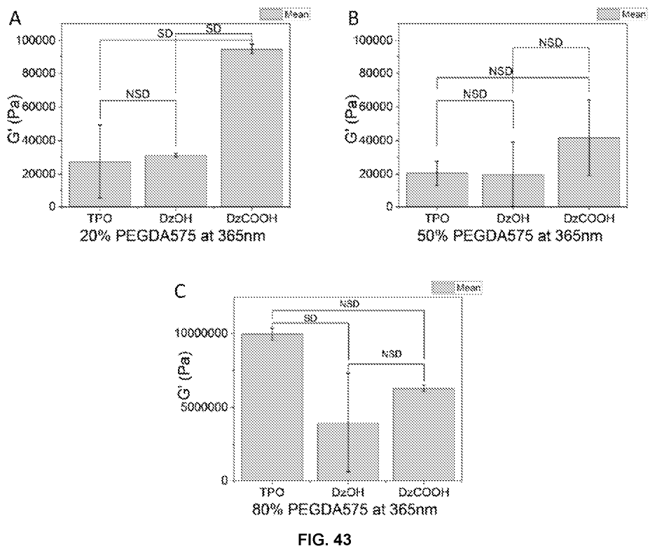

Comparing across the 20% PEGDA575 in PBS samples, it was observed that the DzCOOH sample had the highest G′ value which was stable at 10⁵ Pa, even greater than that obtained by the TPO sample, which peaked at 10⁵ Pa before decreasing to 10⁴ Pa. With reference to the ANOVA analysis in FIG. 43, there is no statistical difference measured between TPO and DzOH samples. However, the DzCOOH sample statistically performed better than the TPO sample.

Additionally, an interesting observation was that the films formed looked cloudy. In particular, the DzCOOH film was observed to have white specks, which may possibly be bubbles or holes in all 3 of its runs at 20% PEGDA575 as seen in FIG. 47.

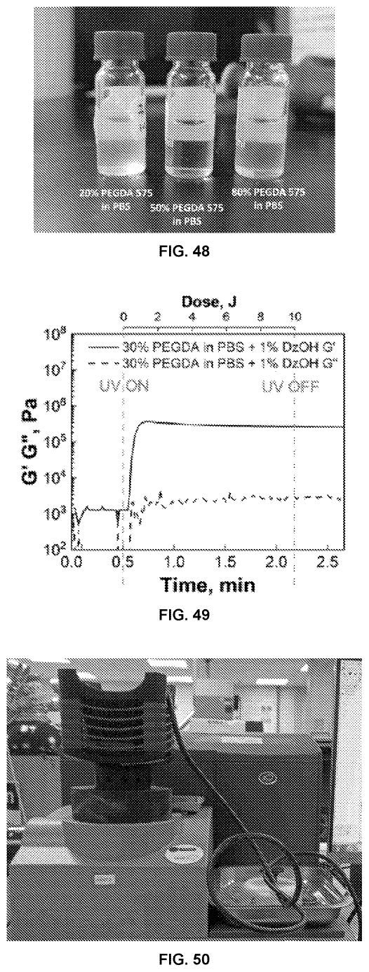

Comparing across the 50% PEGDA575 samples, the G′ readings were not as typically observed. Both the TPO and DzCOOH samples exhibited a sharp peak upon irradiation, before decreasing to 10⁴ Pa. This indicates that the sample may have polymerized quickly, but the internal structure may have fractured, resulting in the drop in G′. On the other hand, the G′ values for the DzOH sample were relatively stable across 10⁶ Pa. However, as observed in FIG. 43, there was no statistical difference across all three photo-initiators at 50% PEGDA575. Additionally, it was also observed that the 50% solutions seemed less cloudy than the 20% and 80% solutions when the PEGDA575 and PBS solutions were first mixed, as shown in FIG. 48.

Comparing across the 80% PEGDA575 solutions, the results are more similar to that of 100% PEGDA575 samples, as there was no sharp peak and decrease in the G′ values. However, it was noted that at 80%, the results obtained by the DzCOOH were comparable to that of TPO, as seen in FIG. 43, while DzOH is statistically different, with slightly lower G′ values.

One possible reason for this phenomenon could be due to phase-separation or solvent-monomer interactions caused by the different concentrations. PEGDA575 is known to be moderately water soluble due to its hydrophilic PEG chains (Zhao, T. et al., RSC Advances 2015, 5, 33823-33830). Hence, the cloudiness could be due to insufficient solvent resulting in phase separation (as in 80% PEGDA575), or hypothesised to have too much solvent-monomer interactions which may result in agglomeration of the chains (such as in 20% PEGDA575). More tests may be done to understand the phenomenon and its effect better.

### Example 27. Photorheometry Studies of PEGDA575 with PBS (at 30% wt/wt) and DzOH

The stock solution of PEGDA575 with PBS (at 30% wt/wt) and DzOH was prepared by following the protocol in Example 26. Photorheology experiments were performed by following the protocol in Example 26.

### Results and Discussion

FIG. 49 depicts the experimental results.

### Example 28. PhotoDSC Studies of PEGDA575 with TPO, DzOH and DzCOOH (at 100% and 20% wt/wt in PBS)

Photo-DSC experiments were conducted to compare between the efficiency of the diazirines at 100% and 20% PEGDA575 in PBS (wt/wt).

The following samples (prepared by following the protocol in Example 26) were tested on the DSC:
PEGDA575+1% TPO;
PEGDA575+1% DzOH;
PEGDA575+1% DzCOOH;
20% PEGDA575 in PBS+1% TPO;
20% PEGDA575 in PBS+1% DzOH; and
20% PEGDA575 in PBS+1% DzCOOH.

### Photo-DSC Studies

Approximately 5 mg of each sample was weighed and placed into the sample crucible. The crucible was not crimped. Air was used as the reference. The experiment was conducted by modifying the cover of the DSC to fit the UV lamp as shown in FIG. 50. The UV lamp used was a Thor Labs 365 nm SOLIS High-Power LED connected to a DC2200 LED Driver set to constant current mode. The LED current was set to 23 mA with a limit of 4500 mA. The temperature was first equilibrated at 25° C., and the test was run at isotherm at 25° C. for 4.5 minutes. The sample was irradiated with 2 J during the isotherm run, by turning the UV lamp on for 100 s two times (LIGHT ON at 30 s, OFF at 130 s, ON at 160 s, OFF at 260 s). The exotherm reactions were recorded as upward peaks.

### Results and Discussion

Previously, it was hypothesised that the presence of water molecules would quench the free carbene radicals formed, preventing photo polymerisation from occurring. However, as solid films were able to form even at 20% PEGDA575 in PBS concentrations, it might suggest that the diazirines may utilise another mechanism to initiate the polymerisation. Hence, this experiment was conducted to further study and understand the effect of hydrophilic environments on the efficiency of the diazirines by comparing the heat flow at different concentrations of PEGDA575 in PBS.

As seen in FIG. 51, there is a significant drop in heat flow at 20% PEGDA575 in PBS as compared to 100% PEGDA575 in PBS for TPO, DzOH and DzCOOH. At 100% PEGDA575, TPO resulted in the most heatflow at 130 mW, followed by DzCOOH with heatflow close to 75 mW and DzOH with heatflow close to 45 mW. Overall, TPO was still the most efficient at 20% PEGDA575, with heat flow of around 18 mW at 20%, compared to the significantly smaller peaks given by DzOH and DzCOOH.

Additionally, at 20% PEGDA575, a second exothermic peak was observed during the second UV irradiation cycle for both DzOH and DzCOOH, which suggests that a fraction of the diazirines were not activated in the first irradiation cycle, thus a second exposure cycle allows additional initiation of free radical polymerization if monomers are present.

### Example 29. Photorheology Studies of PEGDA700 with TPO, DzOH and DzCOOH, Irradiated at 365 nm and 405 nm

Photorheology studies were conducted on PEGDA700 with DzOH and DzCOOH at 2 wavelengths, 365 nm and 405 nm. These studies were meant to determine if PEGDA700 can be used as a preliminary resin for future 3D printing work.

### Preparation of Stock Solutions

As PEGDA700 has a melting point of 12° C., it is solid when taken out of the refrigerator. Hence, it was first left at room temperature for 5 minutes before preparation of the stock ‘PEGDA700+1% photo-initiator’ solutions.

Stock ‘PEGDA700+1% photo-initiator’ solutions were then prepared, by adding 1% (mol/mol) of the photo-initiator to 3 g of PEGDA700 using a pipette. This was done for diazirines (DzOH, DzCOOH and commercial photo-initiator TPO). The amount of photo-initiators added are as depicted in Table 8.

TABLE 8
Amounts of diazirines and TPO needed to prepare
‘stock’ solution for 3 g of PEGDA700.

| | | | Amount of | Amount of | Amount of |
|---|---|---|---|---|---|
| Amount of | No. of mol | No. of mol of | DzOH | TPO | DzCOOH |
| PEGDA700 | of | photoinitiator | needed | needed | needed |
| (g) | PEGDA700 | (1%) | (mg) | (mg) | (mg) |
| 3 | 0.0043 | 0.000043 | 9.26 | 14.93 | 9.86 |

### Photorheology Experiments

Photorheology experiments were conducted using the Anton Parr MCR 102 modular rheometer with the following parameters and 18 ul of the solution was used for each run. A PP10 parallel plate stainless steel probe was used and measured at a 0.2 mm gap. The Steady-State Viscosity was first measured against a shear rate of 10 s⁻¹. This was followed by Dynamic Oscillatory Strain measurement with 1% shear, 10 Hz frequency, and 1% amplitude. During the measurement, the formulation was cured by a 365 nm UVA light for 100 seconds (LIGHT ON at 30 seconds, OFF at 130 seconds) for a total dose of 10 J (100 mW/cm²). The samples were irradiated at two wavelengths, 365 nm and 405 nm. The UV lamps used was a Thor Labs 365 nm SOLIS High-Power LED and 405 nm SOLIS High-Power LED connected to a DC2200 LED Driver set to constant current mode. The LED current was set to 1590 mA for the 365 nm UV lamp and 740 mA for the 405 nm UV lamp, with a limit of 4500 mA for both lamps.

### Results and Discussion

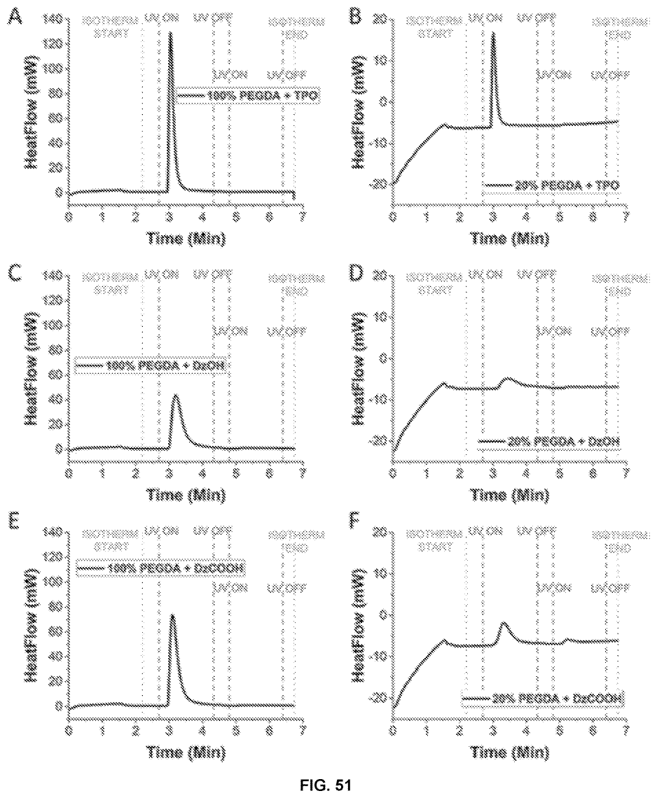

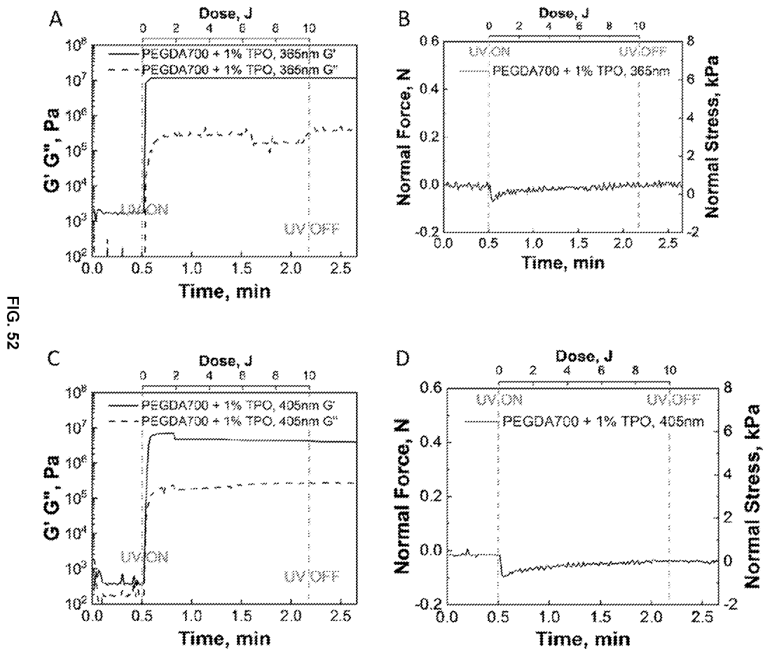

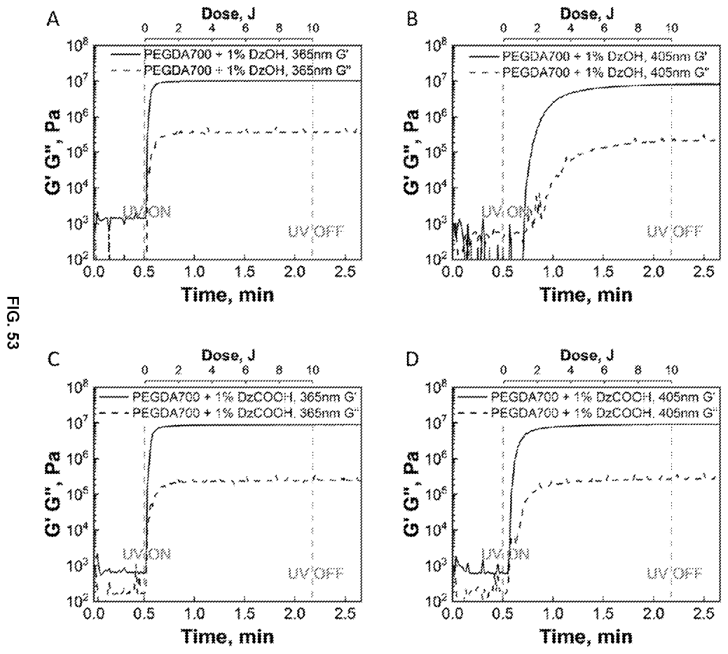

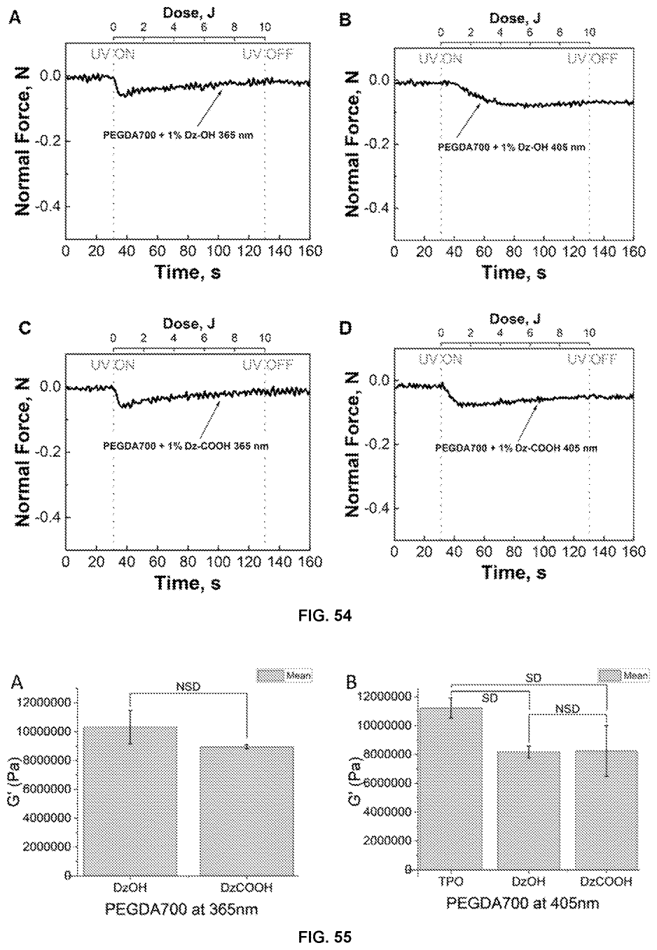

With reference to FIG. 52-54 the full rheological profiles (the total absorbed light dose for both 365 nm and 405 nm from 0 J to 10 J) were measured and showed comparable behaviour for TPO, DzOH and DzCOOH in both G′/G″ values and normal force. With reference to FIG. 55, the G′ values obtained for DzOH and DzCOOH were comparable to each other at both 405 nm and 365 nm, with each sample obtaining 10⁷ Pa and forming a film on the parallel plate. However, there is a statistical difference between TPO and the diazirines, with TPO having lower G′ values at 405 nm. In addition, when irradiated at 405 nm, the DzOH and DzCOOH had a time-lag before a change in G′ is observed for the diazirines. On average, the G′ values for DzOH only increased 15 seconds after the UV lamp was turned on.

In addition, the results for DzCOOH were unexpected, as previously, experiments with PEGDA575+DzCOOH at 405 nm did not result in film formation. Previous UV-Vis studies have also found that DzCOOH does not have an absorbance above 400 nm. However, the results here suggest that using a higher molecular weight PEGDA allows for polymerisation with DzCOOH at higher wavelengths.

Overall, the results show potential to use diazirines, especially DzCOOH, for 3D printing applications as they could initiate photopolymerisation for PEGDA700 at 405 nm, which is a commonly used wavelength for 3D printers.

### Example 30. Photorheometry Results Obtained for UVA-Induced Crosslinking (365 nm) of Binary Mixtures with PEGDA575 and PTH

All experiments are performed on an Anton Paar MCR 102 modular compact rheometer (Anton Paar, Singapore) with a photocuring setup in a parallel plate configuration. A UV light source is illuminated beneath the transparent sample base. A PP10 (10 mm diameter) parallel plate stainless steel probe is used at a 0.2 mm probe-base gap. Steady-state viscosity is first measured against a shear rate of 10 s⁻¹. This is followed by dynamic oscillatory strain measurement with 1% shear, 10 Hz frequency, and 1% amplitude. During this measurement, the formulation is irradiated by 365 nm (UVA) light for 100 seconds (LIGHT ON at 30 seconds, OFF at 130 seconds) for a total dose of 10 J·cm⁻² (100 mW·cm⁻²). Concurrently, the normal force acting on the probe is measured during the photopolymerization. This is followed by an amplitude sweep (1% to 1000% shear, angular frequency of 10 rad·sec⁻¹). The UV diode is a THORLABS 365 nm SOLIS High-Power LED connected to a DC2200 LED Driver (THORLABS, USA) set to constant current mode. The light intensity is calibrated with Newport Power Meter Model 843-R with a 919P thermopile sensor (Newport, USA). All measurements are performed in triplicates. A smoothening function is applied to the steady state viscosity (rq), storage and loss moduli (G′, G″), and normal force measurements (N).

### Results and Discussion

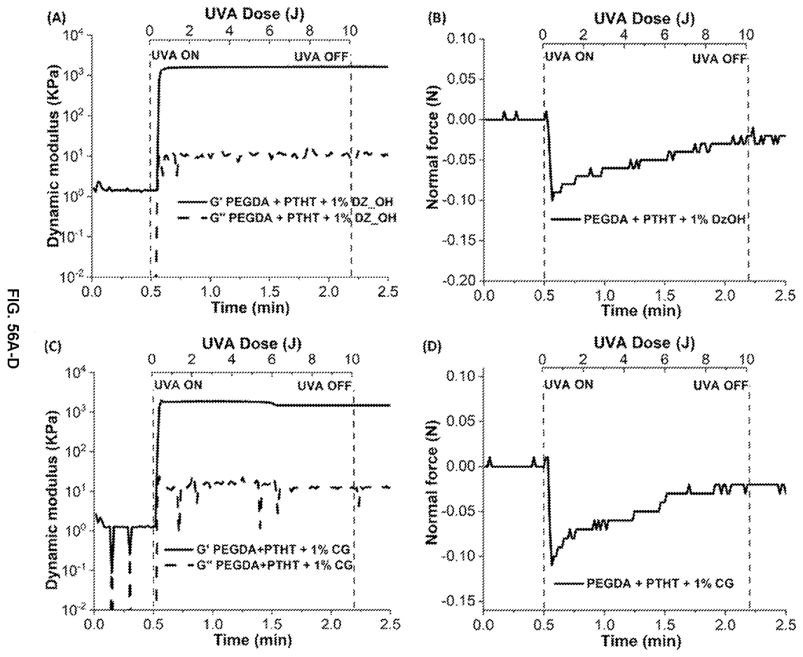

FIG. 56 depicts the experimental results.

### Example 31. Visible Light Shelf Stability

Formulations are prepared by dissolving 1 mmol of DzOH in 100 mmol of PEGDA to produce a solution of 1% (mol/mol) DzOH to PEGDA. In a separate vial, 1 mmol of TPO is dissolved in 100 mmol PEGDA to produce a solution of 1% (mol/mol) TPO to PEGDA. The formulation vials are vortexed on a Vortex-Genie 2 (Scientific Industries, USA) for 3 minutes to mix the solution. This is followed by sonication in Elmasonic P Multi-Frequency Ultrasonic Cleaner (Laval Lab, Canada) for 5 minutes in an ice bath to obtain a homogenous clear formulation. The formulations are then stored covered in the fridge at 2° C. until use. PEGDA formulations with DzOH and TPO are then added to the PBS solution to create 30% (w/w) and 70% (w/w) solutions of PEGDA with initiators (DzOH and TPO) in PBS. The sample vials are then exposed to fluorescent laboratory lighting for 1 hour before images are taken.

### Results and Discussion

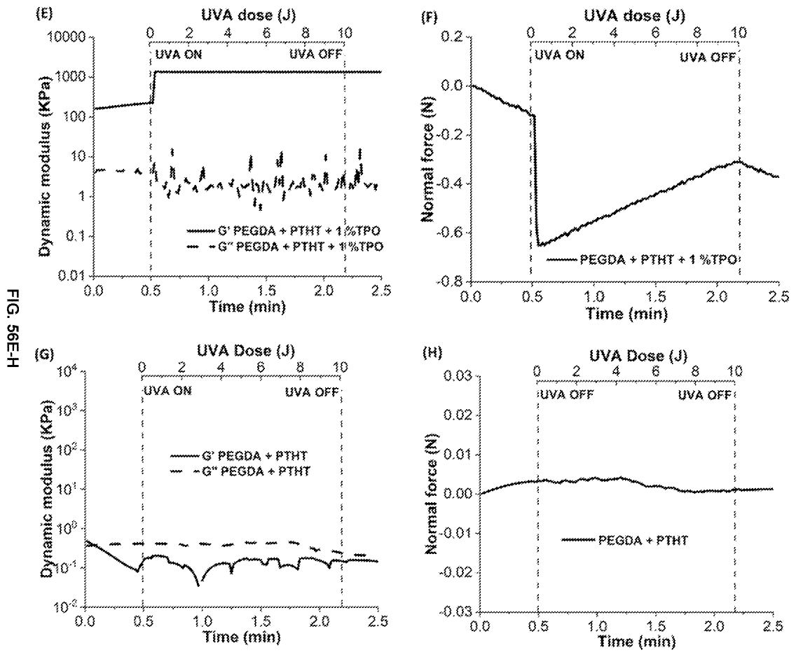

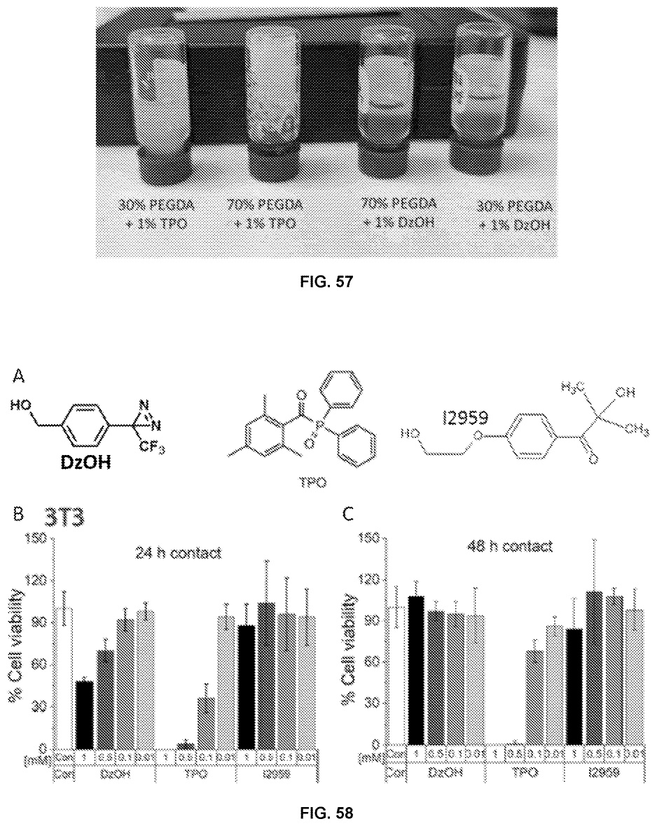

FIG. 57 depicts the visible light shelf stability of 30% PEGDA575+1% TPO, 70% PEGDA575+1% TPO, 70% PEGDA575+1% DzOH, and 30% PEGDA575+1% DzOH.

### Example 32. In Vitro Biocompatibility Alamar Blue Assay

Cells seeded in wells (5 replicates for each group) with 100 μl DMEM media (10% FBS, 1% antibiotic). Incubated for 24 and 48 h, in a 96-well plate, 10000 cells/well, using 3T3 fibroblasts or HeLa cell lines. After 24 h, DMEM media replaced with 100 μl DMEM with dissolved test compounds (Test compounds dissolved in DMEM media to obtain final conc. of 1, 0.5, 0.1, 0.01 mM). After 24 hours of incubation, 10 μl resazurin solution (0.015%) dissolved in PBS was added to the wells followed by incubation for 3 hours. Readings taken post 24 hours and 48 hours of sample addition. (Ex-570 nm, Em-590 nm), Controls: Blank media without cells, Media with cells, Readings for (Blank media without cells) subtracted from all groups, Readings normalized against (media with cells group—100%)

### Results and Discussion

FIG. 58 depicts the in vitro biocompatibility of DzOH, TPO and 12959.

### Example 33. Binary Composite Samples Incorporating Varying Amounts of PEGDA575 in CaproGlu

The utility of carbene based bioadhesives is assessed in the presence of various liquid additives containing reactive functional groups of hydroxyl, thiol, amine, or acrylate. The most unexpected findings resulting from studying these mixtures were in the set of binary composite samples incorporating varying amounts of PEGDA575 in CaproGlu. The results indicate that diazirine photoactivation initiates acrylate polymerization with little to no shrinkage. Polymerisation of acrylates produces highly crosslinked polymer networks that form the mainstay of many industries based on adhesives, coatings, and building materials. For some biomaterials, the stiff matrices of acylated macromolecules are considered advantageous, e.g. bone cements. Curing of acrylate biomaterials requires the incorporation of leachable and potentially harmful small molecule initiators. CaproGlu serves as a synergistic free radical polymerization initiator that may be beneficial for production of in situ biomaterials, where polycaprolactone-based degradable medical implants have little to no mild inflammation (Djordjevic, I. et al., Macromol. Rapid Commun. 2020, 41, 2000235). CaproGlu also expands when cured, so the combination of CaproGlu with acrylates may reduce or prevent matrix shrinkage, an industrial concern especially in dental resins.

A study of TPDs conjugated to gold nanoparticles reports the reaction of TPDs with methyl acrylate that results in insertion into the acrylate double bond (Ismaili, H., Lee, S. & Workentin, M. S., Langmuir 2010, 26, 14958-14964). Examples of polymerisation reactions of methacrylates and acrylates with other carbenes exist, but most reports describe NHCs which are generally relatively stable/persistent carbenes. NHCs have been reported to act as initiators and/or precatalysts for anionic polymerisations of methacrylates resulting in high Mw low dispersity products (Naumann, S. et al., Polym. Chem. 2013, 4, 2731-2740). Trifluorophenyl diazirines, however, produce carbenes which differ significantly to NHCs in that they are less likely to act as nucleophiles due to electron withdrawing groups adjacent to the diazirine. It is therefore speculated that diazirines are initiating acrylate polymerisation through radical>anionic>cationic mechanisms. Light activated CF₃-diazirines preferentially produce closed shell singlet carbenes, which are able to insert into X—H bonds (X═C, N, O, S) and explains their use in photoaffinity probes (Hassan, M. M. & Olaoye, O. O., Molecules 2020, 25, 2285). Triplet carbenes are not able to insert into O—H bonds and react as diradicals, undergoing oxidation to ketones or H-abstraction, with open shell singlet carbenes behaving in a similar manner (Hassan, M. M. & Olaoye, O. O., Molecules 2020, 25, 2285).

The triplet carbene is the ground state for TPDs, but this is influenced by substituents and solvent polarity. Previous studies have indicated that the expected reaction products of triplet carbenes are not observed for trifluorophenyl diazirines (Platz, M. et al., Bioconjug. Chem. 1991, 2, 337-341), and others have indicated that the triplets are observed but in smaller quantities than the singlet carbene (Nassal, M., J. Am. Chem. Soc. 1984, 106, 7540-7545). Another theory could be that polymerisation is initiated via a diazirinyl radical or other reactive intermediates within the transition state (Navretil, R. et al., Org. Lett. 2016, 18, 3734-3737). It is also speculated that the mechanism may be similar to that of common dialkyl diazene radical polymerisation initiators (Moad, G., Prog. Polym. Sci. 2019, 88, 130-188). The crosslinked insoluble nature of cured glue makes discerning reaction products difficult, let alone reactive intermediates, so further studies are needed to ascertain the nature of the reaction.

TPDs (the cross-linking component of CaproGlu) react preferentially with C—X bonds (where X is a heteroatom such as sulphur or oxygen) rather than C—C or C—H bonds (Hassan, M. M. & Olaoye, O. O., Molecules 2020, 25, 2285; and Brunner, J., Senn, H. & Richards, F. M., J. Biol. Chem. 1980, 255, 3313-3318). The reactivity of TPDs has been examined in the context of aqueous photoaffinity labelling of proteins. However, the incorporation of amine groups can have other advantages. One obstacle to the use of polycaprolactone in biomedical applications can be its long degradation time, which can take in excess of six months even up to four years, depending on factors such as the molecular weight of the polymer. Another barrier can be the highly hydrophobic nature of polycaprolactone, which is considered advantageous in some circumstances, but considered a hindrance in others. The introduction of amines and the resulting increase in hydrophilicity has been shown to facilitate the use of polycaprolactones in applications which require adhesion and proliferation of cells (Zhu, Y., Mao, Z. & Gao, C., RSC Advances 2013, 3, 2509-2519). There are several reports that show that the introduction of amines can speed up degradation of polycaprolactone via aminolysis (de Gracia Lux, C. & Almutairi, A., ACS Macro Lett. 2013, 2, 432-435). Reactions of trifluorophenyl diazirines with amines have also been shown to result in formation of enamines (and fluoride, F⁻) which are prone to breakdown by hydrolysis (Platz, M. et al., Bioconjug. Chem. 1991, 2, 337-341). This can be important if the tissue adhesive is used in therapeutic areas where rapid resorption (<1 week) is desirable.

The use of diazirines as a carbene precursors and non-specific crosslinkers in materials applications is becoming more widespread. Bis-diazirines have been reported to act as crosslinkers for low surface energy plastics (Lepage, M. L. et al., Science 2019, 366, 875) and have also been used for crosslinking of solution processed organic light-emitting diodes (Dey, K. et al., J. Mater. Chem. C 2020, 8, 11988-11996). Furthermore, our recent study demonstrated activation of CaproGlu can be expanded to visible light activation with the aid of photocatalysts (Djordjevic, I. et al., ACS Appl. Mater. Interfaces 2021, 13, 36839-36848). Unlike UV activation, visible light does not produce diazoalkane. It was also found that CaproGlu can be gamma-sterilised with no detrimental effects to its properties or function. Although this work focuses on trifluorophenyl diazirines (TPDs) grafted to polycaprolactone tetramers, the findings may be relevant in exploring hybrid crosslinked polymer structures and networks such as tetra-PEGs (Lepage, M. L. et al., Science 2019, 366, 875), hyperbranched polyalcohol dendrimers and acrylates free of common photoinitiators.

1. A light sensitive composition comprising:
a photocurable composition; and
a photoinitiator comprising an aryl-diazirine, wherein the diazirine bears an electron withdrawing group.

2. The light sensitive composition according to claim 1, wherein the aryl-diazirine is selected from one or both of:
a linear or branched macromolecule that is covalently attached to one or more aryl-diazirine groups; and
a compound according to formula I: 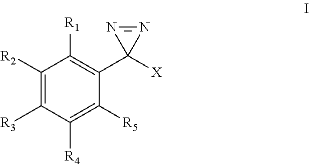
where:
X represents OR₆, halo, or, more particularly, a C₁ to C₆ alkyl group substituted by one or more fluoro atoms;
each of R₁ to R₅ independently represents H, —C(═O)OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₈, when present, independently represents H or C₁ to C₆ alkyl that is unsubstituted or substituted by one or more halogen atoms.

3. The light sensitive composition according to claim 2, wherein the compound of formula I is selected from one or more of the group consisting of 3-phenyl-3-(trifluoromethyl)-3H-diazarine, 3-(4-(bromomethyl)phenyl)-3-(trifluoromethyl)-3H-diazarine, 4-[3-(trifluoromethyl)-3H-diazirin-3-yl]-benzoic acid, and 4-[3-(trifluoromethyl)-3H-diazirin-3-yl]-benzyl alcohol.

4. The light sensitive composition according to claim 2, wherein the linear or branched macromolecule is a linear or branched polycaprolactone.

5. The light sensitive composition according to claim 4, wherein the linear or branched polycaprolactone has the structure:

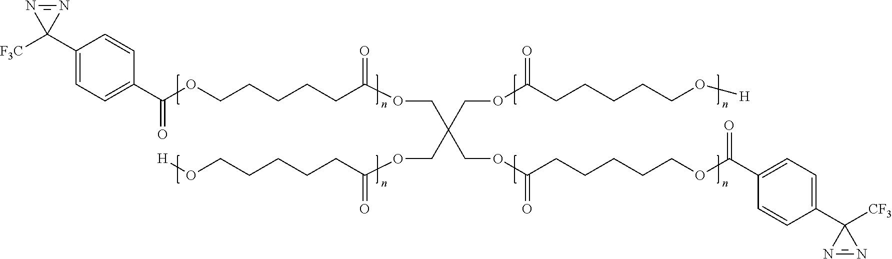

6. The light sensitive composition according to claim 1, wherein the photocurable composition comprises one or more monomers, oligomers or polymers bearing one or more groups capable of free radical polymerisation and/or ring opening polymerisation.

7. The light sensitive composition according to claim 6, wherein the photocurable composition comprises poly(ethylene glycol) diacrylate (PEGDA).

8. The light sensitive composition according to claim 1, wherein the aryl-diazirine is present in an amount of from 0.001 to 50 wt % relative to the weight of the entire light sensitive composition.

9. The light sensitive composition according to claim 1, wherein the aryl-diazirine is present in an amount of from 0.01 to 20 mol % relative to the molar amount of the photocurable composition.

10. The light sensitive composition according to claim 9, wherein the aryl-diazirine is present in an amount of from 0.1 to 10 mol % relative to the molar amount of the photocurable composition.

11. The light sensitive composition according to claim 1, wherein the light sensitive composition further comprises one or more of the group selected from an anti-oxidant, a plasticizer, an impact modifier, a colorant, a pigment, a conductive filler, an antimicrobial, a filler, a chemical blowing agent, a fragrance, and a rheology modifier.

12. (canceled)

13. (canceled)

14. The light sensitive composition according to claim 1, wherein the light sensitive composition is suitable for use as a resin for 3D-printing.

15. (canceled)

16. A cured composition obtained by curing a light sensitive composition wherein said light sensitive composition is that of claim 1.

17. A cured composition comprising:
a cured polymeric resin; and
a reaction product between an aryl-diazoalkane and a dipolarophile, wherein the diazoalkane bears an electron withdrawing group.

18. The cured composition according to claim 17, wherein the reaction product formed between an aryl-diazoalkane and a dipolarophile is a cycloaddition product of a reaction between an aryl-diazoalkane and one of the group consisting of a methacrylate group, a propargylic alcohol group, an aldehyde group or a ketone group.

19. The cured composition according to claim 17, wherein the aryl-diazoalkane is selected from one or both of:
a linear or branched macromolecule that is covalently attached to one or more aryl-diazoalkane groups; and
a compound according to formula II: 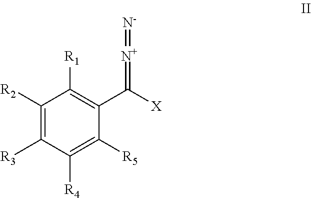
where:
X represents OR₆, halo, or, more particularly, a C₁ to C₆ alkyl group substituted by one or more fluoro atoms;
each of R₁ to R₅ independently represent H, —C(═O)OR₇, or C₁ to C₆ alkyl that is unsubstituted or substituted by one or more halogen atoms or OR₈;
R₆, when present, represents a C₁ to C₆ alkyl that is unsubstituted or substituted by one or more halogen atoms (e.g. R₆ is CH₃); and
each R₇ and R₈, when present, independently represents H or C₁ to C₆ alkyl that is unsubstituted or substituted by one or more halogen atoms.

20. The cured composition according to claim 19, wherein the compound of formula II is selected from one or more of the group consisting of (1-diazo-2,2,2-trifluoroethyl)benzene, 1-(bromomethyl)-4-(1-diazo-2,2,2-trifluoroethyl)benzene, 4-(1-diazo-2,2,2-trifluoroethyl)benzoic acid and [4-(1-diazo-2,2,2-trifluoroethyl)phenyl]methanol.

21. The cured composition according to claim 19, wherein the linear or branched macromolecule is a linear or branched polycaprolactone.

22. The cured composition according to claim 21, wherein the linear or branched polycaprolactone has the structure:

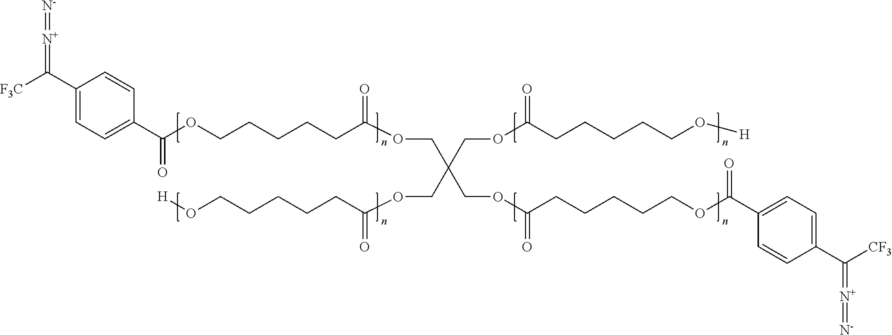

23. The cured composition according to any one of claims 17 to 22, wherein the cured polymeric resin is formed from one or more monomers, oligomers or polymers bearing one or more groups capable of free radical polymerisation and/or ring opening polymerisation.

24. The cured composition according to claim 23, wherein the cured polymeric resin is formed from poly(ethylene glycol) diacrylate (PEGDA).

25. The cured composition according to any one of claims 17 to 24, wherein the cured composition has a minimum absorption of 0.5 ABS within the UV spectrum of from 200 to 300 nm.

26. A method of forming a cured polymeric resin, the method comprising the steps of:
(a) providing a light sensitive composition according to any one of claims 1 to 15; and
(b) exposing it to a light source for a period of time to provide a cured polymeric resin.

27. The method according to claim 26, wherein when the light sensitive composition is one according to any one of claims 1 to 11 and claims 13 to 15, as dependent upon any one of claims 1 to 11, then the light source is UV light.

28. The method according to claim 26, wherein when the light sensitive composition is one according to claim 12, then the light source is visible light.
